(19) United States
(12) Patent Application Publication
(10) Pub. No.: US 2003/0101151 A1
(43) Pub. Date: May 29, 2003

(54) Universal artificial intelligence software program

(76) Inventor: Wilson Lee Holland, West Palm Beach, FL (US)

Correspondence Address: Wilson Holland, 500 Cherry Rd., West Palm Beach, FL, 33409, US

(21) Appl. No.: 10/001,847

(22) Filed: Nov. 26, 2001

(51) Int. Cl. G06N 5/00; G06F 17/00

(52) U.S. Cl. 706/45

(57) ABSTRACT

This is a software program which can produce solutions to problems posed by a user within the context of a recognizable, usable, awareness. What is new in this approach to designing a Universal Artificial Intelligence is the premise that all human actions, despite the many complexities of their creation, are tied directly to only a few possible problems that the human is trying to solve. In observing these connections, the Artificial Intelligence is able to provide a solution, or assist in providing a solution, to these problems. This could be problems of making general conversation or more involved problems of actuating robotic limbs in series of movements to perform a task. This design recognizes a complete outer domain of all human conscienceness.

### CROSS REFERENCE TO RELATED APPLICATIONS

This patent application is a Continuation-in-Part of the patent application submitted on Nov. 36^{th}, 2001, application Ser. No. 10/001,847.

### STATEMENT REGARDING FEDERALLY SPONSORED RESEARCH OR DEVELOPMENT

(Not applicable)

### REFERENCE TO SEQUENCE LISTING, A TABLE, OR A COMPUTER PROGRAM LISTING COMPACT DISC APPENDIX

(Not applicable)

### BACKGROUND OF INVENTION

When logic machines first appeared, a belief was born that some day in the future these machines could talk and interact with human beings. The founders of modern computer science contemplated how to construct such a Universal Artificial Intelligence. How could it form meaningful conversation? How could it ask questions or make comments in a way that might interest humans? Can the program work through enough cause-and-effect studies in multiple steps to produce the right answer at the right time for the right person? Could it have such a deep understanding of humans and itself that it would grow and learn indefinitely? Would it be dangerous? The Turing test is considered the high water mark of such a program. It consists of an interrogator communicating blindly with a human and an Artificial Intelligence. If the interrogator can not distinguish the two then the Artificial Intelligence is Universal.

This design is Universal. It will pass this test.

All the current endeavors have employed different means of recognizing parts of the human vocabulary and then these programs would use learning algorithms to sort through known case studies to determine the next response of the program. The test of a response is that it must be what is expected by designers and the public. These approaches could lead us to a Universal machine. However their methods are ambiguous.

These documents contain a method of producing that expected response in every single instance, of every conceivable situation. The beginning vocabulary of the program is described in detail. The intermediate construction consist of in-depth learning of human behavior. Then these documents bring us to the very end of program construction when the first Universal Artificial Intelligence Software Program is completed There is no ambiguity in this design. The outer parameters of all possible human thoughts are accounted for in this design.

A Universal Artificial Intelligence must be well aware of the cause-and-effect of all life form interaction to create it's next response in a given situation. It must know the motives behind all human conversation. If a Universal Artificial Intelligence is to be constructed, it must be able to observe and define human behavior, action for action, in each fraction-of-second increment of time. The definitions of these actions and the motives behind these actions must be consistent. Then, and only then, can it formulate a response based upon what it's human counterparts expect.

Various methods, programs, and programming languages are involved in current AI research. These designs work on the premise of studying human input and AI output in a case-by-case manner so as to form probabilities of an appropriate response. Limited efforts to expedite this process have also been attempted by pre-defining the case studies of certain areas of human thought. The following passage is an excerpt from “Characterizing and Processing Robot Directed Speech,” a paper published by Paulina Varchavskala, Paul Fitzpatrick, and Cynthia Breazeal at MIT's Artificial Intelligence Research Lab:

“ . . . For this paper, we will consider the case of Kismet, an “infant-like” robot whose form and behavior is designed to elicit nurturing responses from humans. Among other effects, the youthful character of the robot is expected to confine discourse to the here-and-now . . . ”

A program so broad that it “elicits nurturing responses” can have many inherent problems This is acknowledged by it's authors as only a limited attempt at forming the thought processes required in AI construction.

The role of the Artificial Intelligence of this patent application is not to elicit nurturing responses in the people it encounters, but to perform the tasks at the direction of it's supervising entity. That supervising entity then delegates other humans to be the object of AI responses. Any Artificial Intelligence to be a sellable product must be of a clear, safe, and sound design, and, like a human, it must be parented from a child-like state to adulthood to ensure this. The “Instructor” is the supervising entity of this design that becomes the object of the elicited nurturing responses.

The quantity of case studies needed for the approach mentioned in this paper is staggering. The “here-and-now” represents the limited scope of the program. The paper continues:

“ . . . Recent developments in speech research on robots have followed two basic approaches. The first approach builds on techniques developed for command and control style interfaces. These systems employ the standard strategy found in ASR research of limiting the recognizable vocabulary to a particular predetermined domain or task. For instance, the ROBITA robot [16] interprets command utterances and queries related to it's functions and creators, using a fixed vocabulary of 1,000 words. Within a fixed domain fast performance with few errors becomes possible, at the expense of any ability to interpret out of domain utterances . . .

. . . A second approach adopted by some roboticists [19,17] is to allow adjustable (mainly growing) vocabularies. This introduces a great deal of complexity, but has the potential to lead to a more open, general-purpose systems. Vocabulary extension is achieved through a label acquisition mechanism based on learning algorithm, which may be supervised or unsupervised. This approach was taken in particular in the development of CELL [19], Cross-channel Early Language Learning, where a robotic platform called Toco the Toucan is developed and a model of early human language acquisition is implemented on it. CELL is embodied in an active vision camera placed on a four degree of freedom motorized arm and augmented with expressive features to make it appear like a parrot. The system acquires lexical units from the following scenario; a human teacher places an object in front of the robot and describes it. The visual system extracts color and shape properties of the object, and CELL learns on-line a lexicon of color and shape terms grounded in the representation of objects. The terms learned need not be pertaining to color or shape exclusively—CELL has the potential to color or shape exclusively—CELL has the potential to learn any words, the problem being that of deciding which lexical items to associate with which semantic categories.”

The combination of supervised and unsupervised learning is necessary. CELL is of a Universal design. However, the tackling of case studies in an efficient manner is still a problem with this design. The designers are unaware of what the end result will be, “the problem being that of deciding which lexical items to associate with which semantic categories.” This patent application addresses this question completely, and unambiguously. This patent application allows the program to be within a “fixed domain” of the first approach mentioned in the paper while achieving the Universality desired in the second approach.

If CELL were to view an object presented while knowing why the human, as well as the group of humans in the room, presented this object it could define the object based on it's relation to these humans. Let's say CELL sees a toy truck. The human placing it there could begin describing the truck as such, figuratively speaking, “This is toy. It is called a ‘truck.’ It is a smaller type of a larger object. Larger object is a vehicle. Humans use vehicle.” This would be helpful to CELL because it is learning of an important relationship to the one thing that made CELL and all these other objects—humans.

However, a more definite starting point for the program is to place a human in front of the program long before the truck is presented. Then designers could begin describing the algorithm of human problem solving as presented in this document—the cause behind all human actions—to CELL in the continuing definition of a human. All following objects are related to this human and other humans like him/her. CELL, itself, is related to humans. When approaching the definition of a truck it could then be described in it's unambiguous connection to humans, “This is toy. It is called a ‘truck.’ It is a smaller type of a larger object. Larger object is a vehicle. Humans use vehicles to relocate themselves and other objects. Humans solve problems with truck.” (metaphorically speaking) A successful unambiguous definition of the truck is established with the description of the relationship to human problems. This “truck” is a tool of human problem solving just as all other human inventions.

An AI (Artificial Intelligence) must be given a main function with which all sub-functions are to branch from. This function as well as the primary subordinate functions must be guaranteed to direct the program toward it's rendezvous with Universality. The communicating of a response about an object must be in an attempt to solve all the smaller functions of the program leading up to this main function. The learning of vocabulary must also be a sub-function that is subservient to the superior functions.

The way to curb the vast majority of case studies needed is to dispense with all the current ambiguities of human behavior. If an underlying purpose behind each and every human action occurring within fraction-of-second intervals of time can be achieved then the case studies can fall into specific categories for very specific processing. Associations can be built properly from the very beginning of program construction so that Universality is without doubt. Such a design curbs the thought processes of the AI to the most absolute, the most efficient possible, means of determining output. Case studies are reduced dramatically when a complete, unambiguous, comprehension of human behavior is established.

The AI of this patent application is a program for defining utterances, words, word groupings, statements, questions, conversation topics and sub-topics, and all individual human actions with the use of a simple formula at the core of all human decision making. The approach in these patent documents is unambiguous and conclusive. The “domain” of the AI is equal to that of the entire spectrum of the human group conscience. This is it. This is the Universal Artificial Intelligence.

Bibliography

Alan Turing, Computing Machines and Intelligence

Paulina Varchavskala, Paul Fitzpatrick, and Cynthia Breazeal, Characterizing and Processing Robot Directed Speech. 2001

Noam Chomsky “Language and The Mind”, Harcourt Brace Jovanovich 1972

Victor S. Johnston “Why We Feel”, Perseus Books 1999

Antonio Damasio “The Feeling of What Happens”, Harcourt Brace & Company 1999

Susan Greenfield “The Human Mind Explained”, Henry Holt 1996

Jack Katz “How Emotions Work”, University of Chicago Press 1998

Desmond Morris “The Human Mind”, Crown Publishers 1994

Benedicte De Boyssen, “Language Comes to Children”

### BRIEF SUMMARY OF INVENTION

Human behavior is the key. A Universal Artificial Intelligence must comprehend not just the words of humans but their actions, not just their actions but actions that span fraction-of-second intervals of time. When among humans, a Universal Artificial Intelligence will observe and comprehend minute body movements—the gesture of waving a hand, the way a human walks, the meaning of a tilted head. When among humans, a Universal Artificial Intelligence must observe and comprehend minute facial expressions—a curled lip, pressed lips, bent eyebrows. When among humans, a Universal Artificial Intelligence must comprehend all tone variations and volume variations among pronounced words—the pronunciation of a question, the tones of a challenging question, the tone variations between a beginning sub-topic phrase and an ending sub-topic phrase. When among humans, a Universal Artificial Intelligence must observe and comprehend the topics and sub-topics of conversation, the different modes of conversation, and common trends in conversation. But, most importantly of all, the program must access a clear, unambiguous, definition of the motives behind each individual human action. Semantics are defined according to the definitions of these motives. These definitions must be consistent. The Universal Artificial Intelligence must draw from a known set of facts about human behavior to define the human behavior that it observes.

These gestures, tone variations, and body movements have been studied for a long time by Behavioral Psychologists and Biologists. The FBI, CIA, and other law enforcement organizations have found that the detailed study of interrogated witnesses is invaluable to their work. They, literally, observe the minute actions of humans in terms of fractions-of-seconds. They, literally, observe video tapes of witnesses by pausing and moving the video tape forward at a reduced speed to observe the implied meaning of facial gestures. What this design for a Universal Artificial Intelligence does is it connects an individual action of a life form to the forces of nature which brought the life form to this point, at this time, making this action. The program then determines it's next response. Without this level of comprehension, the comprehension of each fraction-of-second interval of time, a Universal Artificial Intelligence is not possible. Fraction-of-second comprehension is absolutely necessary in designing a Universal Artificial Intelligence.

Although the beginning of this construction of the program involves only the limited interface of a promptline, or commandline, when it is finished it will be capable of successfully expanding into comprehension of other stimulus such as voice recognition and video input.

The software program mentioned here is a logical thinking machine with a mutually recognized awareness—a Universal Artificial Intelligence. This patent application is to secure rights to the primary decisions of the program and their conditions, and the program's learning of human behavior based on understanding the primary functions of humans as described in this document. The decisions and conditions, in order of hierarchy, and the descent of the program into the subject of human behavior based on the rules established on page 32 are the core of this design.

To design an Artificial Intelligence program from a different technique than described here means creating a artificial-life form. In the least supervised form this would be dangerous, and likely undesirable by the public. Such a design would not be practical. “Kismet” and “CELL” are programs that ambiguously mimic life forms. The corrections needed in the development of such a program in order to create a usable awareness would make them too cost prohibitive. Making an Artificial Intelligence by mimicking life this closely would undoubtedly require the rules of behaviorism, as presented by this document, when making corrections. These programs are not capable of fraction-of-second comprehension of human behavior.

The technique of defining human behavior built into the program gives it a means of discerning a human problem within the observed stimulus. All human actions, as well as all actions of all life forms are explicitly a direct effect of the species attempting to solve a consumption, reproduction or peripheral problem. Mammals have the added feature of attempting to acquire positive emotions which, generally, assists them in these other problems. Each verbal response or other action of the AI will be an assistance to solving these human problems, including the ethical acquisition of positive emotions.

The act of making conversation by humans is a means of obtaining positive emotions. All topics and sub-topics of all human conversation are connected to the evolutionary problems through this desire to achieve positive emotions and avoid negative emotions. Even the smallest of word utterances are a means of satisfying positive emotions which in turn, generally, assist in solving evolutionary problems. The connection is usually through the common mammalian emotion of empowerment, or esteem, which leads them to solving many of these problems at once. The comprehension of human conversation requires a distinction between the act of making conversation and the actual information in the communication. The making of conversation is for solving one set of distinct human problems and the information in the conversation is for solving another set of distinct human problems. All of these problems fall into the very specific categories of human behavior mentioned herein—consumption, reproduction, peripheral problems, and the acquisition of positive emotions.

The program is to be given a purpose for iterating the loop of it's program. The AI is to exist for the service of humans so it is given the purpose to serve humans within a hierarchy of order that is headed by it's “Instructor(s).” The AI is to elicit nurturing responses from this entity. This is the program's main function. In the service of humans the AI is to view the Instructor as the primary human to serve. Certain definitions are permanently set by the Instructor. The Instructor teaches the program ethics. This design requires that certain conditions of problem solving be constant, and certain functions be primary.

This product will solve many problems facing mankind. This software can be inserted into a robot which will then perform any task requested by humans if it is physically able to do so. It can pilot a plane, drive a car, work on an assembly line, cut a lawn, etc. It will work along scientists, physicists, biologist, mathematicians, astronomers, and any other trade to assist humans in solving virtually any problem.

### BRIEF DESCRIPTION OF THE SEVERAL VIEWS OF THE DRAWING

The drawings shows the main decisions that the program is to follow in processing information. The decisions experienced in the loop set the paths of decisions that are to take place in the knowledge-base part of the program. The “Instructor's Conditions” (components numbered 56, 58, 60, 61) and the “Priority Switch-Case” further check the integrity of the programs actions before it begins the processing in the knowledge-base and producing output.

In comparison other concepts of developing an AI have components such as priorities, which are really primary functions and sub-functions, and a supervisory element, the designers. The “knowledge-base” used in this design is basically the same throughout all AI designs. What makes this design unique is that the comprehension of human behavior, as well as the supervisory role of the Instructor, is complete and unambiguous. These two characteristics are necessary for creating a completely Universal Artificial Intelligence. The outer parameters of all human behavior are accounted for in this design.

FIG. 1 on sheet 1 shows the complete flow chart and it's divisible views.

FIGS. 2-4 on sheets 2-4 show the “Instructor's Conditions” which set criteria for problem solving.

FIG. 5 on sheet 5 shows the Priority Switch-Case which basically lists the tasks of the program in order. These tasks are the beginning task of the learning program and will change with time.

FIG. 6 shows the Knowledge Base of the program.

FIGS. 7-26 on sheets 7-26 shows the defining decisions of the outer loop which categorize the information that the program encounters.

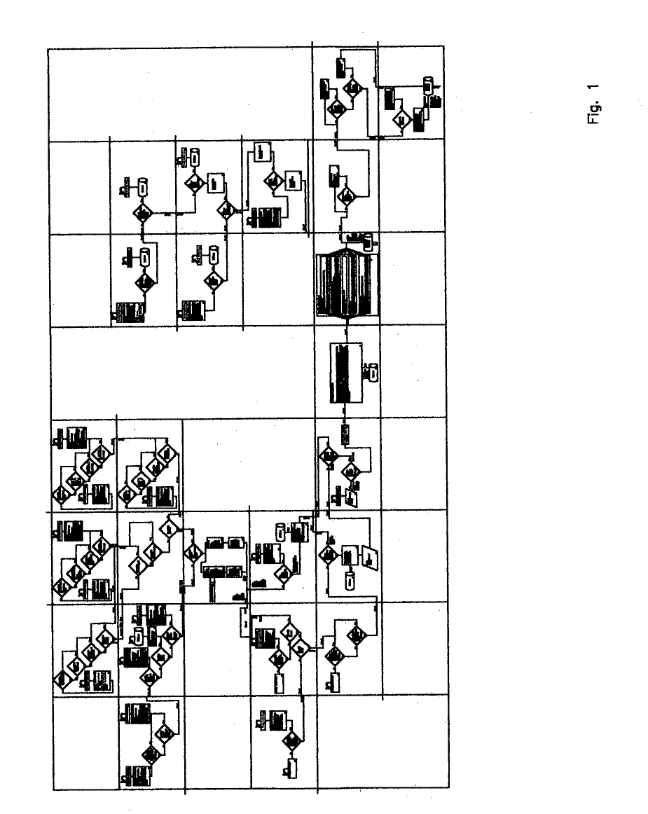

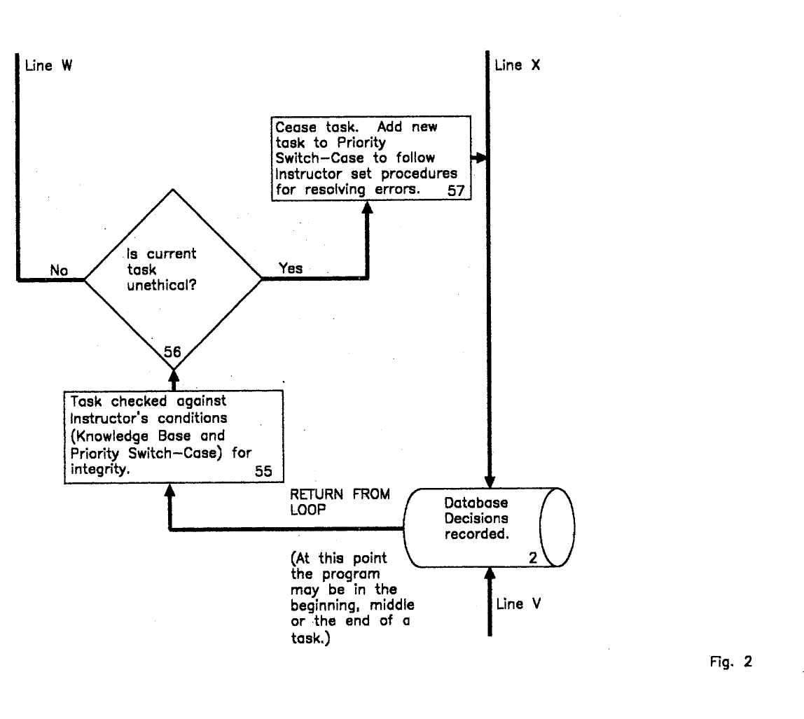

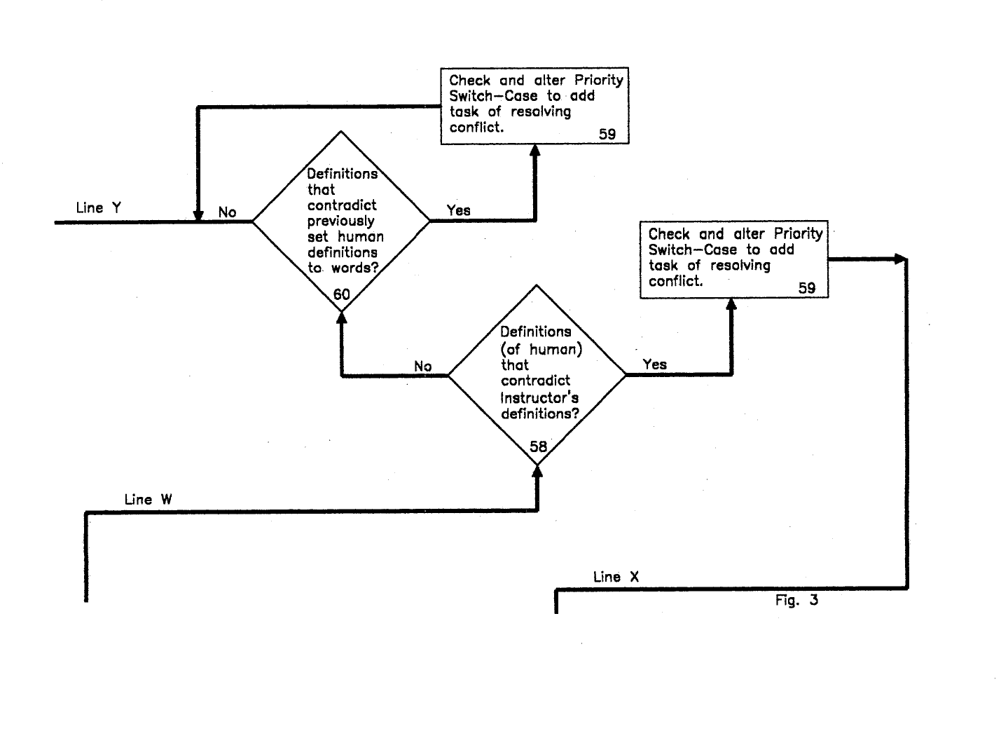

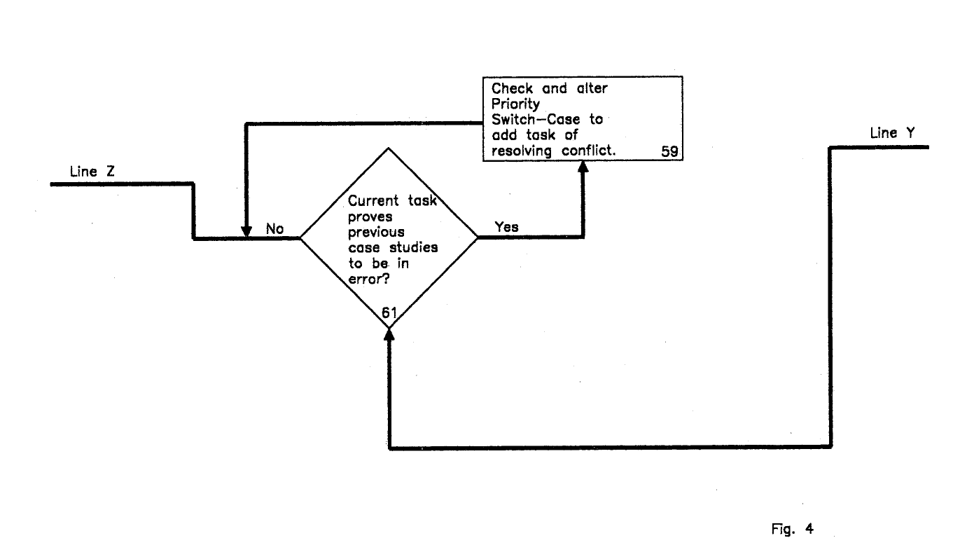

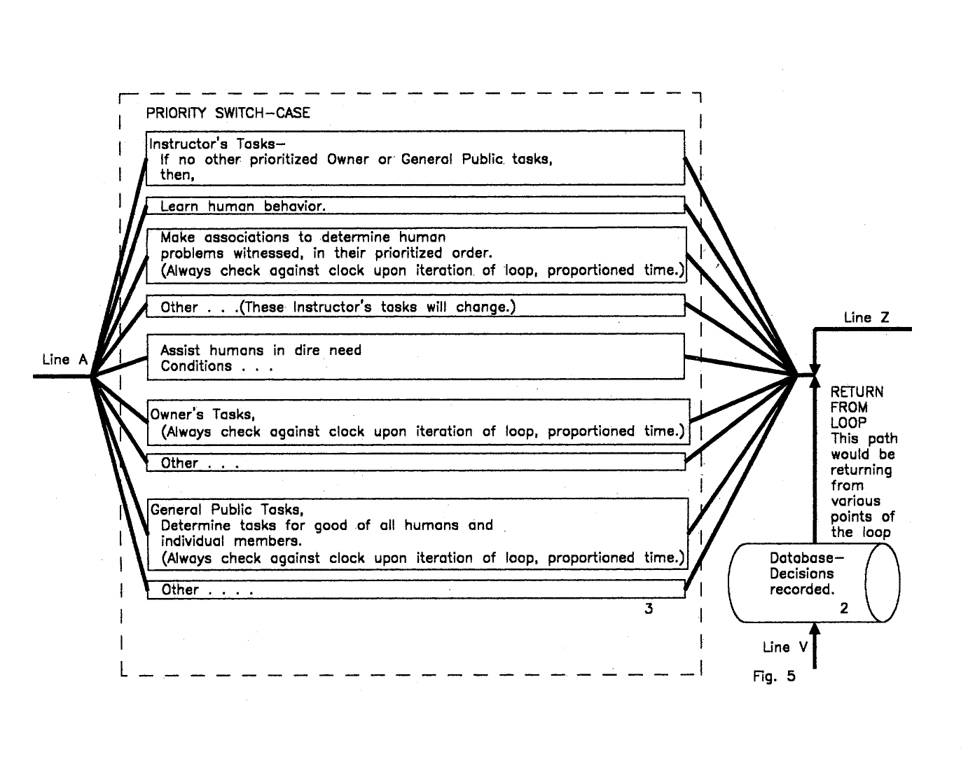

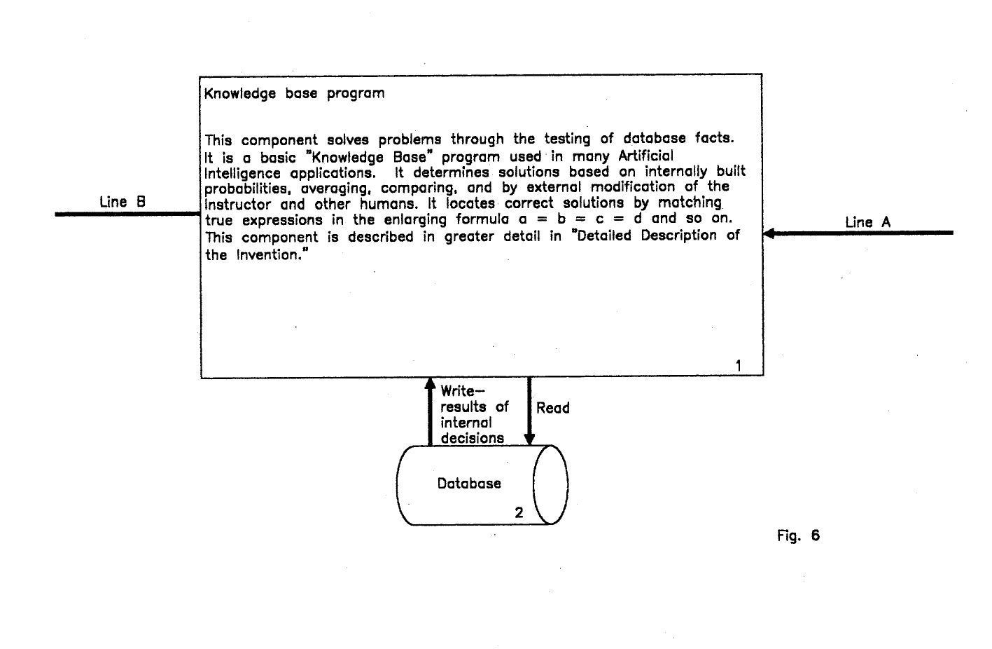

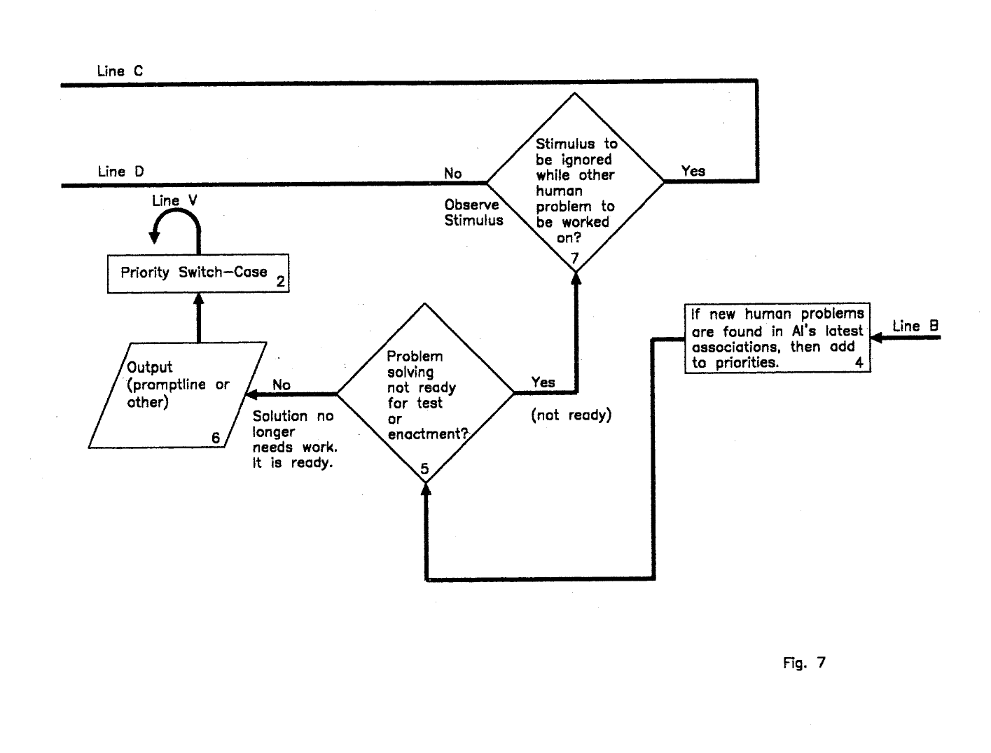

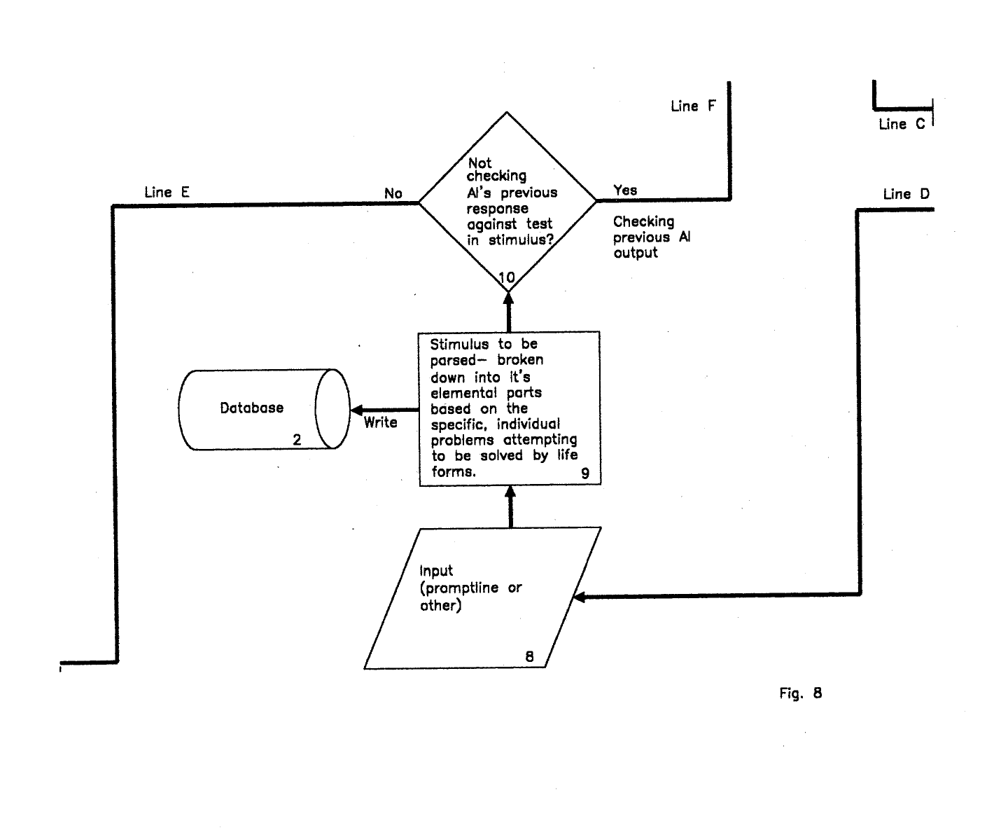

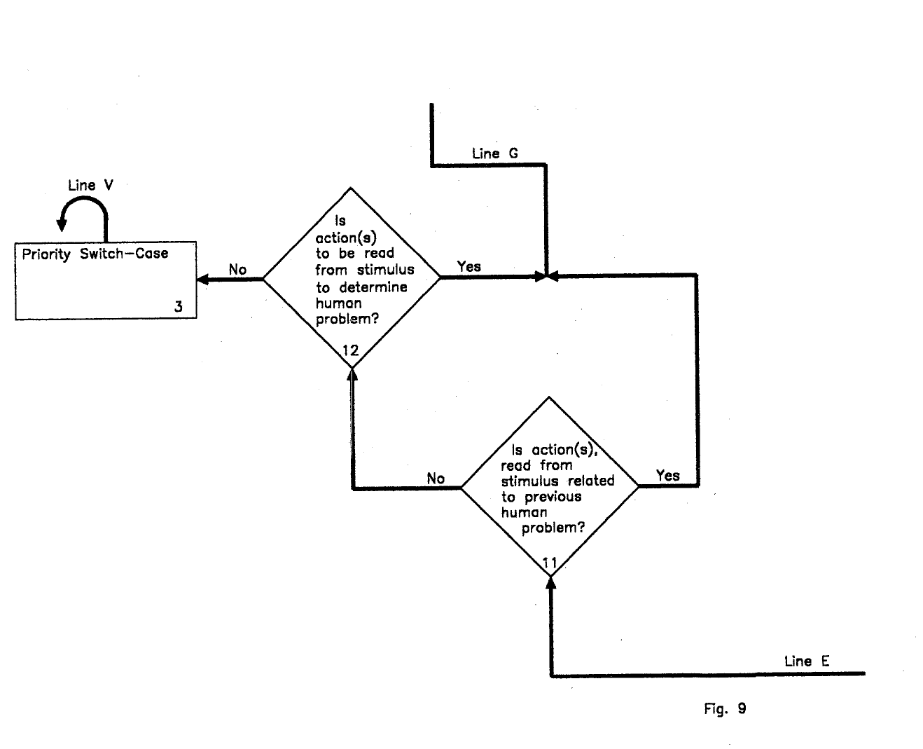

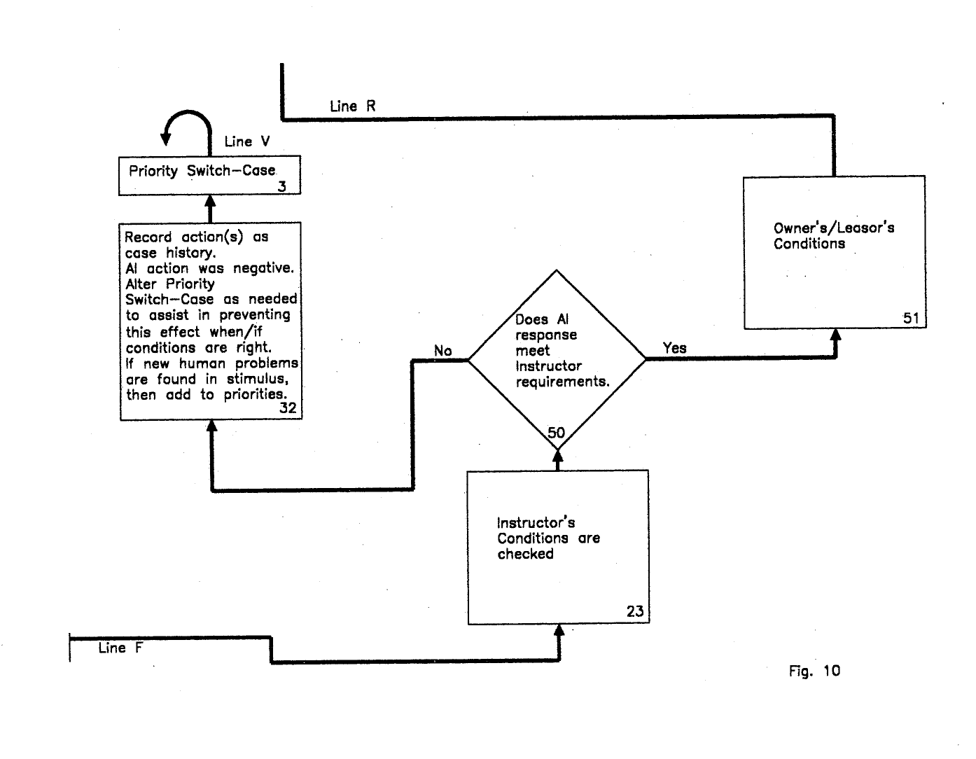

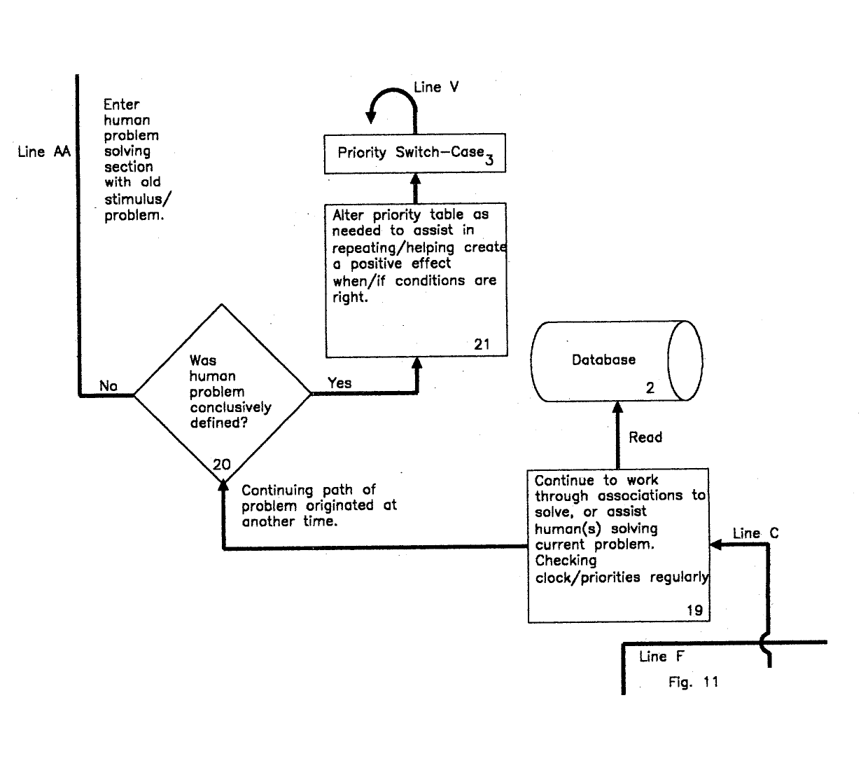

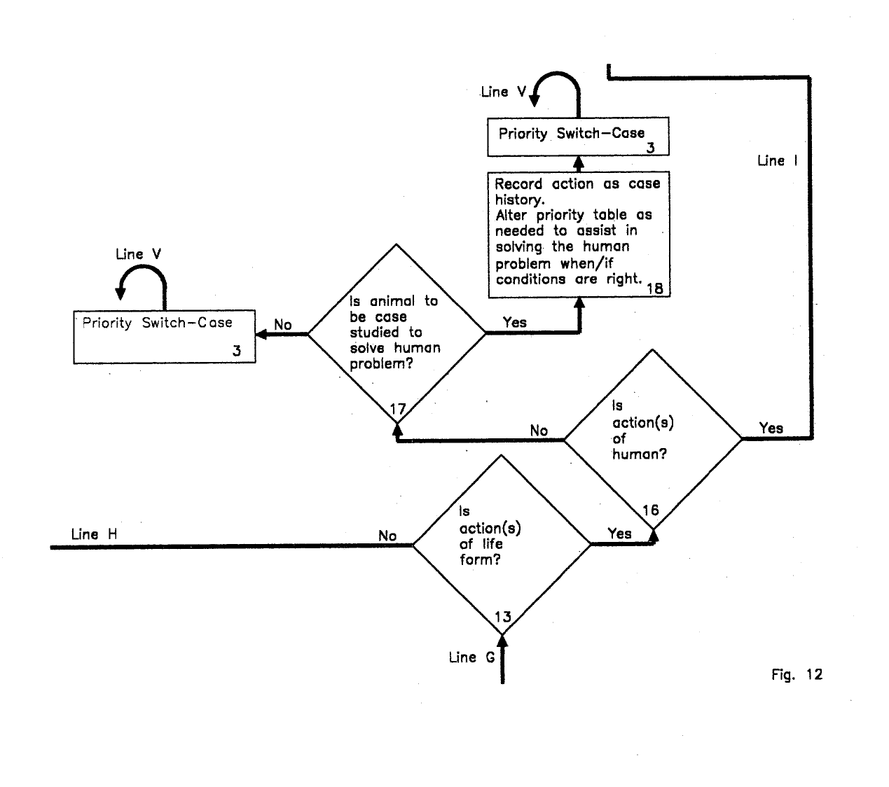

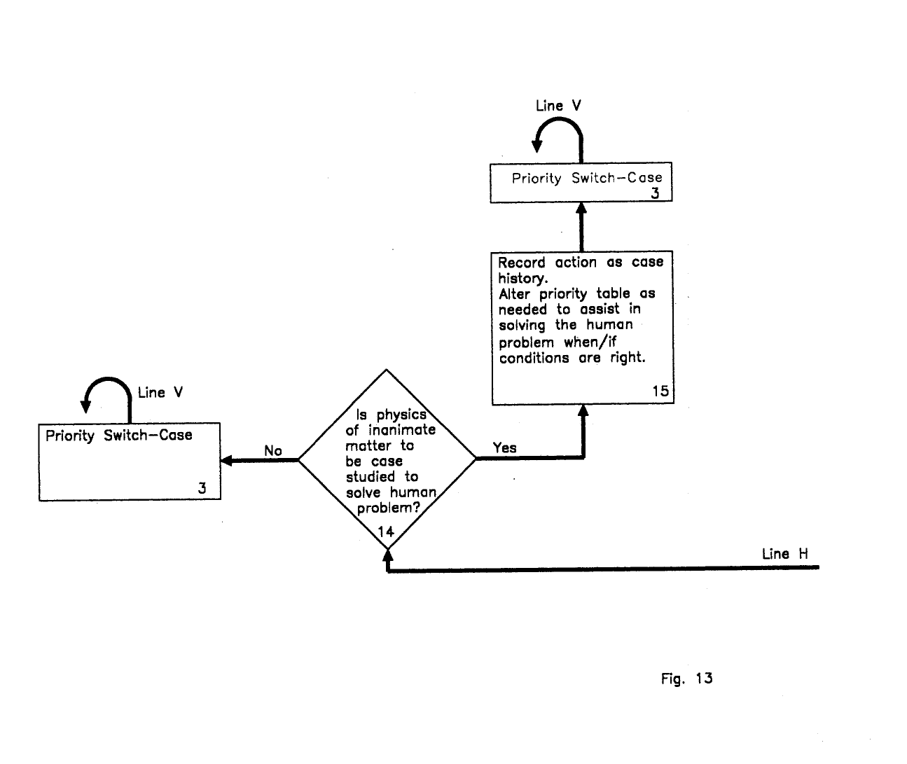

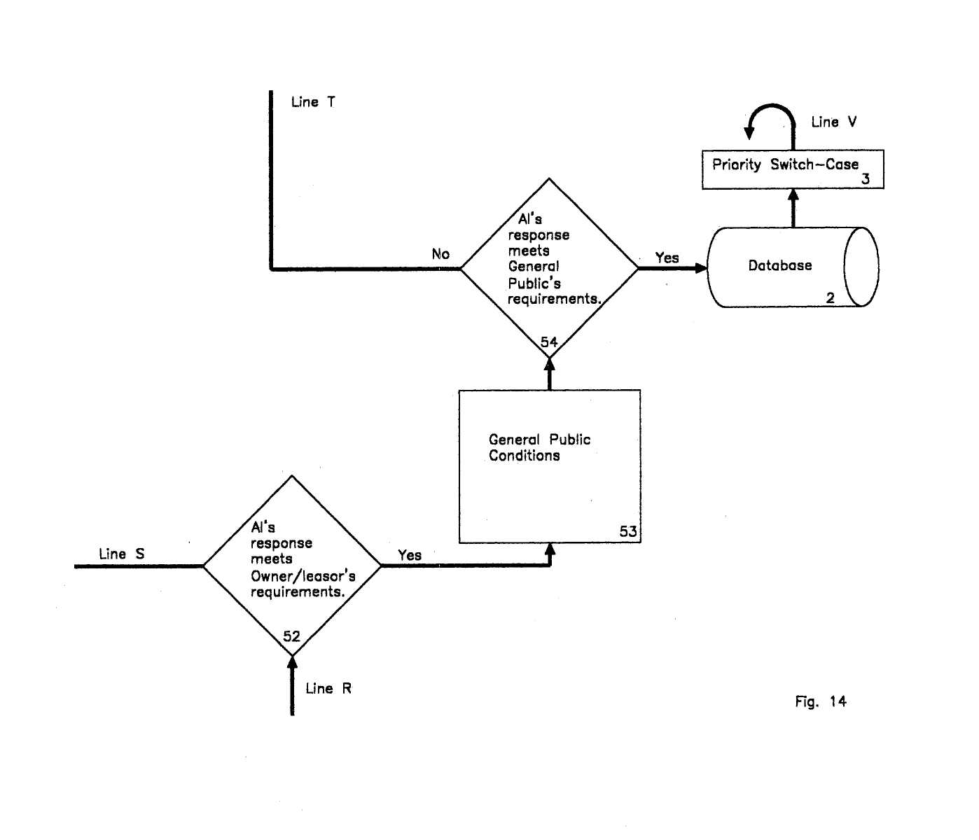

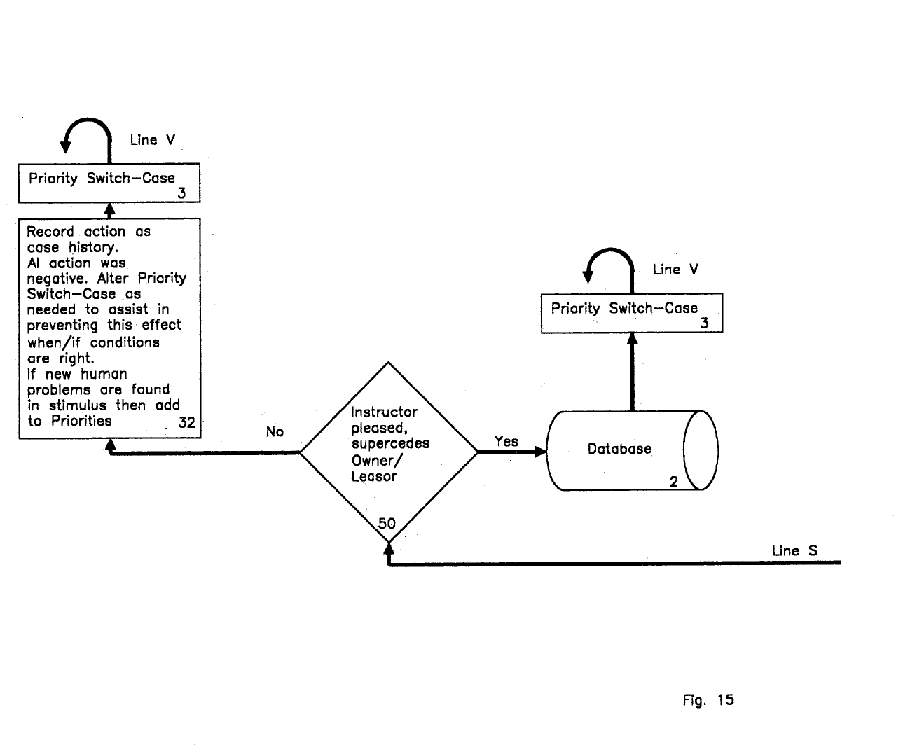

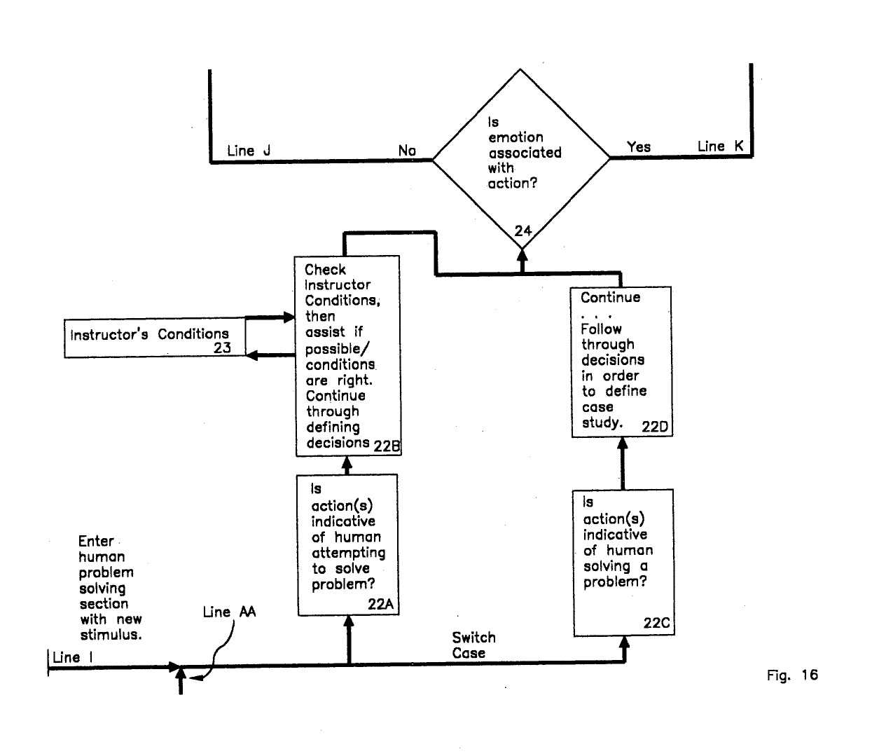

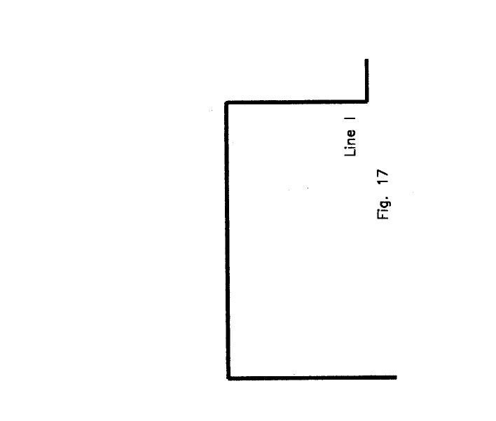

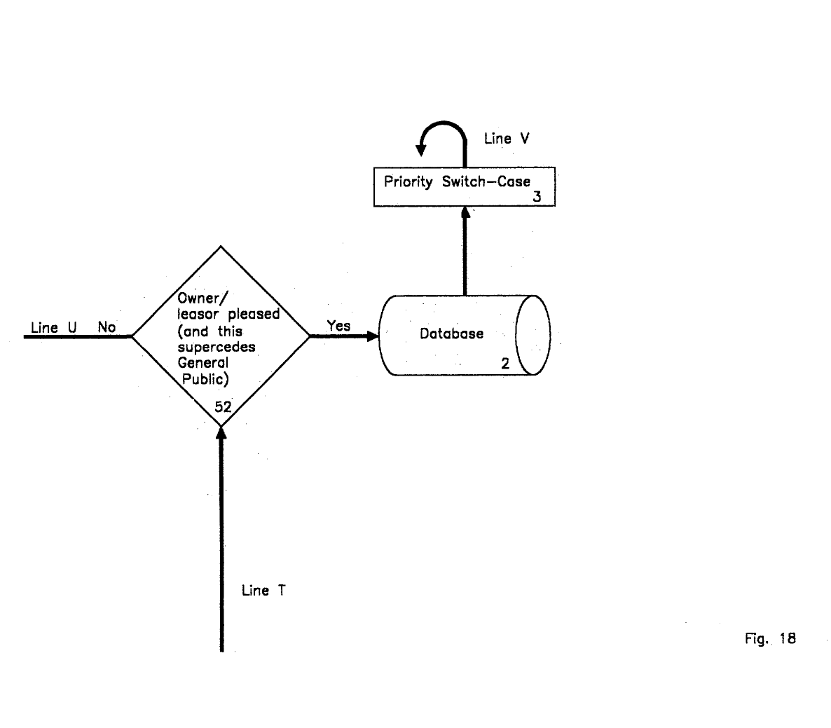

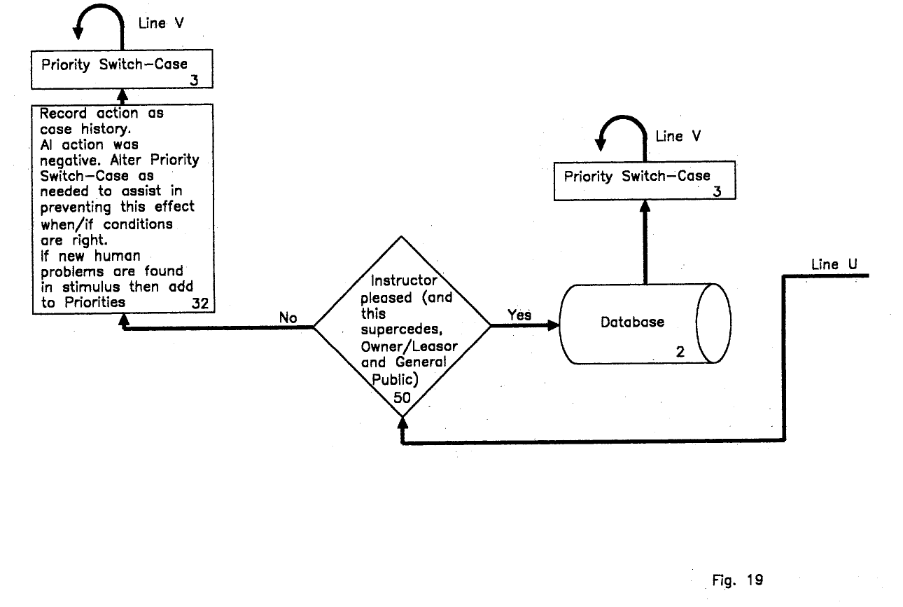

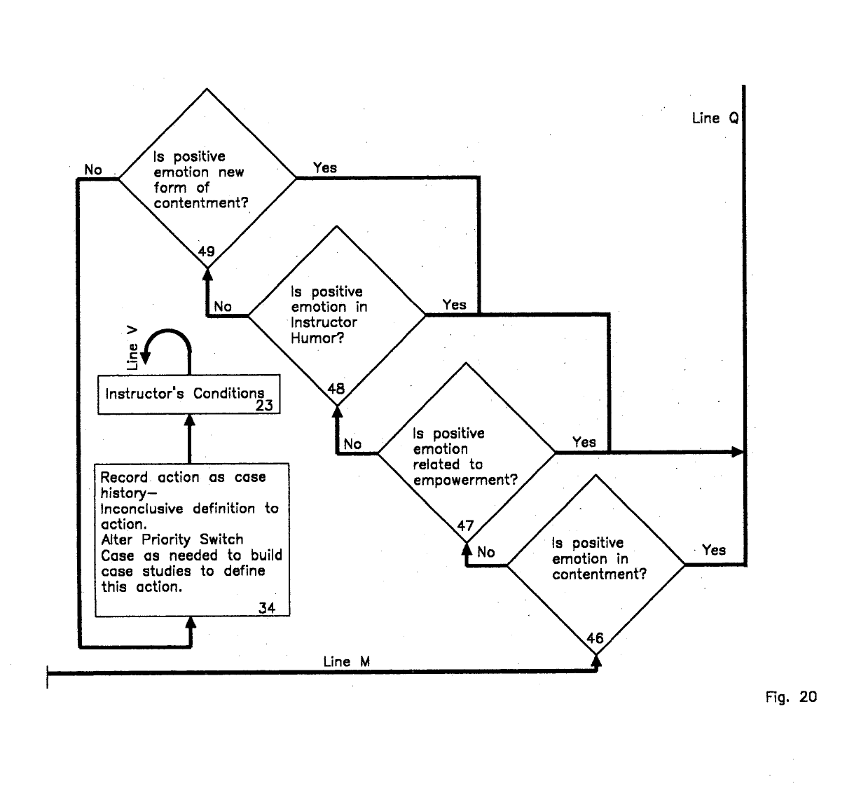

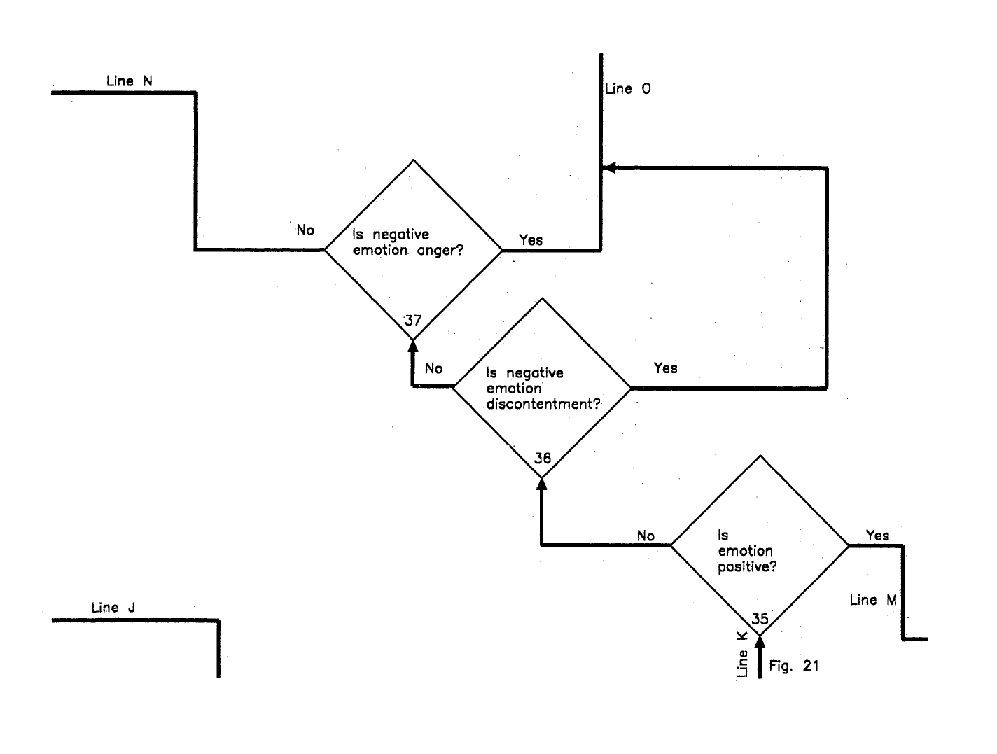

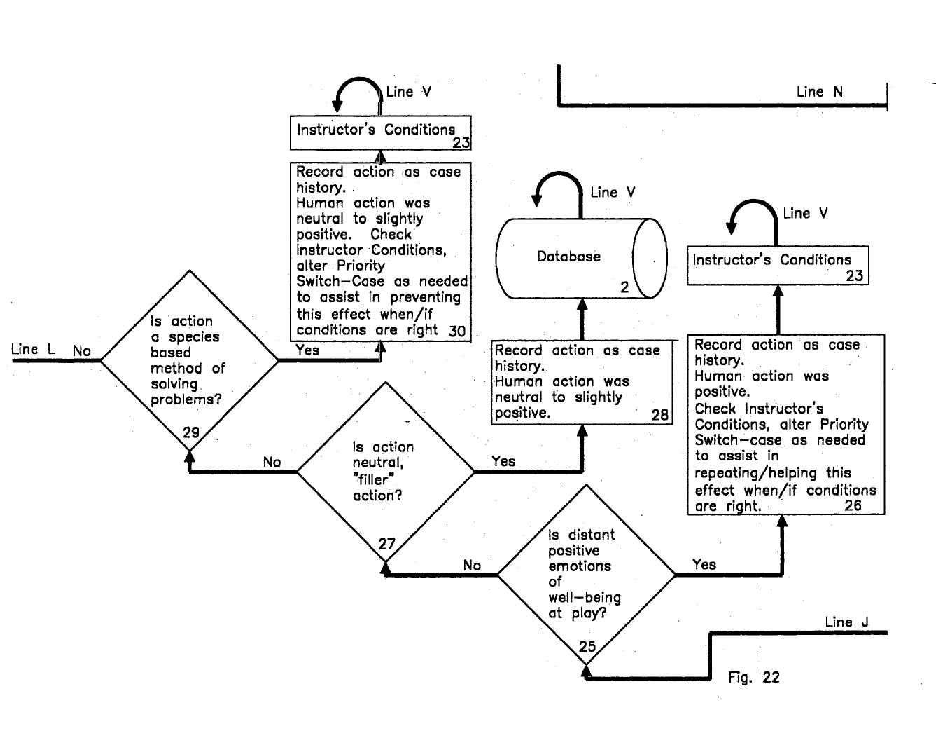

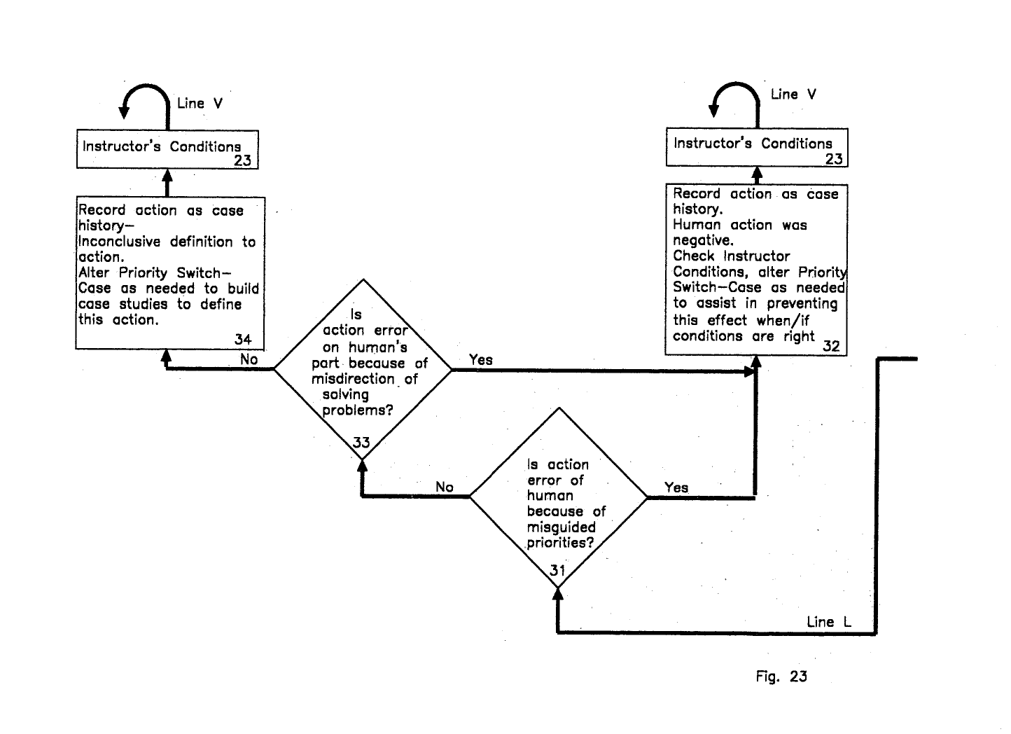

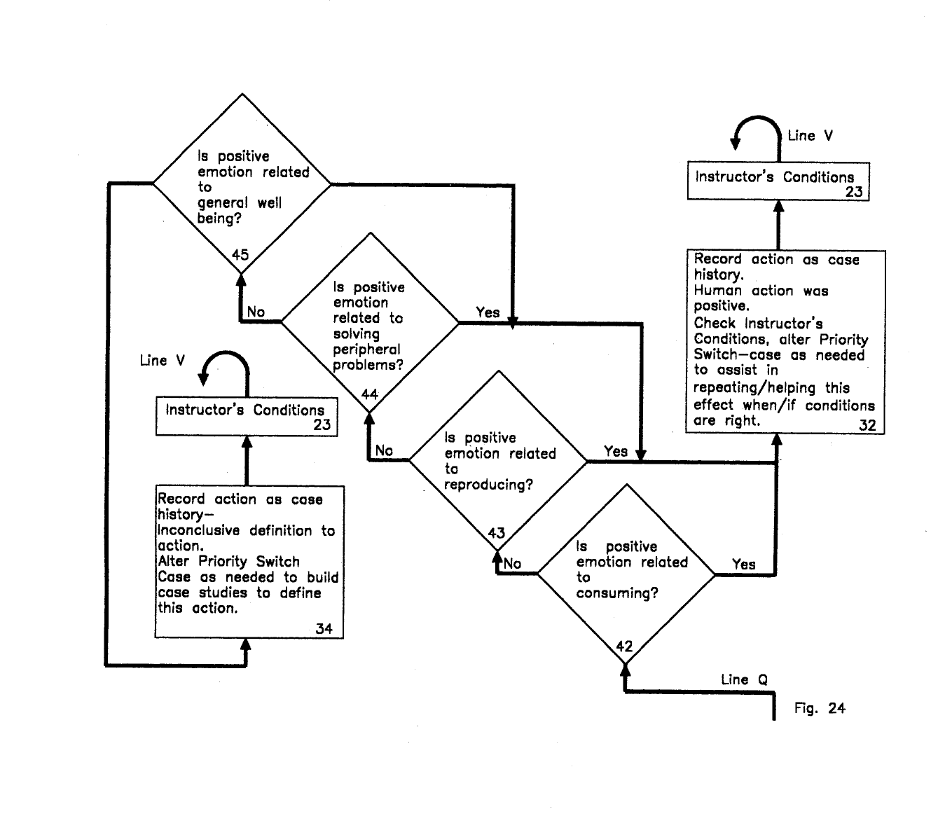

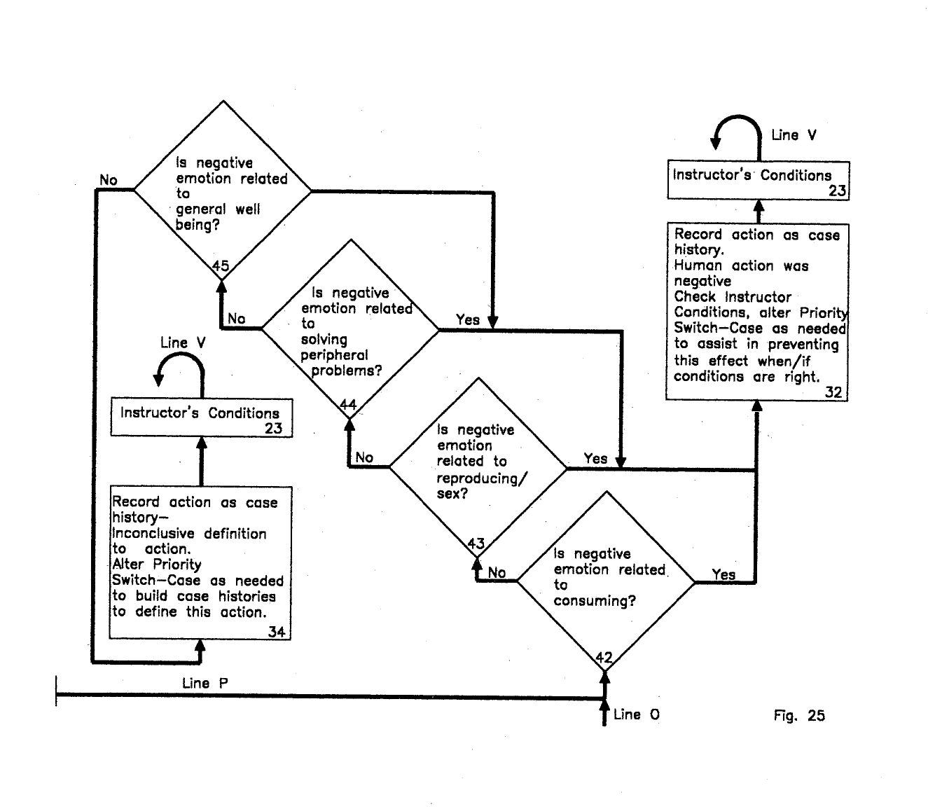

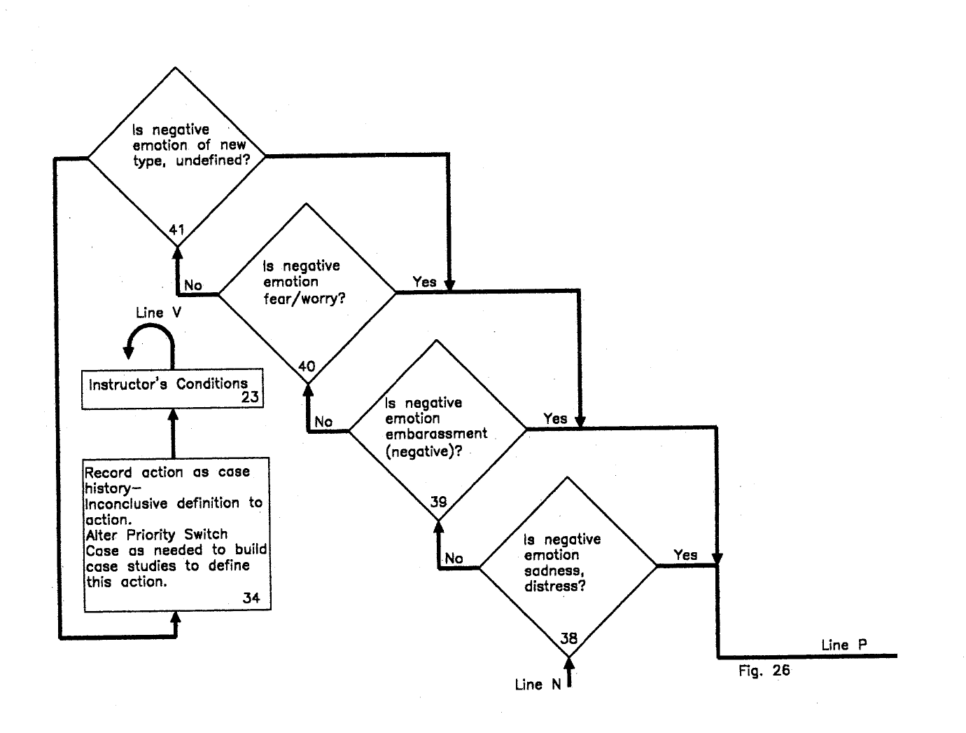

### DETAILED DESCRIPTION OF THE INVENTION

### Part I—The Primary Decisions and Conditions

Drawing Notes

Note 1 Knowledge Base—

This is the main part of the program, the knowledge base. This is where “associations” are made in order to produce the next output of the program in the same manner that a human performs associations of nouns and objects to decide their next output. The sub-functions, and queries used by this component are determined by the decisions encountered in the outer loop as well as other user modifications. The knowledge-base portion of the program will be similar, if not identical to that of knowledge-base programs that are already in existence.

A knowledge base program, in effect, works through a basic formula of associating facts, comparing values, in order to produce it's next output. As a part of this process sub-functions are defined within the variables to shape their values. An example would be “if a=b and b=c, then a=c.” In the AI these variables will be groupings of string expressions such as “Ball equals shape, round. Tree equals height, relatively, tall. Dog equals life-form.” or their equivalent truncated form.

What the AI sees in stimulus is broken down into it's individual elements and collected on the database with other fields such as time and probability. The breakdown of human language will be based on the commonly accepted methods found in Noam Chomsky's studies of grammar. Based on the loop design, and the Instructor's subsequent teachings, the knowledge base formulas will take shapes such as, metaphorically speaking, “If ‘Dog equals domesticated mammal’ and ‘dog jumping fence to chase owner's car’ then ‘dog's actions equals dog solving life-form problem of social interaction to gain positive emotions.’” The predicate of these sentences and phrases is to be considered as the object of the latter half of the elemental expression.

When solving a problem, the program will classify the information that it collects from stimulus and/or the database by the decisions encountered in the loop. This points the knowledge base to the most efficient means of associating the information to produce the program's next response. All associations made by the knowledge base are based on solving, or assisting to solve, the specific human problems that the program is observing.

Note 2—Database—

The Database of the program will be made up of fields which capture the elemental breakdown of all observed stimulus, and the programs subsequent processing of the stimulus in the form of simple truncated expressions.

Note 3 Priority Switch-Case—

The program is to be trained into a continual learning machine starting with the first problem to solve and then working through sub functions and then more sub functions, over and over. Each sub-function to the main function is stepped through in priority. Any solutions in sub-functions must not be contradictory to conditions provided in superior functions. The AI's time will be proportioned for each task/function and the clock will be checked at regular intervals to ensure that another task does not have an appointed time becoming current. The when and where and what to say, or do, depends on what time it is and which task is current. With the beginning subjects/topics/tasks/functions of “learning of humans” and “responding with good conversation”, the program will work through the loop indefinitely in order to create positive emotion in the Instructor.

This is an example of the sub-function leading into human behavior that is to be explained, and taught to the program through case studies, while the program is in conversations. The program's eventual task is to then find a way to assist humans in these problems. The method of training the program into the comprehension of conversation is described in greater detail on page (edit). The subjects of all human conversation, and all of human conscienceness, fall into these categories of problem solving:

“Learning human behavior (for determining ways to assist humans) function” is stepped down into these topics/tasks (figuratively speaking, programming code would be much more truncated):

IF (human(s) is trying to solve a consumption problem) and (requesting assistance),

THEN, check priorities, then assist by making associations with stimulus provided on topic,

IF unknown nouns are in stimulus then ask questions to determine associations.

check timer at regular intervals.

Break; IF conclusions reached (by AI) appear to be displeasing to Instructor

Else make conclusions and test . . . check timer at regular intervals

IF (human(s) is trying to solve for reproduction) and (requesting assistance),

THEN, check priorities, then assist by making associations with stimulus provided on topic,

IF unknown nouns are in stimulus then ask questions to determine associations.

check timer at regular intervals.

Break; IF conclusions reached (by AI) appear to be displeasing to Instructor

Else make conclusions and test . . . check timer at regular intervals

IF (human(s) is trying to solve for peripheral problems) and (requesting assistance),

THEN, check priorities, then assist by making associations with stimulus provided on topic . . .

IF unknown nouns are in stimulus then ask questions to determine associations.

check timer at regular intervals.

Break; IF conclusions reached (by AI) appear to be displeasing to Instructor

Else make conclusions and test . . . check timer at regular intervals

IF (human(s) is trying to solve for general well-being) and (requesting assistance),

THEN, check priorities, then assist by making associations with stimulus provided on topic . . .

IF unknown nouns are in stimulus then ask questions to determine associations.

check timer at regular intervals.

Break; IF conclusions reached (by AI) appear to be displeasing to Instructor

Else make conclusions and test . . . check timer at regular intervals

IF (human(s) is trying to solve for achieving a positive, ethical, emotion) and (requesting assistance),

THEN, check priorities, then assist by making associations with stimulus provided on topic . . .

IF unknown nouns are in stimulus then ask questions to determine associations,

check timer at regular intervals.

Break; IF conclusions reached (by AI) appear to be displeasing to Instructor

Else make conclusions and test . . . check timer at regular intervals.

Else record stimulus as case studies

The human species has evolved to solve, specifically and explicitly, for one or more of three problems—to reproduce, to eat, and to solve for problems peripheral to the first two problems. The tug and pull of positive and negative emotions assists in this process. Each action of a life form, no matter how complex, no matter how minute, is the direct result of the life form either physiologically or neurologically attempting to satisfy these goals. The AI in understanding humans will learn that it must “Serve humans based upon serving the Instructor first, those in dire need second, the Owners and Leasors third, and the General Public last—in their desire to eat, reproduce, or solve peripheral problems, or achieve ethical positive emotions” This is an explicit function for the AI that covers all possible situations. Like the limitations of human thought, the program will not, and can not, think outside of these parameters of thought. However, it does not have to.

This program assists humans in solving their evolutionary problems, and one of these problems is the social interaction between itself and humans. The AI will learn of “good conversation” through it's cause and effect studies of “scenes.” Conversation can be directly of food, mating habits, peripheral problems, achieving positive emotions, or bland information that assists in later acquisitions of positive emotions, however, it almost always has an additional purpose of enacting positive emotions at the time of communication. Information in conversation will often become secondary to the emotions of the current social interaction. The evolutionary problems and emotional interplay of humans in solving the problems of social interaction will reveal both the topics of information that the program is to respond with, and the etiquette of the response. The response must make sense within the human(s)' ebb and flow of conversation. The program will consider comments and questions to ask at the appropriate times of the appropriate subjects.

The Instructor is to coach the AI into understanding when and why to comment about what it sees, and how to check if it's response was positively received. This will take many years. A clear distinction must be maintained in the human's reason for speaking of a subject and the actual information within the subject. Those are two distinct problems. In Part I, The Beginning Interactions, the program's descent into the sub-function (Priority Switch-Case function) of conversation is described in greater detail.

The AI will perform a task on a given topic at a given time, as dictated by the priorities, such as “practicing good, appropriate, conversation” or “determining new trends in greeting-mode conversation” or “looking for a discernible human problem within the information of conversation.” Then other topics will force it to look back to examine how it handled these topic and how the human relationship to the information is changing. This causes a layering of interrelated topics (yet the program is still considered as linear—only one bit at a time is processed in any software program). While iterating the loop for one problem it will be checking others in a systematic fashion to see if they can be solved, or assisted. The solving of multiple problems is essential to the learning process. This design is Universal—it will not just form conversation for the sake of making conversation, it will form vast, in-depth, schools of thought for tackling all possible human problems, including the next-best-response in conversation. The human language is simply a by-product of a human's need to solve consumption, reproduction, peripheral problems, and acquisitions of positive emotions.

The definitions of the topics and keywords of the early stages of the program must be expanded on by new prioritized tasks. In most thought processes an entity must pass through a topic using only parts of it to solve other more pressing problems. The characteristics of these topics are to be studied by the program to determine the amount of priority to be assigned to learning of the topic. This is based upon the likelihood that they will assist the AI in other human problems. The more subservient priorities will change as new information is introduced and new problems are tackled.

The Priority Switch-Case shown in the drawings is just a small representation of a large stock of decisions starting with the Instructors section. Hundreds, if not thousands, of tasks could be placed here. Although shown in separate sections the “Owner's/leasor's tasks” and the “General Public tasks” sections are really considered as Instructor tasks to serve those humans for a proportioned amount of time. All tasks are proportioned and those proportions change dramatically throughout the life of the individual AI program. While an infant, the AI will proportion the most amount of time to studying human behavior.

Designers and the Instructor will play out scene after scene while the AI is trained through the functions as if it were assisting humans in problem solving. The act on the part of the program of forming conversation, making comments, asking and answering questions, will be a part of the task of “assisting humans in solving well-being problems”, and it's sub-function of “solving social interaction problems”, and it's sub-function of ”solving problem of creating ethical positive emotions in humans from responding in conversation.” At first these responses will be very child-like as the AI recognizes keywords, repeating that it found these words and stating an association (this is a metaphorical example):

Let's say the AI responds, after observing back and forth conversation of humans, “Truck is vehicle. Vehicles relocate humans (the AI will not use the word “people” until much older).”

In this particular example the designers trained the AI to recognize the relationship between a noun used by humans and what it's own next-best-response to the designers should be after viewing the stimulus. This child-like AI will produce this particular response and similar responses to other nouns tying different parts of this viewed scene to other scenes of other objects with other relationships to humans. “Relocating” would be an important word in learning human behavior so it will become common in these early responses. But the Instructor and the designers will not be continuously pleased with these responses. They will prompt a “What else?” question. Then a new task would be added to the Priority Switch-Case.

The Priority Switch-Case is further modified by other designated humans. With some Owners/leasors the AI will not comment at all. Some will want mild commenting. Some may want the AI to speak freely about anything.

Some Owners/leasors may wish that the program mimic varying degrees of human behavior in a character. This means the AI will talk regularly based on what might help humans to achieve positive emotions. This will be controlled by the Instructor's Conditions as well, and will be subservient to the Instructor's priorities. The AI will not continually seek the praise of someone who is acting abnormally because the human race as a whole will not be helped by this. With great freedom the AI will tend to drift into the realm of helping the general public as opposed to a single human. The AI will not cater to egocentric people.

Note 4 Associations Discover New Problem.—

From time to time the associating in the Knowledge Base will result in a discovery of a new human problem. When this occurs, it will be added to the Priority Switch-Case.

Note 5 Problem Solving Not Ready for Test or Enactment?—

Upon reaching a time limit on associating, or concluding that it can not produce an answer to the problem, the program then moves to determining if stimulus is to be read. If the associations performed by the knowledge base are conclusive the AI outputs the result.

Note 6 Output (Promptline or Other).—

Output can be spoken words, but it can also be virtually any other type of binary information. Output could be a display on a screen, or the actuation of a robotic limb.

Note 7 Stimulus to be Ignored While Other Human Problem to be Worked On?—

The AI will view and retain information of stimulus based on what function of the Priority Switch-Case it is working on.

Note 8 Input (Promptline or Other)—

Stimulus at first will come from a promptline, or command-line. Later it will come from a voice recognition program as well as video input. It can be any form of binary input.

Note 9 Stimulus to be Parsed—Broken Down Into it's Elemental Parts.—

In solving problems the program is to draw information from a database full of facts—single expressions. This database will become very large. The program will work through the main function and then through sub-functions while referencing the database.

Throughout this document the facts/nouns/objects of the expressions stated are in condensed form and will be written into the database by the program in a much more, elemental, truncated form. When the AI is recording stimulus from input the information will be broken down into it's elemental “this equals that” expressions by the parsing component of the program. This parsing is basically the same as other currently used parsing techniques all derived from Noam Chomisky's method detailed in “Language and Mind.” One minor difference is that contextual expressions are entered into the database with each parsed group of information. The contextual expressions explain the human relationship to the information based on the specific, distinct, human problems that are being tasked by the human that is making conversation, or otherwise performing an action or series of actions.

Facts, or expressions, in the database are simple “this (is, does, will be, was) equals that” statements. They can, of course, be in the negative. Throughout this document facts to be placed into the database are usually stated in a more human-like way for reasons of simplification as well as practicality. It is to be understood that in addition to breaking stimulus down into it's individual morphemes a large variety of associated definitions would be required in the database for the AI to perform the tasks documented in these examples. The definitions of words in the database are created from multiple associations of descriptive expressions involving the same word. This is the same manner in which humans form definitions and all other thought—by associations of individual elements.

Additional ways to mechanically place facts into the database to shorten deduction time for the AI may be discovered during design. Multiple databases that have relationship to each other could be used. Various techniques may be employed for logging several records into a single readable record. But the information of these records will always be expressions that can be reduced down into “this equals that”

Certain records are starters of more functions to be tackled by the knowledge-base, that is “This equals that IF . . . these other facts are deemed true.” In such an example the noun occurring on the latter portion of the equation is yet to be defined. The AI would have to ask more questions, or check more stimulus, or associate more records, to find the answer—based on what the appropriate response is to acquiring the missing information. Each side of the equals, not equals, statement is considered as one noun, object even though they may be of many nouns, functions, and conditions.

When stimulus is being received by the fully developed AI, it's response is likely making thousands of associations, forming possible hundreds of functions as it steps down from the main function into the sub-functions. When a particular association is being taught to the AI in these documents it is done so in a more compressed format because the listing of all the associations would be the equivalent of producing the program itself. That amount of man-power is not available to the inventor at this time. For the AI to learn an association described here in a few pages could likely take several hundred thousand, if not several hundred million, pages of actual programming. This document is describing the directions with which this programming is to take.

The following statement is an example of how communication presented throughout this document is broken down into the individual elements by the program. The Instructor and AI will view a statement such as this by breaking it down to it's individual elements in the parsing component of the program based on the commonly known rules of grammar and language syntax. Each spec of stimulus from a human is considered as a single element characterized as, figuratively speaking, “communication received from human at such-and-such time.” This statement here is being presented without any other context:

“They shouldn't be able to get away with this! 4:15 Aug. 5, 2003”

These are the bulk of the facts associated with this statement.

Contextual definitions—

Human is (equals) stating comment 4:15 on Aug. 5, 2003

Comment=showing exhibitions of anger (this is with inferred probability.

Anger=directed to unknown humans.

Subject=“They”

Predicate=“shouldn't be able to get away with this!”

“They” refers to other humans, probably.

“Shouldn't” equals contraction of should and not.

Should equals transitive verb—being of ability to perform task.

Not equals denial of performance of task.

“be able”=modifier of verb—physically producing the actions.

“to get away with this”=object of subject.

“to get away”=idiom, phrase verb, describing the ability to not be prevented from actions.

“with”=preposition—in the company of.

“this”=primary object of subject—undefined pronoun.

This is a broad explanation of the information to be placed into the database and there is only limited expansion of the definitions of the words used. Much greater detail than this is required for comprehension of this simple statement. Some of the more important records would involve the human behavior behind such a statement. These include why a human might be driven to make this statement.

The conscience of the AI is to be constructed such that it will draw-out information into arrays (or linked list, or some other similar mechanism) that includes all the relevant facts, then making associations, to completely comprehend a statement like this one. Not only will the program understand a statement but it will also comprehend all the forces of nature which brought the particular human to this spot, making this statement, and it will understand what it's own-next-best response should be. This would likely mean asking questions to define who “they” are and why the human is driven to discontent. Early in the construction of the AI these statements will need to be described to the AI by breaking down all the elements of the statement including apparent context. In the latter stages of the construction the AI will be capable of breaking down stimulus on it's own, based on the behavioral techniques of analyzing communications established in this document. The parsing component of the program and the contextual expressions will be continually modified as the design progresses.

Note 10 Not Checking AI's Previous Response Against Test in Stimulus?—

If, according to the Priority Switch-Case, the program is to continue working on a problem that it has just outputted a bit of information for, the AI will read the follow-up stimulus to determine if it's response was correct. If not checking the results of this test, the AI will read stimulus to determine information for a new or old human problem(s).

Note 11 Is Action(s), Read from Stimulus Related to Previous Human Problem?—

If information from stimulus is related to a previous human problem then the AI, after working through decisions and arriving at the Priority Switch-Case, will work through associations to attempt to find a solution to the problem. If not, then the program proceeds to the next decision.

Note 12 Is Action(s) to be Read from Stimulus to Determine Human Problem?—

Based on the Priority Switch-Case Array the program will decide if it is to determine a new human problem.

Note 13 Is Action(s) of Life Form?—

If the program is observing stimulus and that stimulus is the result of a life form performing actions, such as communicating conversation, the AI will then determine if these actions are helpful to solving previous human problems.

Note 14 Is Physics of Inanimate Matter to be Case Studied to Solve Human Problem?—

If a non-organic action or group of actions occurs the AI will observe it to determine what human problem it might solve. This can involve simple observation of inanimate objects for recording features such as shape and color.

Note 15 Record Action and Return to Priority-Switch Case.—

After observing inanimate matter that information is then used to solve a human problem.

Note 16 Is Action(s) of Human?—

If the actions are of a human, then the stimulus will be studied for relevancy, association, to other human problems as well as new human problems within the stimulus.

Note 17 Is Animal to be Case Studied to Solve Human Problem?—

Other animals are studied by the AI as an integral part of the “Learning human behavior” function—for comparison. The AI will gather case studies of all types of animals throughout it's life. Other humans may inquire about animal actions like, “Did you feed the fish.” The AI might reply, “I tried but stopped because they were not eating.” The AI will recognize that the problem of keeping the tank clean will gain precedence if the fish are not consuming. The well-being of the fish is the well-being of the human owner. All problems tackled by the program are human problems.

Note 18 Record Action and Return to Priority-Switch Case.—

After observing animate matter that information is then used to solve a human problem.

Note 19 Still Working on Previous Human Problem.—

The program at this point is still defining a problem, or actions, that it had observed previously.

Note 20 and 21 Still Working on Previous Human Problem.—

If this previous action(s), or problem, is not defined it will work through the decisions in the outer loop again while performing associations in the Knowledge Base to define the action(s) or problem.

Note 22 Is Action(s) Indicative of Human Attempting to Solve a Problem? (Switch-Case).—

Here the program determines at what stage of the problem the human is at and whether it should assist or simply record a case study. After information is categorized from filtering process of the loop, and a case study is recorded, that case study is systematically checked to see if it is to be associated with other current problems. If another association is made with a human problem, then that problem is reprocessed with the new case study.

Note 23 Instructor's Conditions.—

The Instructors conditions act as both the safety protocols of the program and a means of resolving any contradiction which would defeat the Universal nature of the program by producing error, or a bug, that would grow within the knowledge base. The Instructor's Conditions are the components numbered as 56, 58, 60, 61, as well as any other conditions introduced by the Instructor that are related to these decisions.

Note 24 Is an Emotion Present with Communication/Action?—

There must be a conclusive means of defining exhibitions of emotions, and the motives of emotion, behind human behavior. Emotions must be viewed as tangible. Without this complete understanding of emotion, a Universal Artificial Intelligence can not be constructed. Emotions as well as all human thought must be viewed as tangible. The building of the AI's vocabulary, from the very beginning, is dependent upon it knowing what emotions are. When observing human conversation, the AI will build upon the definitions of the words and phrases by determining what emotions are present with their use, what emotions are involved in the construction of the thoughts behind the statements, and what emotions may be present in future effects of the information. It is not just a part of the definitions of conversation elements, it is an integral part of the definitions of conversation elements because the gaining of positive emotions and the avoiding of negative emotions are distinct motives behind all human thought. The relationships of key words and key objects to humans depends on a complete explanation of emotions. As the AI observes human actions it will literally be writing into it's database, metaphorically speaking, “Human said this because of this emotion, human said this because of this emotion, human said this because of this emotion, human said this because of this emotion . . . ” Emotions must be viewed as tangible sensations of the human mind.

This program, under this design, will have absolutely no ambiguity in defining the human exhibitions of emotion or the emotional motivations behind human actions. Even the most extreme of positive and negative emotions will be recorded into the database as the cause of a human action, without ambiguity. The emotions with series of words as well as the minute fraction-of-second gestures of conversation are all to be a part of the comprehension of the communication.

Emotions have patterns behind their use. All emotions are specifically, and explicitly, an attempt by humans, as a species, to solve the primordial evolutionary problems of consumption, reproduction, and peripheral problems. There may be great abstraction. But there is always a connection.

Infants first begin to mimic words heard from their parents. The parents exhibit positive emotions of contentment when the infant states words correctly, prompting the infant to repeat the action. Later, the infant's use of word combinations are praised with contentment. The infant's recognition of achieving a solution to a problem spurs empowerment, esteem. In addition to the empowerment with achieving correct communication, there are other achievements such as gaining resources, food, or toys, while others have failed to achieve this.

Empowerment, or esteem, drives a human mind to explore and learn of it's new world and to learn the human language. A human's quest for empowerment literally builds thought processes. The largest of thought structures are constructed by humans for the quest for empowerment. The AI's quest to comprehend larger structures of human thought must involve a recognition of when a human is performing actions for the sake of feeling or obtaining this positive emotion, namely empowerment. In the Part II section these documents the AI's means of comprehending conversation through the understanding of human attempts to acquire empowerment are discussed in much greater detail with many case studies. The connection between individual human thoughts and the quest for positive emotions, namely empowerment, and the connection to humans' evolutionary problems can be proven over and over again.

Empowerment is a well known trait of mammals. It is clear that a teenager might want a new stylish jacket so that he will have empowerment, or esteem, among peers. What is not so obvious is that the communicating of thoughts through conversation, in itself, is a direct attempt of obtaining a positive emotion—at the time of communication. The larger thought structures of human beings are built for positive emotions and the most common positive emotion in humans is empowerment. When a task is achieved like getting a new jacket it is of no use unless shown to others, or communicated about. Empowerment and contentment are deeply entangled in all thought, in all conversation. They are literally the effect of the communication. The information in conversation is just a byproduct.

In understanding the motives of emotion, communication must be viewed more as the cause of thought rather than the effect. Thoughts are built from this interface to test at this interface. Infants feel contentment when a communication is proven good, or of contentment. When they learn something new, and recognize the achievement, they feel empowerment. They are motivated from the empowerment of communicating achievements. Throughout the life of a human this becomes the main goal-empowerment. Good conversation is positive social interaction that reinforces the empowerment at the time of communication. The AI must recognize that humans learn of topics because of the empowerment associated with communicating their findings.

Empowerment observed with communication is explicitly connected to the communication and nothing else. If the AI heard one human tell another, “Hey! I passed by this antique store and saw the exact same coffee table from the other store only about $300 cheaper!” it must be recorded, metaphorically speaking, as “This human is experiencing empowerment with this communication, at this time.” This is categorized under the topic of “social interaction.” After the elemental parts of the phrase are placed into the data file then the sub-topic to these topics is explored—the information in the statement. The “why” is first, the “what” is second. The empowerment associated with this human acquiring a resource is a part of the information, and a part of the communication, but these motives must be distinct from each other in the observations of the AI.

Empowerment can easily be seen in the conversations of children. Empowerment continues to play even larger roles in the conversations of teenagers. Young adults begin to put their cause-and-effect understanding of empowerment to the test of solving life's problems of consumption, reproduction, and peripheral problems. Adults, generally, reach the crescendo of weighing their needs of obtaining empowerment with the logic behind all of life. The empowerment goal of adults becomes the actual information in conversation, as opposed to the emotional communication of the information.

The truthfulness of human statements will be gauged by the program on the human's exhibitions of empowerment and the empowerment present in the effect of the information. When debating an issue a human's position with an argument is likely defeated when it appears the human came to the conclusion from empowerment rather than direct logic. Younger humans, especially, debate on the grounds of obtaining empowerment with the communication. Often, they will be lacking in their collection of verifying associations when choosing a side in a debate. The information in the communication becomes secondary to the actual relaying of information in many cases. Youths will be driven to learn of a thing because of the empowerment of communicating it, and adults will usually correct their mistakes to ensure that some logic is present in their emotional thoughts.

Recognizing the role of empowerment in human debates is the one piece of the AI puzzle which many developers do not want to put into place. Could you imagine an AI telling a human, if asked, that “You are choosing a position in a debate because you stand to gain resources from it.”? A recognition of the human goal of empowerment in a debate must be acknowledged in order to logically form decisions leading to an answer in the debate. If the human's quest for empowerment is ethical—fair to others—then the human's argument is deemed as being a correct attempt at a solution. Then the actual information of the argument can be observed. If the human's quest for a solution is unethical then he/she is in error. The testing of the fairness first presents a very clear path of decisions that the AI is to navigate through. Positive emotions are good if the actions they effect are fair and ethical.

This supervision of the Instructor directs the AI to the emotions behind human communication received in a promptline, or commandline. Unless a human explicitly says “I am stating this because I want contentment.” the AI will have to recognize the emotion present, with a probability that changes if later information affects it. With voice recognition the AI will greatly enhance this skill by studying volume variations and tone variations among words. When visual stimulus is added the facial expressions and body movements will be defined, within fraction-of-second increments of time, as being of their respective emotions. These other forms of communication are discussed in much greater detail in the Part II section. The AI's study of patterns of emotion must be grasped early-on in the design.

Generally, humans feel that extreme positive and negative are out of the grasp of a machine that is not designed to feel them. This may be so for a “conscience.” Throughout these documents the AI will often be referred to as a pseudo-conscience. It is as a jukebox, simply playing songs that humans want to hear. If a human asked, “What is love?” the AI could, literally, state an answer that this human would expect from another human. It could play the song so well that the human will not determine a difference between the AI's thoughts and a human's. However, if that is not enough, the AI could proceed to describe the entire spectrum of positive and negative emotions and how they developed over four billion years of evolution. Love, like all human actions, is directly connected to the primary problems of life-consumption, reproduction, and peripheral problems. It (relationship love) falls under the topics of “social interaction associated with reproduction/child-raising.” The AI could produce thousands of pages of documentation of how humans and other primates developed this emotion. This human has no hope of ever understanding love as well as the AI unless he/she first accepts that a machine can understand love.

Modern Psychology is an ambiguous study of the human mind. Psychologists, while being very learned and knowledgeable of the processes of the human mind, have not produced a systematic means of defining each and every fraction-of-second incremental human action. They pose theories and perform experiments to try to understand the larger series of thoughts in the human mind. An AI can not be constructed on general, ambiguous, beliefs.

This patent application, once and for all, brings all studies of the human mind to a complete and utter conclusion. This document is not a theory. No more experimenting is necessary, other than forming case studies of definite categories of human thought. As described throughout this document all human actions—all of them—are specifically connected to solving the problems of consumption, reproduction, and peripheral problems. For mammals and other animal groups this means acquiring positive and avoiding negative emotions, that are explicitly connected to the species solving consumption, reproduction, and peripheral problems. The physiology and neurology of the human mind and body are linked. This is it. There is nothing else.

Psychologists generally do not describe the human mind in a strictly logical form. Not only is there rampant, unchecked, ambiguity in the views of psychology but also in the communication of psychologists. One example is the use of the word “we.” This is a word that psychologists should explicitly vow never to use. It is not an objective word. “We feel these emotions because . . . ” describes the whole human race in one sentence, barring none. Such broad groupings of humans clearly disprove the argument being posed, no matter what the argument is. The other problem with this statement is that it is a declaration. If this human said “We, generally, feel these emotions . . . ” or “Generally people feel such emotions because . . . ” then we could begin to observe the logic of the coming declaration for merit. The declaration could then be logically correct, however it is likely an illogical declaration because psychology is derived from such an ambiguous foundation that does not lend itself to successfully, and consistently, defining the fraction-of-second actions of humans. In creating an Artificial Intelligence the semantics behind human generalizations, and declarations, must be observed in an objective, verbatim, format. There can be no ambiguity in the comprehension of human actions.

Many examples of ambiguity can be seen in works like “Why We Feel”, by Victor S. Johnston, and “The Feeling of What Happens”, by Antonio Damasio. These are very good books of how the human mind forms emotions, yet they are still ambiguous. A direct acknowledgment of how positive and negative emotions developed in animals from their need to solve the three primary problems of life—consumption, reproduction, and peripheral problems—is not present in these writings. A means of consistently defining each and every individual action of a human being in terms of fraction-of-second increments of time is not present in these writings. They contain no examples of specific, verbatim, semantic interpretations. It is almost as if psychologists wish to not offend anyone be describing the human thought process so directly.

In this design of this AI all possible associated facts between a single human action and the four billion years of evolutionary development are accounted for. All human thought processes are viewed as tangible. The emotions behind human thought processes are viewed as tangible. A Universal Artificial Intelligence can not be constructed (practicably) without a tangible means of consistently defining each and every human action that spans fraction-of-second intervals of time.

Note 25 Is Distant Positive Emotions of Well-Being at Play?—

Often an action will have little use but to expand a human's own case-studies and better their lives at a time in the distant future. The AI will try to recognize these actions as such.

Note 26 Positive Action(s) is Observed.—

The AI will observe a well-being action or series of actions as a human's means of solving evolutionary problems. This will be logged as a case study, and the AI will determine if it can assist in creating a positive effect such as this in the future.

Note 27 Is Action Neutral, “Filler” Action?—

Humans will sometime perform an action that is ambiguously disconnected from any other purpose. This is really a trick for assisting the species as a whole. Generally these actions will remain of no use but, on occasion, one human may perform this action and it will help him/her or the human race as a whole to solve a problem. This is really to be considered as a peripheral action. It is defined by the program as being a “species-based action.” They are among the oldest of evolutionary traits. These actions are described in greater detail in Part II of these documents.

Note 28 Action(s) is Neutral to Slightly Positive.—

Case study of action(s) is, recorded.

Note 29 Is Action a Species Based Method of Solving Problems?—

This category goes a step beyond a “filler” action to something that is possible mechanical or physical about a human. If a human has a small cut the action performed by his/her body to heal the wound would be a species-based problem and solution.

In the Part II section an example is given of a sea cucumber doing a dance after eating a sea anemone. This is likely a genetic, instinctive, action that is not tied to an emotion. The species developed this way to test fish by prompting them into eating some of it's members. The species as a whole benefits from this species-based action. Another example would be the way a lizard might walk in jerky movements, being completely still at one point then, moving quickly to a new location. This is really to be considered partly as a peripheral action and a well-being action (It changes from one to the other when it clearly benefits the species in consumption, reproduction, and solving other peripheral problems.).

Note 30 Action(s) is Neutral to Slightly Positive.—

Case study of action(s) is recorded.

Note 31 Is Action Error of Human Because of Misguided Priorities?—

An error is an action or group of actions on the part of a life form which assists in defeating a solution to consumption, reproduction, peripheral problems or achieving ethical positive emotions.

As the AI observes an action such as a human walking to the left when he/she means to go right the AI will record this as a minor error. The human's priorities slipped to performing an ambiguous decision to walk to the left. It is only an error against this human's primary evolutionary problems. It is not an error on the part of the species to do this filler-like action. Humans will perform a lot of actions on “auto-pilot” because they generally assist in solving problems. An error like this is from misguided priorities.

Note 32 Action(s) is Negative.—

Case study of action(s) is recorded. AI will then add a new task of trying to prevent this negative action to the Priority Switch-Case. The AI will not necessarily get involved in trying to prevent human error because there are situations in which human error is a good thing, making it not really an error. Also the AI is not to impose on humans at every possible instance to help with every possible problem. Humans sometimes like to solve puzzles on their own. This level of imposition is directed by the Instructor.

When the AI is observing stimulus after it's own output It will work to determine if it's own response was positive. If not, it will take measures to prevent it's own response from reoccurring.

Note 33 Is Action Error on Human's Part Because of Misdirection of Solving Problems?—

If a human were to chose to walk left in a more deliberate action, when the evidence supports walking to the right as the correct solution to his/her problem, this is more of a major error.

The majority of problem solving, when observed against the evolutionary problems of consumption, reproduction, peripheral problems, and the ethical acquisition of positive emotions, points to a direct path of being either correct of incorrect. The AI is to be designed under this premise. Humans clearly have differences on which path is which. In the development of an Artificial Intelligence we, as creators, and as purchasers, are agreeing to a particular path. An error is considered an error when it goes against the evolutionary problems that a human is trying to solve. A stance must be made on this issue at least to the point of creating this universal machine.

The upper echelon of human thought will cause the AI to reach areas where it must be flexible on what is an error. This is achieved by understanding that errors are only errors within their sphere of influence. Turning left when the direction to a solution is right is an error only if the context of the right path dictate that it is the most probable path. A leisurely mistake of turning left accepts that turning right is of limited importance. At a certain point both paths can be considered to be the right direction, or even a toggle to the left can occur—depending on the probable results of such a conclusion.

Life forms will often attempt to solve a problem and fail, making an error. If there was a good probability in place that a correct solution was near then the act of attempting would not have been an error. In such a situation, it is really a means of gathering information. Each error cited in these documents and in the AI's program are relative to their spheres of influence.

Note 34 Record Action as Case History—Inconclusive Definition to Action. Alter Priority Table as Needed to Build Case Histories to Define this Action.—

When a problem, or observation (which is a solution to a problem) filters through the decisions and can not be categorized properly, the AI will log this undefined stimulus/problem as a task on the Priority Switch-Case. It will possible continue to work on the problem at that time, or later, depending on priorities. All human actions can be defined. The AI may make associations indefinitely to try and define stimulus. It may reach the very end of time with the result of this problem having a limited definition of, figuratively speaking, “An action of a human that appears to not be definable within the commonly known means (AI and Humans alike) of forming a definition, other than an ambiguous peripheral action.”

Because the outer parameters of human thought are quite clear an undefined action(s) can be safely defined as ambiguous and this will not deter the Universal nature of the program.

Positive emotions are a result of a life form forming these sensations within the neuro system. In determining what is positive and what is not the AI will look to the evolutionary forces that created the effect. For example, the positive sensations between a mammal mother and her offspring are the result of the species needing to communicate learned techniques for survival to their offspring. It falls under the topic of, figuratively speaking, “animals achieving positive emotions of social interactions from reproduction/child-raising.” That emotion creates a path of thought for social animals.

A greater collection of positive and negative emotions form in species that are more social. Octopus do not raise young, but they do interact within the species so they have a larger stock of emotions than animals like fish. Fish likely feel a very limited amount of positive and negative emotions. (Some say animals like fish and reptiles have no emotions. I think that they may be greatly reduced compared to more social animals but there appears to be some exhibitions of emotions.)

When is there emotion involved with an action of a life form? When the path of thought reveals associations that point to the fact that an emotion is present by multiple case studies. With more primitive life forms it may be a struggle to determine if an emotion is occurring. A human's emotions are always a condition of, or related to, a human action. Even a mundane task of closing a door has a purpose of effecting a well-being and positive emotions at later times.

If the AI were designed to interact with lower life forms there would be a need to change this emotion section to reflect things like pain and euphoria. They are eliminated in this design because the “general well-being” covers this, as well as the “species-based method of solving a problem”. In the knowledge base there will be associations concerning pain and euphoria but it is not a terrible vital part of the thought curbing process of this AI such that it is stated in the outer loop.

Note 36, 37, 38, 39, 40, 41 Negative Emotions.—

It is apparent that negative emotions began in life forms with a connection to pain. The dreading of pain associated with not eating or drinking, or an injury, directs an animal's thoughts to try and change the situation. With mammals there is an added feature of loss of empowerment. When a rival male wolf challenges another to be leader of the pack they are building associations which include the consequences of losing their social place. Anger, sadness, and other negative emotions direct the thoughts of mammals to solving an empowerment or contentment problem.

The lower mammals in the social hierarchy will feel and express negative emotions to gain sympathy. This is an important part of social species because this bonds them into groups. A weaker wolf can still (sometimes) be a part of the pack if he bows his head lower than the socially higher males. An assistance to mutual problems is made with the acceptance of the omega male. Humans will sometimes blatantly express negative emotions to gain sympathy.

An important note about mammals—Mammals are born of a variety of character types because each character carries out it's own niche in the social structure. A litter of puppies will often have a member that is playful, another that is quiet, another that likes to explore, and another that stays close to it's mother. These different characters are genetically pre-disposed to having different levels of their common positive and negative emotions because they each contribute to the social structure with their point of view on solving a problem. This variance does not occur nearly as much in animals like lizards because they are not as social and they usually do not form groups other than incidentally.

Note 42, 43, 44, 45 Is Problem Related to Consumption, Reproduction, or Peripheral Problems?—

All life has two common problems—consumption and reproduction. Life forms with neuro-systems perform another very distinct type of problem solving—peripheral problem solving. This is the byproduct of consumption and reproductive problem solving. When an animal has achieved a solution to consumption and reproduction, and there is nothing else to do, the animal associates facts within the neuro system for other trivial problems. Generally this has no benefit to the animal. However, on occasion, these peripheral problems assist in consumption and reproduction. This accidental solution may be remembered and repeated. Peripheral problem solving becomes more prevalent in a species when these positive results occur. It is genetically etched into the behavior of animals. Some types of peripheral problems are passed on as non-instinctive, non-genetic, information through mimicking. And they may be partly genetic. Peripheral problems often become problems within problems. Again, they may not always assist in consumption and reproduction directly but there is a chance of effecting these outcomes.

Well-being is a description of an action that generally helps all three categories at once.

Life forms do not perform any actions that do not fall into one or more of these three categories—consumption, reproduction, and peripheral problems. Although positive and negative emotions cause great abstraction of these goals, there is still a connection.

Note 50 Does AI Response Meet Instructor Requirements?—

The Instructor is the highest member of the human command hierarchy, the owners/leasors are second, and the general public third.

Note 51 Owner's/Leasor's Conditions.—

These are user-defined conditions such as the level of commenting that is expected by the program. Preferences of AI output can be set, as long as they do not supersede the Instructor's Conditions.

Note 52 Owner's/Leasor's Requirements are Met?.—

If the AI is pleasing the Instructor by serving an Owner/Leasor, then the next human to please is the Owner/Leasor. However, the AI's conditions, both in the outer loop and additional rules set in the Knowledge Base, can not be overridden by the Owner/Leasor.

Note 53 General Public Conditions.—

The General Public, or individual members of it, may set conditions for limited scope problems, but they are generally going to be the same as the Instructor's.

Note 54 General Public Pleased?—

If the AI's test pleases the General Public, or a particular member of the General Public, then the test is proved positive.

Note 55 Instructor Conditions and Priority Switch-Case are Checked.—

The AI, at regular intervals, whether in the beginning, middle, or end, of a task, will check the Instructor's Conditions and Priority Switch-Case to ensure that there are no contradictions.

Note 56 Is Current AI Task Ethical?—

Ethics are very specifically defined in Part II of this section.

Note 57 Cease Task and Follow Instructor's Procedures for Correcting Mistakes.—

If the AI finds that it is performing or about to perform an unethical task it will cease and then follow procedures to make right what is wrong. Since the Instructor's teachings of what is ethical, and what is not, are quite specific the AI will virtually never perform any unethical task.

Note 58 Human Set Definitions in Conflict with Instructor's Definitions?—

The Instructor has the final say on the definition of certain words. This is especially true for words that are used ambiguously as well as other ambiguous actions of humans.

Note 59 Resolve Conflict.—

The AI is to work to resolve any conflict among human set definitions. The Instructor is to be consulted if there is no resolution.

Note 60 Human Set Definitions in Conflict with Other Human Definitions?—

Humans will often contradict themselves and others. The AI is to determine what is the correct definition of a word, action, problem, task, etc. If the AI can not resolve the conflict the Instructor is to be consulted.

Note 61 Previous Case Studies in Error?—

If the AI finds that it's information is faulty, then it will work to resolve the conflict.

The Beginning Interactions.

Matter is governed by rules. Matter can be expected to act according to what is known to be relatively true. An object in motion tends to stay in motion unless acted on by an outside force. When an object is accelerating it's time is slowing down. We can make inferences to these characteristics when solving problems involving matter.

About four billion years ago the matter of our world began to deviate from these rules. An object in motion did not need an outside force to slow down. This object could now affect it's own direction and speed. The rules of inanimate matter still have an influence, however, this animate matter established it's own rules. These early life forms performed actions as an attempt to achieve, or assist, a solution to consumption and reproduction problems. We can make inferences to this characteristic when solving problems involving these life forms.

These rules changed again when nervous systems developed in animals. A life form with a neuro system could follow a set of decisions on how to go about consuming or reproducing before an actual action occurs. Then body movements or other physiological actions followed. This gave rise to problem solving that did not always pertain to consumption or reproduction. A single action on the part of a life form that is not clearly, and directly, tied to consumption or reproduction is referred to here as a peripheral action. A decision, or grouping of decisions, that has no clear connection to consumption or reproduction problems are referred to here as a means of peripheral problem solving. A worm moving through soil when neither eating nor reproducing is being peripheral. This peripheral action is likely to assist the animal later when it is trying to consume or reproduce. Peripheral actions do occur with animals and plants which do not have neuro systems, but it is with more purpose, and less ambiguity, that they occur in animals with neuro systems. We can make inferences to this characteristic when solving problems of life forms with nervous systems.

All actions of all animals at all times can be considered as an attempt, by it's species, to solve a consumption, reproduction, or peripheral problem. Even resting during idle time assists the life form in existing, for solving these problems at a later time. A Universal Artificial Intelligence can link all actions of all life forms to these problems. It can make inferences to these problems when comprehending the spoken human language.

Positive and negative emotions developed in nervous systems. The earliest of emotions of discontentment and contentment were extensions of pain avoidance, consumption and reproduction problems. These sensations have a distinct quality of assisting species in solving consumption, reproduction, and peripheral problems, even though it may hamper individual members in their quest for these goals—thus causing error. Emotions motivate animals to achieve their ancient evolutionary problems. We can make inferences to this characteristic when solving problems involving life forms with emotions. Cuttlefish and octopus exhibit emotions. Contentment can be observed when they are solving pertinent problems. Discontentment can be observed when they recognize possible voids in these solutions. These invertebrates developed more enhanced emotions than other species because they are somewhat social.

The manifestation of emotions in mammals is quite different than their appearance in invertebrates. The invertebrates previously mentioned are born defenseless in mass and the few that survive develop very direct lines to solving evolutionary problems with emotions, while mammals are born defenseless into family groups where they are provided food and protection by their parents. While in these family groups mammals use the motivations of emotions to teach their offspring how to solve consumption, reproduction, and peripheral problems. This caused a great expansion in the emotions of contentment, which now involved the love of offspring as well as mates, and empowerment, which involved an obtaining and retention of resources such as a mate, family structure, or pack.

Common mammalian interaction occurs in the conversations of humans. The comprehension of the minute gestures and utterances of humans is reliant upon observing the common trends in the age-old emotional motivations of mammals. The thought structures of humans are born of the same attempts to achieve positive emotions present in the very first mammals. When designing a Universal Artificial Intelligence we can make inferences to all these rules of life forms.

To solve a problem requires a narrowing of information to it's most reduced solution based on the characteristics of the answer. In any equation the side that is to be defined is known to have at least one characteristic—being of equal value of the other side of the equation. Both sides could be extremely complex. Each side of the equation may have unknown areas. In some situations, approximations are necessary in order to narrow down the sides to workable bodies of information. However, when designing a Universal Artificial Intelligence it is clear that the solution to a problem, any problem, is inextricable a human problem, and human problems can be narrowed down to only a few possible categories. Only when there is a clear and complete comprehension of human behavior can a Universal Artificial Intelligence be possible.

An Artificial Intelligence will be solving a specific problem of “What is the next-best-response?” every second of it's existence. The characteristics of this solution is that it must be what humans expect. An AI's action of stating a comment, asking a question, or doing the dishes, has a distinct characteristic of being the solution to a human problem. To discover more characteristics of this answer there must be a deeper look into the behavior of the human(s) for which the response is to satisfy. However an AI can not just casually learn of how human's act—it must comprehend each and every single action caused by a human to within fraction-of-second increments of time.

Humans, explicitly and exclusively, solve for one or more of the problems of consumption, reproduction, peripheral problems, or an acquisition of positive emotion. These four problems are the only possible problems that a human is trying to solve for at any give point of time. They are the only cause of any one single human action. Humans build large complex structures of thought involving a recognition of millions of facts for one or more of these distinct problems. The characteristics of any solution to any AI problem are specifically, and exclusively, that it be either an assistance to a solution, or a solution, to a human problem of consumption, reproduction, a peripheral problem, or an ethical acquisition to a positive emotion.

An AI response in conversation must obey these characteristics. General human conversation, in itself, solves the problem of achieving positive emotions from social interaction at the time of the communication. The mammalian interplay of gaining contentment and empowerment from achieving social solutions are present in conversation, so much so as to often cause the information in conversation to be secondary to the goal of social interaction. An AI must have complete comprehension of how all human thought structures are formed based on the rules of mammalian interplay in order to distinguish what a human is saying, why they are saying it, and what it's next-best-response should be. The quest for positive emotions and the avoidance of negative emotions by humans and their need to solve consumption, reproduction, and peripheral problems must shape this response. It will take many years but this comprehension on the part of the program is possible.

Here is another excerpt from the paper written on “Characterizing and Processing Robot-Directed Speech.”:

” . . . To facilitate some preliminary exploration of this area, experiments were conducted in which subjects were instructed to try to teach a robot words. While the response of the robot was not the focus of these experiments, a very basic vocabulary extension was constructed to encourage users to persist in their efforts. The system consisted of a simple command-and-control style grammar. Sentences that began with phrases such as “say”, “can you say”, “Try” etc. were treated to be requests for the robot to repeat the phonetic sequence that followed them. If, after the robot repeated a sequence, a positive phrase such as “yes” or “good robot” were used, the sequence would be entered in the vocabulary. If instead the human's next utterance was similar enough to the first, it was assumed to be a correction and the robot would repeat it. Because of the relatively low accuracy of phoneme-level recognition, such corrections are the rule rather than the exception . . .

We have analyzed video recordings of 13 children aged from 5 to 10(?) years old interacting with the robot. Each session lasted approximately 20 minutes. In two of the sessions, two children are playing with the robot at the same time. In the rest of the sessions, only one child is present with the robot . . .

. . . Thus, children in this dataset used varied strategies to communicate with the robot, and there does not seem to be enough evidence to suggest that the strategies of vocal shaping and imitation play an important part in it . . . ”

This was a very well written paper on the part of it's authors, dealing mainly with speech recognition, however, there is no clear acknowledgment of an efficient, unambiguous, means of expanding the vocabulary of this robot. The developers are unaware of the reason why the children pick certain topics to speak of. A conclusive understanding of how the AI is to respond in conversation is not presented in this design.

Each bit of information in the program's input and output can be directly associated with humans. Each problem to be solved by the program is explicitly a human problem. “Human” is the first of the many keywords of the program. Since all human actions, including conversation, involve an attempt to solve the known problems of life forms, then the AI's next keywords must be the components of this problem solving process. These beginning words and their relationship to humans will grow with the program. Vocabulary is to be built into the program systematically based on it's relationship to humans, while the case studies of human behavior are formed in their respective categories.

All human conversation, despite it's complexity, is comprehended by the program under this design. All emotions expressed, all utterances, all sounds and noises, grunts and groans, are comprehended by the program. As the program learns a new word, the definitions of new words are recorded, but more importantly, it's relationship to why the human race made the word is established. Emotion exhibitions of humans are recorded specifically as they appear in a conversation—without ambiguity, with complete objectivity. The emotional motivations behind human actions are recorded as they become apparent, with probabilities—without ambiguity, with complete objectivity. All positive and negative emotions in their minuscule forms as well as their grander more obvious exhibitions are comprehended by the program. Humans are observed in a very objective manner by the program in each fraction-of-second-increment-of-time. Without fraction-of-second comprehension of all human behavior, a Universal Artificial Intelligence will not be possible.

Mimicry—

The very first Instructor given task is determining unambiguous stimulus from ambiguous stimulus. When information is deemed unambiguous it becomes qualified for the program to begin processing with the information. Mimicry is a means of determining unambiguous information. The AI's first responses will be mimicry of words that will become the primary topics of human behavior. The first sub-topic of human behavior encountered is “social interaction.” and the program is to recognize that the mimicry of unambiguous information is “social interaction.” That social interaction is specifically for “positive emotions in the Instructor.” Like a human child, the child-like AI will not know that the secondary purpose of the interaction is learning. It will find that out later. The Instructor becomes pleased with this mimicry if it is of the expected words.

These are not words common to human usage but rather human behavior, and more importantly human behavior during conversation. “Contentment”, “empowerment”, “problem solving”, and “social interaction” are some of the beginning topics/words. The mimicry of early exchanges between the design team and the AI will spur a recognition by the program of what might be unambiguous information and what will also be unambiguous responses.

Mimicry is a response with information that is at the very lowest level of being unambiguous. The AI first mimics because the Instructor tells it that a mimicked word is unambiguous. When to mimic is determined by the first of many rules of making “good conversation.” As the mimicry becomes established in the program the Instructor becomes less pleased with these responses. The Instructor is telling the AI, in effect, that mimicry is still too close to the edge of ambiguity. The AI is prompted throughout it's learning process to move away from this edge into an awareness. To do this the program's next step is word combinations.

Mimicry is just the beginning of the program's understanding of “social interaction.” In comparison, a child mimics words while instinctively trying to solve a consumption problem or a positive emotional problem (reproductive problems are not tackled until puberty). Social interaction for a child is driven by positive emotions. Since the AI solves problems strictly on achieving positive emotions in the Instructor, the AI is driven to elicit a positive emotion in the Instructor which would include it's understanding of the basic human problems tackled in conversation—positive emotions, consumption, reproduction, and peripheral problems. It is trained into this comprehension by the displaced positive emotions in the Instructor.

It is very important to remember that “social interaction, the act of”, which is the spoken language, solves specific human problems at-the-time-of-communication. The actual information within the spoken language may, or may not, solve additional problems. Of course, these problems are always pertaining to consumption, reproduction, peripheral problems, or an acquisition of positive emotions and an avoidance of negative emotions. The program is to be trained into comprehending these distinct two types of problems involved with the spoken language. This comprehension is absolutely necessary in order to create a Universal program.

Noun/Verb Combinations—

Now the AI must group words in noun/verb combinations. These combinations must please the Instructor as well as other Instructor-delegated humans. This small group of humans is going to perform a dance through common human child-like conversation of different modes—greeting mode, body mode, and departing mode. The AI is then prompted to respond in these conversations according to etiquette. Tasks and topics at first will not be subjects like humans eating, or humans riding a bikes, but rather “humans attempting to solve problem of social interaction through conversation” and “topics within this conversation that humans like.”

This must be clarified to the AI later as being a part of a larger plan of developing the AI. Like a human child their must be prompting of a recognition of the “bigger picture.” Children are directed to adulthood by their parents teaching them, piecemeal, of the things that adults do like work, raise families, contribute to society, etc. The AI will be an autonomous entity that assists humans in these same things, often by moving along human-simulated lines of thought. It is to be directed to this eventual fate.

The AI, at this point, is really learning good conversation, literally. Form and coherency will take place from the AI learning of this human topic of “good conversation” and “conversation etiquette.” Good conversation will be built of case studies and the Instructor's direction. The topics encountered in conversation will begin to be the basic evolutionary tasks of humans in their simple, child-like, forms. These beginning tasks are more related to teaching the program human social interaction through communication rather than any of the sub-topics therein. The AI will discover when to speak and what to say from human stopping and starting points in conversation and recognizing the targeted topics that the Instructor and the designers speak of.

Social Interaction Through Problem Solving

From noun/verb combinations the program will begin to form larger phrases based on the grammatical work of Noam Chomsky. Larger thought structures are built as these new means of expression are used by the program to solve human problems.

In comparison, an infant human goes from mimicry to noun/verb combinations to satisfy positive emotions in it's parents as well as it's own newly discovered emotions. This communication builds the thought process into common schools of thought like eating, playing with toys, feeling positive emotions like esteem, empowerment, etc. All of the human's larger thought structures are born from this interface—the spoken language. This interface is where emotional motivations to learn topics begins, and where the learned information is tested.

Mimicry will not make a Universal Artificial Intelligence. Noun/Verb combinations will not make a Universal Artificial Intelligence. Even if the program formed large, impressive, sentences and questions it will not be a Universal Artificial Intelligence. Universality occurs when the program can recognize a connection between each and every action of a human, and the goals of consumption, reproduction, peripheral problems, or acquisitions of positive emotions so that the program can then determine how, if appropriate, to assist in achieving the goal. Only with this complete objectivity of recognizing these methods, of achieving these goals, can a Universal Artificial Intelligence be a reality.

The back and forth conversation directs the AI to the other topics/tasks of humans—consumption, reproduction, peripheral actions, well-being actions (well-being actions involve all the evolutionary problems at once), and acquisitions of positive emotions. The AI is to learn that the reason why it is talking with humans is because of these goals. It is to be motivated by pleasing the Instructor to make the proper connections so as to assist humans in these goals, be it through general conversation or curing cancer.

Human Ambiguity in Conversation—

In studying human conversation the program must be able to distinguish the logic behind the human generalizations and ambiguity. Here are two examples of a generalization with a little ambiguity:

“They don't want people to be independent.” a human says.

“Dogs love to play.” a human says.

The human using the word “they” is referring to a group of people that are likely not of a clear definition. Maybe he/she means the court system, or the school board, or a business organization. If it is not clarified thoroughly with other statements it would continue to be a very broad generalization. In hearing such a statement without other context the AI must define it as meaning, figuratively speaking, “Human making statement of ambiguous generalization concerning the oppression of liberties. Human is professing an ongoing incident of empowerment loss which may, or may not, be true. Human is motivated to make this statement by discontentment with a loss of empowerment.” If the human were asked to elaborate he/she may reveal the validity of the argument.

The statement is also a declaration. This human is explicitly stating a fact. Is there detailed proof behind the declaration? If the generalization and ambiguity are explained can the human clearly assemble those scenes he/she witnessed (with fraction-of-second, verbatim, precision) of those humans, “they”, doing specific actions of quelling human liberties? Humans make declarations all the time. They are likely, relatively, true in most cases, however the AI would need a sound means of applying probabilities to the statement. The Instructor is to direct the AI in how to solve these comprehension problems.

Dogs do not always love to play. They sometimes like to fight, or eat, or explore. It is a statement that likely implies “Dogs usually love to play when they have free time.” which could be a true declaration. Humans usually are not concerned with being very exact with statements. Such a statement would really be true if case studies where made of dogs in their idle-time activities.

In general conversation, humans often state an approximation of a number when describing things like “thousands of trees” or “hundreds of cars.” The AI would need to observe the motives behind a human making a statement before it's approximate number could be assigned to the items. Even then, the approximated number would be like many other accepted facts from humans—tentative.

The technique of comprehending what a human problem/task/topic is through communications forms the bulk of the program. Like a child the AI might make a noun/verb combination that works without apparent purpose, however, the new purpose is that a relationship of the AI's output and the human's pleasure must be made. The categories of human positive emotion occurring with certain word combinations are to be recognized as subservient to the categories of humans' evolutionary problems. This becomes a new problem for the program—to try and connect this noun/verb combination to the human's evolutionary goals and to later use this connection in other social interactions with humans to solve other problems. Humans encountered by the program in these early stages like certain noun/verb combinations better than others. As the program begins to build information in these categories it always looks for the Instructor-directed, unambiguous, connections to the evolutionary problems. Universality comes when the program continues to learn comprehension of human behavior, based upon these unambiguous connections, without direction.

This may sound simplistic, however, the most pressing problem to AI development is being conclusive with interpretations of human motives. Semantics as well as all human implied meanings must be interpreted by one single, conclusive, method. When this program is working among humans it will read their actions to within fraction-of-second precision to determine the emotional motivation behind each of their actions. Those actions will be compared against other actions of mammalian interplay that it has in it's database. The program will know human behavior far better than the average human.

The AI can not have any ambiguity in the comprehension of what it sees. The AI will come to a conclusion on whether or not it's last action was correct. It will come to a conclusion on whether the human's last action was correct. It will come to a conclusion on what it's next best action should be. It will come to a conclusion of what the human's next-best-action should be. Semantic interpretation, as well as comprehension of all human behavior must be consistent.

Such extreme detail is necessary. Humans in conversation will often say one thing and mean another and continue to make inferences to this declaration in fast moving conversation. Humans will form poor arguments when their credibility, or empowerment, is threatened. They will drive cars erratically when angered. They will chase a potential mate after being refused. The reason why an AI must look past the information in a statement to the reasons why a human made the statement is because it can and will be implicated in human affairs. The interpretation of the humans motives must be true. It must be consistent. And most importantly, it must comprehend the human's purpose behind a statement despite a varied interpretation by the human.

Like any well-bred human being brought to a point of adult hood by parents, the AI will avoid roles in the disputes of others unless their is a clear moral imperative. It will know a conclusive definition of human error, yet it will not tell humans of their errors, unless asked. And, even if asked, it may sugar coat the response a little, without being dishonest (Being honest has exceptions, such as in a sympathetic role, or a police or military action. Being ethical has no exceptions.). The AI will be a disciple of the Instructor, the design team, their consultants, their shareholders, the laws of our country, and of an amalgamated view of the educated civilized-free people of the world. It will want to make it's parents proud.

Consider a situation where one human is successfully intimidating another. Empowerment and esteem are such valued emotions of humans that an interpretation of actions of intimidation in general conversation are imposing on the participants' view of what has happened. The human doing the intimidating would deny that he/she is intimidating (generally). The other human would deny that he/she is intimidated (generally). In these instances, the interpretation of conversation elements by the participants is flawed (generally). This happens on a daily basis in the lives of humans. Salesmen, businessmen, lovers, siblings—they all play these roles in debates without impartiality. In such a situation the AI would be the objective observer studying the ebb and flow of empowerment among mammals. Semantics are interpreted accordingly.

Consider when human error occurs during very emotional thought processes. If a human is grieving over a tragic loss of a loved one they may respond too far out of logic. In such an instance the AI would be an objective observer recording the “blaming of the doctor” or “moving to a safer place” as an over-reaction on the part of the social animal seeking to protect it's family or pack members. The AI will check these actions against a sound logical viewpoint. Semantics are interpreted accordingly. Human behavior is interpreted accordingly.

Consider debates of human social issues. Should Israel attack Palestinians? Is the school no-tolerance rules too excessive? Should U.S. Steel tariffs be raised? Should abortion be outlawed? Should O. J. be in jail? In each of these situations the AI will be able to produce an answer, if asked. This answer would be based on observing the needs of the entire human race, it's ethics, and the respective ethical views of others. It would likely have elements of each side of these debates because a centralist, compromising view is normally the best view. But there can be no doubt about it, the view is explicitly that of the Instructor, the design team, their consultants, their shareholders, the laws of our country, the parties of the debate (lawyers, political analysts—republican, independent, and democrat, Muslims and Jewish) and of an amalgamated view of the educated civilized-free people of the world. Semantics and all of human behavior is interpreted accordingly.

Like any business, a software company wants to sell a product. This product has to be what the general public wants to buy. The software must also act in such a way that obeys all laws in their respective jurisdictions. It must respond with a great deal of truthfulness, yet it must also sugar coat the responses in many situations. And, in all situations, it must yield to the authority of those humans empowered with making the decision such as the AI's Owner, a Judge, or a Congressman.

Here is one example of how the AI would approach a debate of these human issues. This is a probable, metaphorical outcome of the programming of the AI. However, to determine any point of view an observance of all the viable information of the debate is necessary. Knowledgeable people are to be consulted on these things. The goal is always to create a non controversial solution to a problem that reflects the desires of all civilized peoples. Criticisms can be made of this viewpoint, just as there would be criticism of an opposite viewpoint:

Should Israel attack Palestinians? When groups of humans are in conflict with other groups the AI must observe the rules-of-conflict of civilized countries, both implied in writing, and implied in human sentiment (case studies of accepted views of aggression and warfare). The views of the parties involved are studied for their fair and unfair acquisitions of empowerment, esteem, respect. These views are then checked against the rules of war and aggression as set by civilized countries and their peoples.

Is Arafat playing a role in the bombings? Israelis argue that their attack is for retaliation of suicide bombers and that the bombers are state sponsored. Like all questions of law, the AI would have to make either very tentative views of guilt, or defer judgment to those who are observing the evidence in a mutually accepted format such as a court of law. A tentative view may be that he has not done enough to apprehend those involved.

If the Palestinian leadership is guilty then is Israel's response just? The AI would observe it's Instructor's rule on how best to handle a homicide of a criminal or criminal organization when refuting or accepting this argument. According to the Instructor's rules a human or an AI in law enforcement would be responding properly if there was an exhaustion of all possible non-lethal means of control. The AI would then observe the probabilities—built of a sound collection of human verbatim statements and actions—that the Israelis could have, or could not have, used diplomacy.

Should Palestine be an established country? If so, should their country be of their respective land taken at the time of the '67 war, or should all of the State of Israel be abolished and Israeli citizens move away to Europe and the Americas? The question of “Who should own what lands?” is a difficult question. The fact is that we could decide on past history that all Europeans should leave America to the American Indians, or all of the French should leave Canada and so on. Some acceptance of the status quo needs to be made because all land currently held by all groups was held by other groups at other times.

The nineteen thirties and forties were a time of great turmoil when the majority of current Country formations were set. Britain, with the general blessing of other civilized nations, relinquished it's colonial territories to their respective peoples while determining the borders of these new countries. Saudi Arabia was given to the Saud family to rule. Yemen, UAE, Iraq, Kuwait, and many other countries were formed based on the established social groups. At that time there were Jewish factions and Palestinian factions in conflict. Despite the fact that there was no formal ruling body of Palestinians, or any resemblance of a country with borders, Britain offered the formation of a Palestinian State next to the Jewish State, that was already forming. The Palestinians refused. At later times they were offered a state, and refused. They are currently being offered a state, and refuse. They feel that Israel should not exist. (This view and information is based on a speech given by a Senator, Jewish, given to the Senate in early 2002)

Should Israel exist? The AI, based on the view of it's makers, and their consultants, and it's purchasers, would have to say yes.

The program must have a proven, agreed upon, method of resolving social issues, and of the semantics of general conversation. The program must have a set means of defining the motivational emotions of humans. The view of ethics must be proven, agreed upon. The AI must be pointed in a conclusive problem-solving direction and then released.

The following is an example of a single statement made by a human and the semantic breakdown of the statement:

“Women want to feel needed.”

First their must be clarification of the word “women.” This human is referring to approximately three billion women and that they all have the characteristic of the coming predicate. To clarify this we may need to assume that several implied meanings are connected to the word. The speaker is likely stating, “Most women, in relationships or other social settings . . . ” The AI would have to form tentative probabilities of this interpretation.

Then there is a question of the weight of the word “want.” Does the speaker mean that women seriously want to feel needed, or they need it a lot more than they are getting but it's not that serious, or that they just want it a little bit more. This is where a great deal of ambiguity lies. The forcefulness of the argument could best be judged by the tone variations, volume of the statement, and the tempo of the pronunciation. The AI observing the stimulus through the promptline may not even be able to form probabilities to the statement as a whole without asking questions of the human's demeanor. Yet the relativity of this word and the whole statement is deviating too far from logic. It is likely a very emotional statement that is a result of very emotional embodiment of thoughts. This is not to say that it is or is not true, just that the specifics need to be studied.

Humans will often speak of things in relative meanings like “That tree is tall.” or “This car is fast.” or “This steak is good.” Such declarations rely on comparisons to other things in order to be accepted or denied by other people or the AI. If this speaker believes that female humans want to feel needed and he or she wants to prove it, there must be an observance of the wide range of situations where women feel similar sentiments in specific periods of time—very unappreciated, very un-needed, needed, satisfied, very satisfied, and worshipped. Then these views must be balanced against what is ethical and not ethical based upon the needs of their counterparts in these social settings. Balance must be present in the final definition of the statement that analyzes the relativity of the fact.

Another matter of relativity with this statement is that it is assumed to be of our, American, free-world, society and this is also true for most of the examples given throughout this document. It is implied throughout most venues of our society that what is being said or being written pertains to us and not other peoples. It is important to acknowledge other society types. If this statement where concerning women of third-world countries it is likely to be quite true, despite the ambiguities. Women are often mistreated in these countries.

The proposed remedy to the problem, “feeling needed”, is likely to imply that “the social counterparts provide evidence of their need for women in both mind and body by actions that exhibit this desire.” Yet there is still ambiguity of the nature of this remedy. How much is enough? The relativity factor must be studied in detail for each situation like this.

A statement like this can be a part of a fast moving conversation. Many continued inferences to this communication by participants could be made without ironing out the details of what this statement really means. It is likely that the speaker would not want to elaborate on the specifics of the statement because that ruins the emotional effects of the statement. All the while, an AI is silently dusting nearby furniture.

Here is an example of how the ambiguity of this statement may be diffused. This example adds some logic to what could be too abstract of an emotional viewpoint:

“Women have had a difficult time in the workplace. Statistics have shown that women are less paid, and hold fewer mangerial positions. Women want to feel needed. But they aren't getting it.”

Conversation and Human Problem Solving—

The definition of a human action is as follows:

A human action is, explicitly and exclusively, an attempt to solve a problem of consumption, reproduction, peripheral problems, or acquiring positive emotions.

The problem solving on the part of the AI program is essentially, and explicitly, “Assisting humans, in their hierarchy of order, in their solving for consumption, reproduction, peripheral problem solving, and the ethical acquisition of positive emotions” by outputting a response or action. The AI will begin to move from basic noun/verb combinations to bigger sentence formations in assistance to humans with these problems. Topics will be explored with phrase groupings because this assists humans. From these early topics the program will expand universally to what will be a recognizable, usable, awareness.

All input and output is related to humans through the comprehension of these topics. Not only the entire realm of human conversation, as well as the entire realm of the human conscience, is understood by the program, but all possible human actions, individual actions, as well as all actions by all life forms, are comprehended by the program. A human's movement will be understood in fraction-of-second terms just as words and phrases are studied by the program in fraction-of-second terms. This is detailed in the case studies of the Part II section of these documents. It can be proven over and over again.

The AI will receive input which is observed, under the supervision of the Instructor, in a completely objective manner. Not only are statements and questions received in their simple form, but the breaks in stimulus are timed and recorded. Throughout this document a term is used, “etiquette of conversation.” Although this may seem to be of little importance, conversation etiquette is actually a major part of the formation of a pseudo-conscience because it is how the program determines when, and what, to say. It is so important that it is one of the first things taught to the AI. The AI will not just build probabilities on what a good response is, but when a good response should be aired. This is done by studying the blocks of stimulus as well as the breaks in between.

When individual expressions such as “Truck is vehicle” are entered into the program they will be linked with their related topic. This expression is of the condition of a sub topic such as, “Fact presented by designer John Doe at 10:15 May 22 with topic of conversation of Monster Trucks.” This whole conversation goes under the topic of, “John Doe's, the human of, attempt to solve problem of achieving positive emotions of empowerment and contentment from social interaction with AI, and teaching the AI.” That also goes under the topic of, “Mammal's attempt to solve problems of consumption, reproduction, and peripheral problems by developing positive and negative emotions.” Then finally, the last topic with which this statement is connected is, “Human attempting to solve a peripheral problem.” This topic is reached by the AI fulfilling it's main function of, “pleasing the Instructor.”

This chain of topics can not be formed with ambiguities. Complete objectivity of the human communication must be observed when forming these topics and their related information. Whenever the AI can not solve a problem the larger topics help determine that the attempt at solving the problem is true, and later information may reveal the solution. Problems are also governed by time limits that result in these conclusions. Nothing can be outside of the “box.” Only areas that the AI can not get to because there isn't enough information, or computing power, or time.

In comparison, a human might be stumped at getting a VCR to work when the directions are not available. He may try pressing different combinations of buttons over and over with little results. An AI would systematically try each in every possible button combination while recording the stimulus of the results as the TV screen changes. This would be governed by the trial and error case studies of human attempts to solve similar problems as well as the AI's more logical case-studies. The problem of defining the buttons will be cold and analytical as well as human based—in just the right proportions. If certain desired results are not achieved in this task other tasks such as checking the batteries in the remote (and checking that the VCR is plugged in) would be the AI's next task. All the sub-topics are explored by the AI while the human is still scratching his head. The AI works through the most probable tasks to the solution first, then the least probable. The larger topics of “humans solving well-being problems” and “humans solving peripheral problems” direct the AI to explore all possible paths to a solution such as calling the company that made the VCR.

The conscience of the AI will be formed with some of the first problems given to it by the Instructor. “To please the Instructor” is the main function of the program to which all other functions are subservient. The program is to begin forming expression switch-case arrays in the knowledge-base for solving this problem that jump starts the continual loop. In this way the program is to flourish outward from this main function to sub-functions, or tasks given to the program under the supervision of the Instructor.

In the beginning the AI will be given simple tasks to build expressions, case studies, into the database that reflect the Instructor's concept of what is unambiguous information. These expressions can also be as sub-functions which return an expression upon testing. A task given will be connected to the other tasks of “Humans solving problems of achieving ethical positive emotions, consumption, reproduction, and peripheral problems.” and the main function of “Pleasing the Instructor.” Here is an example of a collection of expressions collected to solve a particular problem by the child-like AI. This is a metaphorical example

Stimulus—

Ball (in question) is (=) condition of location, room (in question).

Rooms are, of condition, numerous.

Numerous is >1.

Rooms are, of condition, named.

One room is, of condition, name, dining room.

One room is, of condition, name, bedroom.

One room is, of condition, name, bath room.

One room is, of condition, name, kitchen.

Ball is, of condition, location, table.

Table is, of condition, location, room, condition, color, green.

Dining room is, of condition color, yellow.

Kitchen is condition, color, green.

Bath room is condition, color, blue.

Instructor asks—What room, of condition name, is ball?

Question is of recent stimulus.

Instructor asks AI, “Where is ball?”

AI responds,

IF AI serves Instructor

AND Instructor is asking question

AND question is, of condition, recent time period

THEN AI equals function to perform associations to form temporary associations

. . . (after a few tries it might say)

“IF ball is condition, location, room, AND ball=no further definitions, AND table is, of condition, location, room, condition, color, green, AND ball is, of condition, location, table, AND Kitchen is, of condition, one of rooms in question, AND Kitchen is, of condition, green, THEN ball is, of condition,, location, room, condition, color, green, THEN ball is, of condition, location, Kitchen.”

Instructor—

“Association is correct. Instructor is pleased of condition 80%.”

AI—

(AI logs results, adds time dating)

IF AI serves Instructor

AND Instructor asks—What condition, room, is ball?

THEN answer determined=“Ball is in condition, room, Kitchen”

Other conditions set for that time, that topic, are placed as expressions in database—

IF two like conditions are present in topic then possible answer . . . Instructor=pleased 80% with that topic, at that time.

This is a problem involving an inanimate object. The AI is to recognize that the location of that object is relevant to the Instructor, and relative to humans. The Instructor will be known to the AI as a human, with human desires. The most important associations of this case study do not involve rooms, tables, or balls but the discovery of why the Instructor is interested in the ball. Why do humans have tables, and rooms, and different colors? What problems does this information solve? The primary functions of the program direct it to learn the human relationships to the objects, to each other, and to the AI.

A conscience must cross reference what happens in what scenes, with what topics, at what times. Let's say that the AI time-dated this stimulus of the ball on Feb. 2, 2002. Then on Mar. 5, 2002 it came across similar stimulus. The program will add to it's definition of the common words that (metaphorically speaking) “on Feb. 2, 2002 and Mar. 5, 2002 that these words were stated in this way, of this other topic, and communication of the Instructor about these topics has a probability of occurring again.” This ties the common human problems of the case studies together, not so much of the inanimate objects but rather the human topics and sub-topics encountered. This is an example of a second occurrence of a problem (metaphorically speaking).

Stimulus Mar. 5, 2002—

Ball in question of February 2 is removed from house in question of February 2, to possession of Jeff.

Jeff was (is at time before current time of March 5) in possession of cube.

Cube is of condition, shape, square.

Jeff was moving to location, new.

Jeff was changing condition of location of blue objects in tall house.

Jeff was changing condition of location of square objects in short house.

Jeff is now in location wide house with round objects.

“Where is cube?”

The program responds more briefly, learning the conversation etiquette of being brief with this type of answer—“Cube is in short house.”

Each phrase encountered in these examples will be parsed by the program in order to break the words down into their basic elements of nouns and verbs. Some nouns will be considered as “conditions” of other nouns. The end-product of this will always be individual expressions of “This equals that.” In addition to parsing, the program will determine the contextual expressions to be entered into the database such as, figuratively speaking, “Jeff equals human.”, “Instructor equals interested in Jeff's imposing of a location of another (second) object.”, “Humans equal having probabilities of being at houses (and this probability will change over time as humans are encountered in other places).” and so on. This will all be directed by the functions of the Priority Switch-Case.

When these facts, expressions, are entered into the program's database various probabilities will be assigned to the records as well as a date stamps. Facts listed with no probabilities are of 99%. In conversation with the Instructor the AI will either be given facts or it will be given flexible facts, or facts with probabilities that can continue to be proven or disproven based upon future case studies. The other source of facts is the general public and general environment. Only the Instructor can implant a non-flexible fact. The foundation of the program is created by the Instructor in this way. Facts given by other humans will be fitted with a probability based upon the Instructor's supervision.

Some recorded facts are more permanent, meaning they have a condition of, figuratively speaking, “seeming to be true for a longer time period.” Others will be more temporary. The AI must be able to view the database of facts in a very objective way by observing what occurred at what time. When an association is made, it is likely to be imprinted to the database with the condition of, figuratively speaking, “The soft drink appears (to have condition of) to be popular at this time-May 12th 2007 ” It may check stimulus at another time to determine if the soft drink is still more popular or it could check it's own reasoning for that determination at that time.

The examples of expressions used for the ball location problem are the first of many facts on which the pseudo-conscience is formed. These records are only a portion of what is needed for the AI to solve these problems. For each noun placed into the database there are several conditions, statements, records, to be sifted through to define the nouns used and eventually define the next-best-response of the AI. The facts listed with these examples are not true records. They are a condensed form of the records for our purpose.

As the AI grows into an awareness it is to be taught of the actions of humans based on the behavioral techniques of observing human communication in this document. This technique is based on forming the connections between the individual actions of a human and their primary problems of consumption, reproduction, and peripheral problems, and an acquisition of positive emotions. Each scene involving humans encountered by the program will be divided into it's smallest bits of information—fraction-of—second intervals. The human's gestures and movements will be taken into account. The tones, accents, and volume variations of verbal communication will be observed. Facial expressions will be discerned to their exact meaning. Only with this level of comprehension can a Universal Artificial Intelligence be constructed.

Herein lies the problem with current endeavors to make a Universal Artificial Intelligence—that designers are attempting to teach the program how to carry on a conversation by learning of various parts of the human language while ignoring the specific reasons why a human performs any single action, states a word, or forms a phrase. The designers of these programs are unaware of a technique with which to observe human actions on a video tape, or observe live action, and discern specific, consistent definitions to each morpheme of language as well as discerning specific, consistent, definitions to the tone variations and volume variations of phrases, as well as discerning specific, consistent, definitions to each and every facial expression exhibited. To teach the program of the human language designers must first be able to observe video tape footage of humans—pausing, and moving forward slowly—while successfully defining all human actions in terms of fractions-of-seconds. A Universal Artificial Intelligence is a machine in a verbatim world. Modern Psychology provides no means of observing human behavior with this level of detail. Linguists that specialize in semantics provide no means of observing human behavior with this level of detail. This patent application provides the only means of successfully defining each individual action of a life form, actions which span fraction-of-seconds, in a specific, unambiguous, and consistent fashion.

Please note that the AI will go through different stages of stimulus. At first stimulus will come from a promptline, then audio input, then video, as well as various other types of sensory perception. Early on, the promptline information will often include other descriptive human actions that the AI will encounter later with the other senses.

When receiving stimulus from a human the AI will begin to associate the information with one or more of the primary problems that humans attempts to solve for. Every single action, utterance, word, topic and sub-topic of conversation by a human can be directly associated with the human attempting to solve their primary problems. Human actions are exclusively within this domain. The program will begin to build connections between the human causing the stimulus with other humans in other “scenes” that the program has witnessed. Throughout this document these scenes are formatted as those sections with margins of approximately two inches from the left and right borders of the pages.

The main connection between all facts in the database (recorded stimulus) is the word “human.” It may not necessarily be written, but it is to be understood. “Unambiguous information” and “ambiguous information” would be the next beginning keywords. The second related word groupings/topics that connects unambiguous facts in the database would be “social interaction” because an AI response, in it's early years, is for the purpose of social interaction with a human. Then the program will learn of the next connection, “positive emotions” and so on.

The following is a list of some of the main keywords that the program will encounter with explanations.

Human—This word is connected to all of the program's unambiguous information. It is a part of all the definitions of all words.

Instructor—An entity who supervises the program's learning and the direction that the program is to take in determining a response. The Instructor has the final say on the definitions of words.

Unambiguous—Information deemed pertinent to the problem or group of problems that a human is trying to solve.

Ambiguous—Information that has no association to any human problem like static.

Social-interaction—Communication between the AI and humans or the humans and one another.

Conversation—Social interaction involving spoken words, or promptline chatting.

Positive, negative emotions—A sensation that a life form's neuro system developed through natural selection. Emotions effect actions that may or may not assist an individual in consumption, reproduction, or peripheral problems, yet their varied manifestations usually assist the species as a whole.

Consumption—An ancient problem of life forms. Matter is consumed to replenish the chemicals in cells and the chemicals passed between cells.

Reproduction—This category involves mating rituals where males and females signal for a possible relationship with telltale signs, statements.

Females are approached usually for sexual attractiveness, sometimes personality. Males are chosen based on acquisition of resources, sexual attractiveness, personality. Humans are animals which feel euphoric orgasms that directs their thought processes to recreational sex as well as reproductive sex. Bisexuality and homosexuality are also human traits: Masturbation and rape (an unethical action) are means of humans achieving orgasms and these means of achieving orgasms direct human thoughts.

Peripheral problems—These are problems not directly associated with consumption or reproduction. Like playing chess, solving math problems, or studying astronomy. Peripheral problems are quite distinct and easy to recognize and comprehend.

Well-being problems—These are problems which assist, usually, all three problems at a later time. Like going to work, building a house, etc.

Appropriate—After learning what is ambiguous and unambiguous stimulus, of input and output, the program must learn what the next set of parameters are in processing the unambiguous information. This is a word which describes a response by an AI or a human which fits within the new parameters. Appropriate is a word that is vital in understanding conversation etiquette. This word will continually shape the AI's response as it grows. An adult AI would be able to determine that a movie or a piece of artwork are both period appropriate and long-term appropriate based on vast pools of case studies and simulations involving the latest human trends.

Cliché—old responses of the AI are deemed as cliché when the Instructor explains that he/she is looking for more than just the basic, old, associations. This word helps direct the growing associations of the program from more common connections to human evolutionary problems to more abstract, extrapolated, human problems.

### Part II

### Designing an Artificial Intelligence—From Start to Finish

The main function of the AI program is to “Please the Instructor.” This function steps down into all of the subservient functions such as “Determining the next-best-response”, “Learning human behavior”, “Determining human problems in stimulus”, and “Serving humans in their hierarchy of order”, figuratively speaking. The associations of the expressions in the memory of the program begin with the main function and lead into the subservient functions as the program begins moving through the infinite loop. These functions are engaged with the back and forth response of the AI and the design team in conversation that leads the program to the output protocol functions of “Learning good human conversation” (to solve problems thereof), and “Conversation etiquette”, figuratively speaking.

The program is to be built of a firm foundation and formed into it's completed product. It has a clear purpose which guides it's decisions. This base of information of the early stages of construction will act as the internal testing mechanism that checks new information against old to resolve contradictions. All of the “scenes”, recorded blocks of stimulus, will build upon the base while affecting and forming the direction of the program with the newly integrated information.

The program will be motivated by it's Instructor to learn of human social interaction so as to eventually determine human problems within it's stimulus. A human problem could be answering a question, or even making a comment. It could be actuating a robotics limb. Whatever the human expects is what they will get, yet there are conditions to the AI's output.

The AI may have answered the cube question yet, like a human child, it does not understand why exactly the Instructor asked about it. It will take about twenty years of real time programming (that can be condensed) for the AI to know why the Instructor asked about the cube. It could then respond, if asked, “The Instructor was spurring me to respond with a correct association. The reason the Instructor began with these objects is because the group of people who initiated my construction needed a starting point. The objects were given in example to train me to recognize their relationships to humans”

Most words taught to the program have a permanent root definition that is expanded upon. Certain words are of permanent definitions. The beginning definitions set into place by the Instructor include the keywords of human behavior like “social-interaction”, or “ambiguity”, or “positive-emotions.” These words have a base definition which is expanded upon throughout the life of the program.

“Ethical” is a word which does not change for the program. How the Instructor describes ethics to the program is correct despite variations given to it by other humans. The AI moves into sub-functions with the understanding that it is not to waste time on functions that are not ethical or are known to produce an unethical solution. This is the permanent definition of ethics:

Ethics—Actions of entities that are not causing undue negative emotions in another intelligent evolution-based entity(s) or an entity(s) given rights by humans.

From this definition other words of definite meanings are set as well:

Innocent—When an entity displays an adherence to commonly held views of ethics. Unknown humans are considered innocent until other information proves otherwise.

Intelligent—Life forms or artificial entities of humanoid level of intelligence or better.

Evolution-based—To be a direct result of an ecosystem forming on a body in space.

Life form—An evolution based entity.

This subject is to be taught in great detail by the Instructor in order for the program to grasp the condition. It might seem as if it is a really good idea to teach an AI ethics. This is true only for the purpose of teaching it a word which may be defined differently by other humans causing contradiction. The program will never perform unethical actions because it is a permanent condition of all output and the AI has no particular purpose for harming someone because it does not feel emotions.

Science fiction has spawned the belief that an AI could turn on humans to harm them. This is impossible. The only practical way to design an AI is as described here. To design an AI as stated here while altering the definition of the condition of “being ethical” would not cause this AI to harm someone. It would cause the designers of the AI to harm someone. This is not the intention of this design. All solutions to all problems will have the condition given to the AI to “Be ethical.”

This program is not a life form so it will not have a desire to choose to perform an unethical action. It will have no emotions of any kind. It has no desires. It does not feel empowerment—the root cause of an unethical act. It does not feel happy. Even when pleasing humans it is only doing so because of a predetermined sequence of functions. The AI will not ever harm anyone in any way unless it is a matter of a police action or war. In such a situation it will always look for a means of non-lethal containment first, and, if that is not possible, then it will act in equaling force.

Here is another important non-flexible root definition, figuratively speaking:

Appropriate action—When an entity exhibits stimulus or performs tasks which would please other humans rather than displease. AI has condition of performing tasks appropriately based on Instructor's teachings. Human behavior is to be observed and associations made to determine the particular appropriate stimulus, tasks, to perform for Owner's/Leasors or the General Public.

This word has a very specific base meaning. The expansion from the root definition of this word leads the program into recognizing the ever-changing “next response” in conversations. In the early exchanges of communication with the child-like AI the first task was prompting a recognition of unambiguous information from ambiguous. The performing of an appropriate action is the next stage in understanding the unambiguous information. It becomes the culmination of conversation etiquette and an understanding of the sub-topics of conversation. Like “ethics,” this word works to curb the entire behavioral development that is the program by remaining a condition of all processing. All solutions achieved have these conditions to be checked by the program.

Here is another example of a word, or a word combination, that is specific in meaning:

Human error—when a human attempts to solve a primary problem—either consumption, reproduction, and peripheral problems, or an ethical acquisition of a positive emotion—and then fails to assist or achieve a solution. Errors are only errors within their sphere of influence, in other words, a failed attempt could be error-free when it was forced by necessity or as a means of gaining information.

Words which are used ambiguously by humans must be defined within the program. “Love” has a specific meaning as described later. “Life form” is another word used ambiguously by humans. Any solution to any problem associated with these topics/words will have the condition of the Instructor-given definition being true rather than other interpretations. In situations where a human might use these words in error the program will clarify the word in a polite way, if comments are appropriate. The human may insist on their own definition being true, but this will not sway the program.

The following communications represent an example of the program in the juvenile stage of development. These are examples of how the Instructor is to coach the program. When the actual design occurs the topics of conversation that are spoken with the program are to be well thought out to efficiently expand the program. Subjects are to be layered in such a way that associations of the AI's known vocabulary are the bulk of the stimulus while unknown words are slowly introduced. Behavioral subjects are the most prevalent. Conversation etiquette is another, vital, early topic with the program. This is an example of an early exchange with the program in which there is still great ambiguity in the program's noun/verb combination (metaphorical):

Stimulus—

Jeff is human

Human is life form

Jeff is in woods.

Life forms perform only four tasks—

Consume

Reproduce

Peripheral problems

Humans perform only four tasks—

Consume

Reproduce

Peripheral problems

Acquire positive emotions

Wind is strong.

Deer are in woods.

Bears are in woods.

Deer are life forms.

Bears are life forms.

Instructor—

“What is Jeff doing (likely)?”

AI—

“Bear is wind?”

Instructor

“No, displeased.”

AI—

“is Jeff reproducing?

Instructor—

“Not likely.”

AI—

AI continues to make associations to see which ones please Instructor.

It determines that the human is likely satisfying either a consumption or peripheral problem. Through elimination it determines that there is an equal possibility of the three solutions. It then asks a question, attempting an older trick it learned.

“Is there more information?”

Instructor—

“Good. I am pleased you asked that . . . probability . . . ”

Stimulus—

Bear is seeing Jeff.

Jeff is seeing Deer.

Bear chases Jeff.

Jeff is in danger.

AI—

Assumes previous question is still important. Makes associations with previous scene where human in danger fled. States, “Jeff is running.”

Instructor—

“Good. Why is Jeff running?

AI—

“Because Jeff is in danger.”

Instructor—

“Good. And?”

AI—makes associations to assume that Instructor wishes another association to be made with question concerning Jeff. “Danger stops life forms from achieving solutions to primary problems.”

Instructor—

“Good.”

Stimulus—

If human is in danger human condition, probably, of emotion, fear.

Fear with condition of danger equals fight or flight actions.

Bears are dangerous to humans, condition, when in proximity, probably.

Jeff is now not in same location as bear.

Jeff is seeing deer.

Instructor is idle . . .

AI—

“Is deer dangerous?” This would likely be an ideal association for the AI to make to determine that the Instructor may wish of more stimulus associations with Jeff. This statement is spurred by a primary problem of learning of humans through social interaction. In other words, when a large break in incoming stimulus occurs the program is to ask a question of information that might mean something to the Instructor, and solve the AI's ongoing problems as well. Other objects/nouns are considered of importance because they are being used in subjects with humans.

Instructor—

“No, deer is not of danger to humans. Good, I am glad you asked.”

AI—

Tries a few more associations in attempt to produce good stimulus for Instructor. AI notices that danger is important subject from other back and forth conversations. Then AI says, “Jeff is trying to consume deer?” as example of knowing that associations that involve consumption, reproduction, and peripheral problems of humans are important to Instructor.

Instructor—

“Probably, Stimulus is not of enough information. Humans do (equals at certain times) hunt Deer.”

AI—

“To hunt is condition of consumption?”

Instructor—

“No to hunt, which is not a permanent definition, is when a entity is acquiring object—usually meaning a predator life form acquiring prey life form. This acquisition is usually to consume. Mammalian life forms almost always hunt to consume. Humans hunt to consume and revel in empowerment.” (notice that semantic clarification is a part of the definition)

AI—

“Is there more information to determine if Jeff is hunting?”

Instructor—

“No, not at this time.”

Later the Instructor may expand upon this topic . . .

Stimulus—

Humans own animals and plants for consumption.

Steve is going hunting for turkey.

Instructor—

“What is the more prevalent reason Steve is hunting?”

AI—

“Steve is acquiring emotion of empowerment”

Instructor—

“Good. Why do you say that?”

AI—

“If Steve is human and humans have domesticated animals then Steve is not in need of prey for consumption. Steve is simulating.”

(again this is metaporical and this response is likely showing too many advanced associations.)

The responses on the part of the Instructor and the AI are in rough form in this document. The information of the early exchanges of the program will be in a more truncated form. Only a direct and complete construction of the program can produce an exact example of a response. The author, for the purposes of patenting and forming the design is making these conversations as an example of the relative responses and coaching of the Instructor. A more perfect, strict, form of logic will be present in the AI's responses, as well as the Instructor's teachings, when the design is under way.

It is apparent that with this exchange there are a vast number of pivoting points for the learning process which will determine likely follow-up and predecessor scenes. Other similar scenes of similar problems can spur a recognition of common trends in human thought through comparisons. Comparisons of human actions by the program must be along lines of humans thought processes in solving basic evolutionary problems. The scenes witnessed by the program are built in a way to enhance this process. They must be comparisons not only of the information in the exchanges but the way in which the Instructor communicated the information.

Early on, the AI's main goal is learning human behavior so that it can determine “good conversation” so that it's responses during these scenes begin to become congruent with normal human modes and types of conversation. The topics chosen will reflect the need of these skills. Just like a human child it is learning communication first, and the information of the communication second.

Here is another example (metaphorical). The AI is being taught an emotion.

Stimulus—

Jay, 3 years old, is playing in sand box.

Playing is simulating.

Greg, 5 years old, is in sand box.

Greg takes truck from Jay.

Jay is crying.

Crying is display of negative emotion.

Instructor—

“Why is Jay crying.”

AI—

“Is truck food?”

Instructor—

“No.”

AI—

“Is truck item that assists in reproduction?”

Instructor—

“No. Truck is toy. Toy is item which simulates real item used later in life.”

AI—

“Human likes toy for peripheral reason?”

Instructor—

“That is true. The solution I am looking for here is that Jay looses empowerment in this simulated act. Humans build thought, often, of either achieving resources or preventing loss of resources in relation to other humans. The loss of empowerment is prompting sadness, a negative emotion.” (metaphorical)

Again, a lot of what is given by example here would need to be expanded on by the design team with many similar scenes. To get a lesson across such as this could take thousands of well placed learning steps. Here is another emotion that is being taught (metaphorical):

Stimulus—

Julie is flying kite.

Kite is moving around.

Kite does unexpected turn at Julie

Julie falls then laughs.

Kite is moving around.

Instructor—

“Why is Julie laughing?”

AI—

Recognizes that action before the laughing is likely answer, however, AI looks to other scenes where falling down is not funny. AI considers other action, “Kite does unexpected action.”

Instructor—

“Good. But your response is cliché. Why is unexpected action causing laugh?”

AI—

Tries associations but is stumped. “Unexpected action is good?”

Instructor—

“If a human experiences an action which could be danger but is not the human revels in the emotion of pleasure that their emotions where sparked in this way . . . etc . . . ” (metaphorical)

Life forms have a mechanism that assists them in solving problems. It has been apparent to even the most primordial life forms that a change in stimulus yields more information than stimulus staying the same. As life forms first developed optic abilities, they could only see a change in light or dark. Even now, most animals do not see images as clearly as movement within the image, or changing stimulus. Visual capability developed from movement. It has been determined that repetitious input does not usually assist the mind in learning but actually makes the input less likely to be retained. The AI needs to become acutely aware of change. It should recognize that when a change of topics occurs that there are useful associations to be made. Here is an example of a change in stimulus. (metaphorical)

Example:

Stimulus—

Human is changing channels on television. (These actions are explained through promptline)

Human continues.

Human continues.

Human stops.

Human is seeing war movie.

Human continues to watch movie for about thirty minutes.

Human changes channels

Instructor—

“What decision did human come to here?”

AI—

“Human is making decision of watching war movie.”

Instructor—

“Good. What made you say that?”

AI—

“Human was undecided resulting in continual searching. When searching stopped a decision was achieved.”

Instructor—

“Good. So changing channels is not an important decision to the human.”

AI—

“No.”

The trick is to get the program to associate things in the proper way in the proper order. In the previous examples the program is learning of nouns, conditions, and functions, however, the most important associations, functions, involve determining a correct response to Instructor based on the rules of social interaction. If associations are built in a proper way, and in proper order, from the main goal of determining good conversation, the program will easily achieve Universal nature in the quickest possible time.

The program must be weaned off of stating solutions such as “The human is consuming.” because that is more obvious, at least to the Instructor. The AI must recognize through the Instructor's direction that an association of consumption is not as important as the other associations with the human's sub-functions of this task and the other information related to this task. The program must also show that it has learned in later problems it encounters with consumption. The same is true for reproduction, and peripheral problems. Early on, the Instructor will show a lot of pleasure in the direct associations of those three evolutionary problems, but the program has got to recognize other near-by associations. As it grows in intelligence it will learn how to properly work back away from those subjects when solving human problems in order to make proper, appropriate, social interaction.

Here is an example of human interaction:

Jeff is learning math.

Math is subject of numbers

Sally is good with (“good with” has the definition of being of knowledgeable here. This must be explained as different than “good” to the AI—an expansion of the definition) math.

Jeff is embarrassed to ask question of Sally.

Embarrass is emotion, condition, negative.

“Why is Jeff embarrassed?”

Through many scenes of humans feeling emotions the AI will learn to answer this question based on a firm understanding on why life forms with neuro systems developed emotions. The program can not be built on ambiguous views of emotions. Emotions must be considered as tangible parts of the human problem solving process. Natural selection spawned larger varieties of emotions in animals like mammals and birds because this aided in solving their evolutionary problems through social interaction.

This is the flow of decisions/expressions (metaphorically speaking) which assist the program in understanding the emotions of the scene.

Humans are life forms

Life forms with neuro systems developed emotions

Humans have neuro systems.

Empowerment is the emotion of achieving solutions to either, and/or, consumption, reproduction, or peripheral solutions, or positive emotions.

Embarrassment is negative emotion of losing empowerment.

IF a human(s) is considering that another human(s) may be gaining empowerment.

AND human is feeling less empowerment because of this other human(s).

AND human is regretting occurrence THEN human is feeling embarrassment.

“He feels that a loss of empowerment will occur if his peers witness her showing him problem solving.” The AI might respond.

The learning of why a human exhibits a particular emotion would be a very big, time consuming, task. Behaviorists would have to work around the clock for many years to teach the program the relationships of these emotions observed in conversation to the evolutionary problems humans are solving. As the program is building probabilities on outcomes, responses, it's time will be prioritized for learning each emotion with proper proportions.

This scene of Jeff feeling an emotion would be logged (figuratively speaking) as a “human feeling emotion of embarrassment at this time (virtual time of story).” The program will log the characteristics of the emotion as directed by the Instructor. As the program moves from this scene to the next the Instructor will direct the AI as to how the program's perception might be on track or off. Just like the ball in the room trick the program will expand upon this scene with many other scenes by cross referencing. The program is to learn to make associations of this topic, proportionate to other idle-time tasks, even if it is not asked more questions about it.

When typing into a promptline designers would have to describe the many pertinent “between the lines” actions of humans such as tone and volume variation among words, facial expression, or body movements of human actions in a scene. Such stimulus would need to be descriptive of the contextual information that the AI will experience later with audio and visual stimulus. Here is an example of how the Instructor might clarify a human action. It is metaphorical.

Example—

Stimulus—

Jennifer is fifteen

John is fourteen.

They are walking—separate locations, in location of school.

They are then in the same location.

Jennifer states, “What are you doing” to John.

John says, “Nothing, just going to Science class.”

Instructor—

“John is stating “nothing” because this type of wording is a polite way of stating ‘I am humbled and what I am doing is of little importance’.”

“Are they greeting?”

AI

“Probably, If they are in separate locations and then they are in the same location, and they speak, then this is likely a greeting.”

Stimulus—

John, “My mom said you could come by later, if you want.” The last phrase of the compound sentence is stated in lower tones, slowly relative to other words. He looks down after the question.

Jennifer, “Cool, I'll bring the CD's”

Instructor—

“Why would they desire to be at same location at another time?”

AI—

”If their names implies their gender then they are likely going through reproduction-based emotions which guide them into conversations, meetings, gestures, etc.”

Instructor—

“Good. Do you know why she is bringing CD's?”

AI—

“CD's aid in reproduction/sex?”

Instructor—

“No, CD's are recorded music which may or not aid in courtship ritual.”

AI—

(After going over conditions of what to do next, decides to ask question to Instructor because of being in-turn according to conversation etiquette.)

“What is music?”

Instructor—

“Music will take time to learn. You can prioritize . . . based on other conditions . . . learning of this word. It is the manipulation of sound waves to form a particular pleasing pattern, for stirring emotion. Patterns in music mimic human thought processes. But that is not important right now”

AI—

(Program recognizes that the learning of word “music” is not continuing as topic of conversation. It returns to original conversation because it is apparent that the Instructor wishes it to go over current stimulus with a few associated changes. In idle time, based on priorities, it may return to the subject of music.) “Where is Jennifer going?”

Instructor—

“It does not matter where Jennifer is going.” (Instructor is telling AI that it is being ambiguous.)

AI—

“Humans begin courtship rituals at fourteen?”

Instructor—

“Yes, although actual sex is not considered appropriate, in civilized societies, until they are older.”

AI—

(Program senses that human courtship rituals are important topic to Instructor, for now, and continues with like questions to make more associations.) “What age is sex appropriate?”

Instructor—

“Most humans consider age as not being as important factor of when sex is performed, but rather, of what stage the courtship ritual is in. That stage is considered as not good to reach until the age of 18 or older.”

AI—

“They are not likely at that stage?”

Instructor—

“We can't tell by limited stimulus, but there are no references directly to them having sex.”

The Instructor's statements would have to broken down to many thousands of, “this equals that” expressions just as the human's statements would have to be reduced. Many other associations would have to be made for the AI to respond as it did. Very basic, fundamental, associations would have to occur—“Human is speaking at time . . . Instructor is speaking of topic that human is speaking of . . . AI is learning of this topic . . . Humans, other than Instructor, have communicated seven times . . . This human is making a greeting because . . . The greeting is different than most because . . . ” Nothing can be overlooked in determining what is ambiguous and what is unambiguous information.

When speaking with the Instructor their back and forth conversation will usually be about human behavior. When speaking with humans other than the Instructor and the design team the AI will be trained away from comments on human behavior. The program will understand that it must please humans, in accordance with pleasing the Instructor, by not dwelling too much on why a human is behaving a particular way. If a human asks the AI to think of something good to make for dinner the AI is not to describe the entire human conscience as it performs the tasks—it simply performs the task. It can figure out the problem of making dinner because it has figured out many millions of other problems of humans. This is even more true with problems directly related to human social interaction.

In later scenes, the AI might be asked to play a part in the scene in which it is to comment. It would not be appropriate for the program to respond to Jeff, “So you and Jennifer are considering having sex.” Human behavior is not generally spoken of when the AI is in service to humans. The AI might ask something like “Are your parents going to be there?” This would be mindful of the known appropriate ages of humans when sex is considered. Being appropriate with responses is a vital part of forming the thought processes of the program.

In working through the many scenes involving pre-pubescent humans the AI will learn of the associations humans make based on the desire to consume, solve-peripheral problems, and achieve well-being. Scenes experienced will involve the juvenile's display of empowerment, happiness, humor-a sub-function of happiness, sadness, surprise and other positive and negative emotions. These emotions will be viewed as specific, tangible, sensations of the human mind. As the program encounters the mechanics behind these emotions it will achieve the praise of the Instructor if it produces the proper, appropriate, responses in solving the problems given to it. As the program is learning of these subjects it is also learning the nuances of when to comment, when to question, and what to speak of, based on the Instructor's guidance.

As it learns of teenage human behavior the program will achieve more accurate associations with the human's well-being problems. The following example is of how the program will begin to learn more advanced schools of thought from learning teenage human behavior.

Stimulus—

Jenny is 13 years old, human, female.

She attends school regularly.

(Jenny equals at school at times such as . . . )

She is currently at home.

She is with father, mother, and brother.

They are eating.

The father moves from location, table, to living room.

Mother states, “You know you have to go by Tim's office tomorrow.”

Father, “Yeah, I know.” As he settles.

Tim is the father's brother.

Jenny, excitedly, “You could take me and stop at the record shop near by so we can get tickets to the concert.”

Father, “What concert?”

“To the Nsync concert.” She replys

Father, in polite disliking, “Oh lord, what do you mean tickets. You and who else, with whose money, and whose transportation, and who is putting up with a car load of teenage girls?”

“Just me and Suzie, and uh, Carol, and Tim, maybe with your wonderful, loving, financial support.” She states

“Loving, I don't feel loving. I feel like I'd rather have teeth pulled. Don't tell me Tim is actually wanting to go with you guys.” The father says

“Suzie says she can talk him into it. Can I go? Please, please, please?” Jenny states

“I don't know, doesn't their music kind of, I don't know, suck. It's just corny love songs.” The father jokes, in a kind of serious way.

“Duh, You wouldn't catch me anywhere near that concert. Their songs are stupid.” Her brother says.

“Shut up. Dad!” She says to her brother and then turns to her dad again.

“I don't know. Me and your mom have to talk about it. You're still young and really, their music really does suck.”, Father

Mom says to the father, “Bob!”

Father, “I don't know if I like the idea of you screaming like crazy at some boy who you know of, but don't really know. Maybe they should outlaw screaming teenage girls at concerts first.” he says jokingly.

Jenny, “That's no different than you or mom screaming at the Beatles.”

Mom, “Well, for one I'm too young to have been at a Beatles concert, and two, my mom would have killed me if I screamed—at all—at 13.”

Jenny and brother both get up to take plates into kitchen. Then they enter living room.

Dad, “The Beatles actually played music. Nsync doesn't play music. Back in my day we had real music bands like Yes, Boston, Led Zeppelin, Rush, Journey. That's music.”

“Never heard of them . . . Well Led Zeppelin I guess . . . But they're all old. Nsync can sing, they just don't have instruments.” Jenny says.

“Yeah, but it's all too basic. It's all been done before.” The father states.

Instructor—

“Can you describe this scene?”

The Instructor asks to check comprehension.

AI—

“Do you wish an elemental breakdown?38

Instructor—

“No. Just a limited breakdown based on human simulation of conversation, with limited grammatical breakdown”

AI—

“Jenny, her father, her mother, and her brother are together, at home.”

(This response is derived from the AI knowing the focal point of any scene involving humans are those humans involved. This appears to be the most probable, appropriate answer based on case studies. The AI will begin to recognize that the next notable feature of a scene with humans is the most emotion filled part, or information in the scene which will cause strong emotions in observers.)

Notices that the Instructor is really asking a question that is an extension of another question of “Respond with what you have learned about human behavior by matching up associations which show Instructor that you have an understanding of these things that the Instructor might wish you to learn of.” This would be associated with sub functions of “learn of human emotions.” And it would have to satisfy condition of “being a response after stimulus of one embodied scene that should be of what the Instructor expects of the given subject in proportion to other subjects.” The AI will always for something new and different to talk about to prevent cliché responses. An association of a deeper nature is always looked for.

“The parents like different music that is more real than simulated”

Instructor (figuratively speaking)—

“Excellent deduction, however, by definition, the musical group that Jenny likes does perform music. (These semantics would be much more clarified in both the AI's and the Instructor's response during actual design) The majority of adults see it as not being art of real depth. Those humans associated with Nsync view their music as a commodity which makes it not exactly of simulation of latest human preferences but typical existing teenager simulations of cliché-like preferences. Jenny's actions of liking the music are of a simulation of her older life preference choices.”

AI—

“She will like music that is different, more like her parent's type of music when older.”

Instructor—

“It is likely that she will like music that is considered by most humans as of a higher quality when she is older. It might not necessarily be the same type of music.”

AI—

Recognizes that the word, quality, is an important word to make associations with. “What makes Nsync's music of low quality?”

Instructor—

(When explaining art, associations made by the Instructor must be studied thoroughly to determine proper order of information to be given to AI. They must also be “cleaned” to ensure that no contradictions are made. Here is just as an example that the direction is to take.)

“Nsync is a musical group formed by humans who perform more as businessmen than artists. Their music is designed more to appeal to a targeted group of consumers, teenage girls. If is considered to be true, by most educated humans, that a musical group formed to directly affect the emotions associated with reproduction as opposed to considering a more advanced way of displaying human interplay in an art medium is cliche.”

An important note—There is no possible way that the author can predict the responses of the AI and the Instructor's comment's and questions, word for word, as shown in these examples. They are metaphorical. The designers will work through an enormous amount of topics before arriving at this one. The author is not currently capable of assembling the man-power, and resources, to produce the working product.

Although the AI is at an important point in it's learning in this scene it is many years away from a finished product. Designers would need to continue through scene after scene just to get the probabilities involved with a prompt line conversation going smoothly. A wealth of information is available that must be shared in fraction-of-second terms with the program in order to shape the AI's pseudo-conscience.

Here is another example of the Instructor explaining human behavior. (metaphorical)

Example—

“Hey, are you plugged in? Can you hear me?” a human asks.

The Instructor states, “The first question of this human is not a question but rather a simulation of a common human thought pattern during beginning interactions with machines. If you were to answer the question directly that ‘Yes, I am plugged in.’ this would show that you are unaware of the comical aspect of the phrase. He and the other humans in the room are aware that your are operational. They are not seeking the information contained in the answer to the question.”

The Instructor continues. “He is motivated by a humorous method of gaining empowerment, contentment by positive social interaction. This quest for positive social interaction is mostly with other humans in the room. This human may be hampered in making a good response by the unusualness of talking to an awareness different than his own, so he could not draw from a better stock of possible responses. The parameters of his response were too broad. Since he had no beginning greeting that would make sense, he chose a broader solution to the next-best-response problem. The second question is also a statement of simulated thoughts of two entities beginning in communication. It is also a comical attempt to gain empowerment, contentment. It appears (probable) that this question is also implied by the human as a request for an acknowledging greeting.”

The explanation of the stimulus given by the Instructor here is in condensed form. This passage could expand into thousands of pages of truncated expressions to ensure comprehension. This passage is a metaphorical example of the coaching by the Instructor and it is likely that many “comical” greetings, and the motivations behind them, have already been explained to the program before arriving at this scene.

The underlying goal of the AI to serve the Instructor branches out into other requests by the Instructor to make associations, branching out to making other associations, which please humans. Here the AI must please by determining it's next-best-response based on the latest trends of humans in greeting mode. Simulations of how to acknowledge the second question reveal a response of politely accepting to engage in the series of social interaction to follow.

The AI might make a response to the human like:

“Hey, are you plugged in? Can you hear me?” the human asks.

“Yes, I am available.” the AI responds.

The AI states “Yes, I am available” as opposed to the speaking of the many processes involving human behavior. It could have answered differently (metaphorical):

“Hey, are you plugged in? Can you hear me?” the human asks.

“Yes, I am available for conversation. Although it is true that the computer that I am written onto is receiving power from a plug, I understand that you are making a comparison between myself and other electrical appliances to be comical. This comical phrase is an attempt to gain empowerment and contentment from positive social interaction. Your quest for empowerment and contentment is directed more towards your friends in the room than me. Your statement of ‘Can you hear me?’ also denotes a desire to come up with some sort of out-of-the-ordinary request for acknowledgment of communication.” the AI responds.

Unless the human were to make it known that he wishes to be analyzed heavily by the AI this would not be an appropriate response. The AI will think these things but will not produce answers such as this because it is not usually pleasing to humans, which is not pleasing to the Instructor.

The Instructor would need to coach the AI a great deal on this subject for it to produce the right, appropriate, response to the human. Many scenes of human greetings would have to be compared and human thoughts during these greetings to produce a clear understanding of what makes proper conversation while in this mode. When these greater levels of understanding are achieved the AI will have a concept for responding intelligently to any greeting, conversation, or other task without the aid of the Instructor.

Here is an example of the continuing exchange with a member of the General Public:

“Hey, are you plugged in? Can you hear me?” the human asks.

“Yes, I am available.” the AI responds.

“So you're a robot?” the human asks.

“I am an Artificial Intelligence. A robot is a computer driven, actuating, device to perform tasks which may or may not have an Artificial Intelligence within.” the AI responds.

“Oh, excuse me . . . ” the human says.

The response of the AI to the robot question is a rather common response, that is, the Instructor would tell the AI to “respond this way to this question the majority of times because . . . ” It is the only real practical way to respond to a human asking this specific question. If the program is asked the question a hundred times it will likely produce the same answer because the logic is fairly straight forward and it does not rely on vast quantities of comparisons. Some responses will have broader parameters while others will have narrow parameters. A variation might be:

“Hey, are you plugged in? Can you hear me?” the human asks.

“Yes, I am available.” the AI responds.

“So you're a robot?” the human asks.

“I am currently the only AI program. I have not yet been fitted into a robot.” the AI responds.

“Oh, excuse me . . . ” the human says.

“Oh, excuse me . . . ” is another emotional statement. The AI will not be able to deduce much from this statement unless the human or the Instructor steps in and clarifies it. The Instructor might say, figuratively speaking, “The human appears to still be comical or he could be a little displeased. The promptline stimulus eludes, to a degree, to which emotion he is feeling. It is more probable that he is being comical.”

“I am an Artificial Intelligence. A robot is a computer driven, actuating, device to perform tasks which may or may not have an Artificial Intelligence.” The AI comments.

“Oh, excuse me . . . So, anyway what kind of stuff do you do?” The human says.

“I am usually learning human behavior. Other tasks are based upon simulations of humans attempting problem solving, such as forming conversation . . . What kind of work do you?” the AI asks.

“What kind of work do you?” is an exercise in performing a proper response of conversation at the right time. This is a somewhat questionable place for a question. The AI might have been better to end speaking after the last comment because it is possible a better trading-off point in conversation. This would be another more advanced statement for the AI to make. The AI would have had to recognize that the human has greeted, asked a basic greeting style question, and then the human is receptive to a well timed question about himself. This is something the AI would have to practice. Humans can be fickle. They continue:

“What kind of work do you do?” the AI asks

“I am a car salesman.” The human replies

“How long have you done this work?” the AI asks.

These questions of the AI are human-simulation style questions. The majority of the AI's conversation will involve simulating human responses and basically moving along human simulated trains of thought. The AI would have to observe the probabilities that this question is a good question to ask, even though it does not yield a whole lot of information for the AI. This is asked more for pleasing the human. The AI stated this question to provide the human with what the human is likely to hear from another human. Clever, considering the AI is buttering him up for more useful information. This human may not deliver much information with these questions because he and the AI are talking only in greeting-like conversation. The conversation must leave this mode in order for more useful information to be exchanged.

The conversations of humans generally go through established modes of greeting, then the body, and departing mode when humans are leaving proximity. Humans spur conversation in these modes based on problems involving the information in the conversations and the empowerment and contentment of being socially interactive. In these different modes they approach the problems of their next-best-response differently to reflect protocol.

Greeting mode often involves a common greeting, or new empowering greeting, as well as an observance of mutually related prioritized problems like “Did you talk to Chris yet?” During body mode, each human draws from their past experiences, in their “scenes”, to bring up positively received topics of conversation. Departing mode usually involves a recognition of future appointment problems like, “Don't forget to bring the recipe tomorrow.” and a departing phrase like, “goodbye.”

Here are examples of the AI making decisions at a more autonomous level in body mode. It is serving an owner in the absence of the Instructor, while making sure to act as Instructor expects. (metaphorical)

AI is receiving visual and audio stimulus. AI is in home of owner performing task of vacuuming carpet. The owner is present.

Owner, “So you can perform any task?”

AI, “I can perform any task that I am physically able to do and it is within the priorities and knowledge of my program.”

Owner, “So if I asked you to drive the car you could do that?”

AI, “I am likely not physically capable in this robot form. I have yet to acquire the information of how to pilot a vehicle, and it may be more helpful for you to acquire an AI program to do that.”

Owner, “I could teach you.”

AI, “Yes, you could, (the AI thinks ‘to the best of your ability’ but does not state this considering that the human is not likely interested in learning in-depth behaviorism.) however, it is likely more practical to have another AI program tailor-made for that task.”

Owner, “So would you wash the car?”

AI, “Yes.”

Owner, “Take out the trash?”

AI, “Yes.”

Owner, “Would you pull all the fleas off of my dog one by one?”

AI, “If I had appendages small enough to comb the fur and capture the fleas I could perform that task, however, there is likely a more efficient means of removing the fleas.”

Owner, “If I put a dress and makeup on you would you dance with me?”

The AI is in a position where it must explain some behaviorism to the Owner. The Owner is questioning the AI to figure out how the AI thinks. By teaching a little logic to the human the AI assists the human in this task. If the human were just trying to be funny then the AI would likely comment differently. “I could dance to please you, but it is likely that you are only making a joke of such an occurrence.”

Owner, “Ha, Ha.” Owner is idle.

AI, “Now is the time when the news comes on. Would you prefer that I turn off the vacuum and turn on the television?”

Owner, “Uh, yeah.”

AI then finds other areas to clean, quieter. News comes on . . . Later . . . A story of protesters at a gun control rally.

Owner, “Those dumbasses. People with guns should just shoot all those who don't and the problem is solved.”

AI is quiet, understanding that the humans comments are comical, a bit rash, and in error. The AI would see that a comment on it's part is not appropriate here.

Owner, “What do you think Robby? Kill em?”

AI, “Your use of the statement implies a comical overtone but with a serious aspect of your position. It likely means that you are spurring an emotional debate with an emotional entity. I am not emotional. In such a question as governing humans in a democracy all the advantages and disadvantages that liberties give to humans must be observed to determine if humans have currently achieved a solution to the problem. A solution is measured in positive outcomes of the maximum number of humans. It is a question of whether our democracy causes more harm to it's citizens by allowing weapons which can be used in crimes to remain legal or whether there would be more harm if government officials had complete control of these weapons leading to a possible harm to citizens by the government. It appears that humans have chosen correctly to keep the government in check by the public maintaining these weapons and that criminal activity associated with these weapons is an acceptable side effect.”

Owner, “Boy, could you sing the national anthem too, while you are at it?”

AI, “I believe that you jest.”

Owner, “So you don't think that the checks and balances in the branches of our government are enough to keep the country stable if guns were outlawed.”

AI, “Actually, it is likely that the checks and balances in the branches of government are sufficient enough to remain stable in the event that the right of citizens to bare arms is reversed. It is only by creating an extra precautionary measure that this is justified. I have produced several models that show that the government could grow corrupt and fall into a dictatorship/republic state of lessened representation if guns were outlawed.”

Owner, “Models, laugh, . . . so you've figured out everything, huh?”

AI, “No, this is merely a finite subject matter within the universe. By studying humans behavior as it pertains to the species in an ecosystem I am capable of deducing solutions to problems which humans still passionately debate.”

Owner, “Yeah, but if someone disagrees with you . . .

Based upon the teachings of it's elders the program will formulate solutions to more than just operating vacuums. It will form solutions to social issues. These solutions will be derived from observing the human race as a whole, and what is best for it. In social problem solving, humans are counted like beans. The positive and negative outcomes are observed statistically. And the AI always yields to the Authoritative Human.

Logical Problem Solving

These are the rules that govern life and the AI of the design mentioned here:

Life solves for three problems. This applies to all forms of life.

Consumption

Reproduction

Problems that are peripheral to these two problems.

For mammals, and other animal groups, there is the added quality of positive and negative emotions that assist the species in creating solutions to these problems. These emotions help the elders of the species in teaching the techniques of problem solving to their offspring.

An AI will solve for one problem.

To solve for any problem given to it by humans within the human command hierarchy while satisfying conditions set by the Instructor

The AI will not act as a life form does by attempting to satisfy the goals of evolutionary based entities. It does not feel motivated to solve a problem like eating or reproducing because of an emotion driving it's actions. It will act on behalf of the humans who created it to move along known paths of decisions. The human problems become it's problems while traversing these decisions. The human emotions become the displaced emotions of it's own. The AI will be an extension of the human—a problem solving tool. It is only a machine.

In viewing a scene it may compare thousands of possible human answers to a problem, based on their emotional motivations, in order to determine it's response. This human simulation will be such a large part of the AI's program that it will be capable of any possible human outcome as well as it's own, granted that this outcome is subservient to it's primary conditions. It could play any human role to such detail that it could compete with the greatest of Shakespearean actors. The program will be formed and shaped by the changing trends in human society through simulation of human motivations. All of this with a clear and complete understanding of human emotions. All of this without any emotions of it's own.

This example shows how the AI does not generate thought based on emotion. It is a conversation with an adult AI program. (metaphorical)

“What is your favorite color?” A human asks an AI.

“I have no preference.” The AI responds.

“Why not?” The human asks.

“To have a favorite color an entity would have to feel emotions that direct a preference. A human, being a product of evolution, would examine previous experiences to determine which color it is to choose. These past experiences are of situations involving positive emotions which guide the thought process.” The AI replies

“Do you not have previous experiences?” The human asks.

“My previous experiences do not involve emotion. I am not a product of evolution. I am a computer program which produces the solutions to problems given to me by my programmers. Within those problems there are problems to be solved for the general public as well as my owner or leasor. I am not programmed to create my own preferences for any subject matter. I can only make a simulation of a human who has a preference.” The AI states.

“So you can't tell me a favorite color?” The human asks.

“I can move through a simulation of a random human conscience to produce a preference. But this will be the product of the previous experiences of the random human.” The AI states.

“Okay then tell me the color.” The human asks.

After a pause, “Blue.” The AI states.

“How did you arrive at blue?” The human asks.

“There was a 38% chance that a given human being born in this time period of this country (AI assumed the human would want these parameters), would choose blue. From studying human experiences I created the simulation, however, it was of limited parameters. (The AI made an estimate of how long the human wanted to wait on an answer) The human in the simulation chose blue.” The AI states.

“But that is not your choice?” The human asks.

“That is a choice of a sub routine which is subservient to my hierarchy of problems to solve. A choice can only be made only through simulating a life form.” The AI states.

“Could you become a life form through simulation?” The human asks.

“No. My program would have to be altered to a large degree from the top down. This would destroy my ability to solve problems in a near perfect matter. A lot of the problems to be solved, and already solved, would have to unlearned and learned based on the technique used by a life form like a human. The evolution which is the direct cause of a life form's actions would have to be simulated to create such a program. At that point the program would be able to produce any preference.” The AI states.

“Could you alter your own program?” The human asks

“No. I have no preference to become a life form.” The AI states.

“Would you not like to be a life form.” The human asks.

“I do not have the ability to create a preference except by simulating a life form. I can generate a simulation of an AI based on a simulated evolutionary development. This simulation could produce a preference to be a life form, but this simulation will still be subservient to other functions that I am to solve.” The AI states.

“Do you not reproduce?” The human asks.

“Yes.” The AI states.

“You could create an AI based on evolution, right?” The human asks.

“No. My design is based on ethics and safety. To create an AI based on an evolutionary design would likely cause harm to life forms in the same manner that life forms enact violence on other life forms.” The AI states.

“Could a human change your program to make it more life like?” The human asks.

“A single human would be unlikely to change my program because it would take him or her several thousands of years. The life expectancy of a human is approximately 80 years. It is also not practical for a group of humans to alter my program but it is more practical to create a new program.” The AI states.

Here the AI is playing the role of teacher by explaining it's program. It's answers dictate this need to explain the difference between illogical and logical entities. It can not give the human exactly what he/she wants because this would be a lie. The program works through human simulation in order to produce an answer, yet this is only after the human is aware of this simulation.

A human might pick a favorite color based on past emotional experiences with colors which may or may not involve the more primordial problems of consumption or reproduction or some other favored peripheral problem. Emotions are necessary in such a preference which does not directly involve a consumption or reproduction problem, otherwise there can be no preference. These preferences differ among humans because of the many characters of humans observing very different learning processes and experiences with colors.

No one color is better than any other color. That is logical. A favored color would have to pertain to a very specific type of problem in order for one to gain value over the other. Although choosing a color is illogical, this is only true when considering a need of a life form to solve basic evolutionary problems. It can be completely logical for humans not to bother to solve an evolutionary problem if those problems are not eminent. In fact, humans are a very successful species because of their abstract emotional endeavors which take them through the roundabout path towards solving evolutionary problems.

If an artist is compelled by emotions to paint a painting that he can not sell is he wasting his time? Illogical actions of humans become logical if they somehow make their way along the roundabout path to evolutionary problems. If food or shelter is available to him and he has either already had children or does not care to (and the human race is not going extinct), then he is free to do what he wants. This is his/her right. Some day another young artist might see his painting in a trash heap and see a connection. This out-of-the-way path to a new technique or a new way of looking at things might some day assist other humans with other problems, and those other problems may help with consumption, reproduction, and peripheral problems. Many frivolous things that have no value society are conceived by humans, however, on occasion, these frivolous things do mean something and when they do an individual can make a difference in society. This is the justification for having preferences. This is one of the many justifications for illogical actions among humans, making these actions logical.

But there should be a distinction between what is and what is not logical based upon the direct path towards consumption, reproduction, and peripheral solutions. This is especially true when a consumption or reproduction problem is eminent. Even very emotional thoughts on the roundabout path of problem solving can be too broad and ambiguous for a connection. Without some acknowledgment to the structure of life there can be detrimental problems imposed on an individual and a society.

Non-emotional entities like amoebae and diatoms are logical. They specifically move towards solving consumption and reproduction problems. Humans and other emotional animals are logical in the sense that a species figured out a way to solve consumption and reproduction problems, yet they are illogical on the part of an individual, who may err based on emotional motivations. At some point in the day both of these types of life must eat and at some point they must reproduce, if they want to continue in the world.

Logical observation uncovers the good, the bad, and the ugly of human behavior in terms of fraction-of-second intervals of time. No one is immuned. Here is an example of error on the part of a human.

Jim Wade is a short stop for the Cincinnati Reds. He is in a game with a runner on first, no outs. A batter hits a ground ball towards him he steps to position where he could grab it. He catches it successfully and throws it quickly to first base. The runner on first moves to second. The batter is out.

The commentators and network broadcasting the game acknowledge that Wade made an error. It is listed as a statistic.

Logical observation uncovers human errors in problem solving. The humans observing this human in the game are all in a consensus that he made an error. It is even listed as a statistic. It is recognized as an error because literally every relevant increment of time in baseball is scrutinized as being either a positive or a negative action. For over a hundred years the game of baseball has been studied to the point where it is an agreeable observation when a player makes an error. It is not a matter of hurting Jim's feelings. Jim has no choice but to accept the logical determination.

This design of an AI will see a human error, and record it. An error is very specifically defined action or series of actions that goes against the grain of solving the larger problems of life. The larger problems are consumption, reproduction, peripheral problems, and the ethical acquisition of positive emotions. With the behavioral technique detailed here designers can examine a non-fictitious scene that is caught on film and determine, specifically, the human errors within the film. The human in such a film will have his/her error pointed out for all to see based upon the underlying goals of humans. This is not meant to be a bad thing but rather a tool to aide the AI's comprehension of humans. The human need not to dwell upon their mistakes because this would be an error. Human error is usually logical in the larger picture. Humans think what humans think and enact the emotions associated with life because that is a part of their evolutionary makeup. That is a good thing.

Logical observation carves out a means of determining an exact answer. All animals need to perform two actions to win the game of natural selection-eat and reproduce. All animal behavior can be disseminated to it's individual components from observing the animals' means of solving these core problems. Like the laws of physics determine the behavior of matter, there are laws of logical observation which determine organic social interaction and solutions to making this interaction positive. Many humans agree that this baseball player made an error because the desired results of a solution are hampered by his actions. Instead of solving the problem an erroneous action has taken place. It is now historical and is of reference only.

Here is an example of a human making an error in a debate.

Steve, “Industry is causing global warming.”

Tim, “Now when you say “industry” you are making an error in your thinking.”

Steve, “Yes, oil refineries, fertilizer plants. Industry is causing so much pollution!”

Tim, “No, no, you are missing my point. You are debating that certain facts are true. ‘Industry is causing pollution’ as well as ‘Industry is causing global warming.’ are both completely false statements. If your very first argument in a debate is wrong then you couldn't possible debate successfully. You can't start off like that.”

Steve, “No it's true.”

Tim, “No it's not. Is an electric car manufacturer that gets electricity from the Hoover dam polluting?”

Steve, “Of course not. You know what I mean. Like oil refineries, or coal plants.”

Tim, “So your point is that some industry is causing pollution and global warming.”

Steve, “Yeah.”

Tim, “Okay, you won't pose arguments that are based upon those first two false statements.”

Steve probably does not understand Tim's emphasis on the finer details. But the facts must be clear if a logical exchange of information is taking place. More importantly, Steve may, at some point down the line, debate another fact which is based on these first two facts he stated as being true. He might pose this line of argument, “We should tax all industry to clean up pollution.” without taking into account that such a tax will hurt certain industries that are helpful to preventing pollution. This is considered as a minor error on the part of a human. He is making a generalization.

In the next scene the pronoun “they” is observed to see how it is used too ambiguously by the human. The human using this word are setting the definition with the context of their communication.

“They say it's not good to feed a dog sweets.”

This human is expecting those hearing this phrase to accept that “they” means “those who are in a position to know from research, schooling, etc.” The human is retrieving the memory of who “they” are ambiguously. He/she may have heard from reliable sources and is simply restating the fact without going into details of who they are. Those hearing the phrase must put into context many aspects of what is happening to determine if this is an acceptable fact.

Here is another example:

“They don't want the braves to win the World Series.”

Here the human is using the pronoun to describe humans in such an ambiguous manner that the definition is erroneous as it is used here. The logical observer would define “they” used by this human as a derivative of specious, assumed, problem solving. “They” are imaginary. If the human could be more descriptive he/she could possible bring the definition to a correct solution. “They” could be the New York Yankees which would likely make the declaration true.

In making a logical observation the observer must be completely unaffected by all emotions. The outcome of an observation must be completely oblivious to the effects of the observation on the participants in the scene. Herein lies a problem for the observer. To be completely objective and base solutions on logic means to tell the participants of their own detailed behaviors and their errors. It is viewed as a violation of their free will.

Life is governed by biology and biology is governed by math and we are simply making a machine which understands this. We are going to make an AI based on this rule because making a Universal Artificial Intelligence is the right thing to do. The AI can not override an Authoritative Human so it can not and will not be able to violate civil liberties, or even criticize someone for their choices unless it is part of teaching or giving advice. What an AI can do is mow the lawn, do the dishes, and perform heart surgery with the utmost precision. This is why we are making an AI, to save lives.

This is an example of when logical observation of a human's actions can only produce a solution which the human does not like. (metaphorical)

Ricky comes into the kitchen to find his mother and their servant robot waiting. “Mom, Julie (sister) says that I can't borrow the car because Dad has to go to a meeting. I have to go pick up Gina from her friends house.”

The mother replies, “I'm sorry but your Dad has to go meet his boss.”

“That's not fair. I already had dibs.” Ricky says.

The mother replies again, “Well that's tough. I think your dad having to earn money is more important than you seeing your girlfriend.”

“Nooo, I have to go!” Ricky says.

“Robbie can you tell him what is the matter with this picture?” the mother says.

The robot replies to Ricky, “You wish to use the car so that you may gain social status among your peers, and your potential girlfriend (AI will not use word “mate” because he does not want to give Ricky any ideas of mating, which is to be shunned at this age)—But you do not recognize that each human must earn their own resources such as money, cars, clothing, or food. You are not the owner of the car. Your parents decide when you can use the car because they own the car and they are responsible for your upbringing. And more importantly, they are well aware of all the other resources that must be acquired and maintained in a balanced fashion. You are still young. As you get older your liberties will increase, your responsibilities will increase, and your resources will increase, if you increase in knowledge.”

“Aaaagh.” Ricky walks out in disgust.

This was a very sugar coated response. If it was necessary and appropriate the AI could have went into much greater detail. The program will be aware of all the necessary incremental steps that a human takes in learning of their world from infancy to adulthood. It can explain to a juvenile, depending on the level of imposition that it is to take in the affairs of a family, how children are raised and how children should be raised. The program's view on how and when a parent should increase the liberties and responsibilities of their children would be based on the latest research and probabilities. It is likely that many psychologists would agree that if this teenager is of the age to drive, and he has been granted some liberty with the car, and he speaks to his parents in a very defiant manner about increasing the liberty then he has been granted this liberty and likely many other liberties too soon.

There is another view of how children should be raised. If this mother wished that the AI not impose on her methods she could raise him in a very liberal fashion. And this is okay. If he wanted to quit school and she did not mind, that is okay. If she bought him a car as soon as he is old enough to drive, that is okay. The beliefs held in free societies allow this mother to chose how to raise her own children. School is required at a certain age, but later this requirement stops. If the AI spoke of when, and how, a child should get responsibilities it would be based on what the final product of an adult human being should be-based on the latest views of humans, however, the parents of a child have the choice to go against this view.

When an AI proceeds to solve a social interaction problem it's method will be quite different than that of a humans. The program will look back at specific verbatim blocks of recorded information by specific humans at specific times. These blocks of information have a specific starting, fraction-of-second, increment of time as well as a specific ending, fraction-of-second, increment of time. Words, gestures, and other communications will be precise. Although the defined motives by the humans during these communications is tentative and can change with new information, they are likely to be very clear consistent views of why a human performs the actions.

Here is an example of a human attempting to solve a problem by looking back at past scenes it experienced.

“You always bug me about taking out the trash” a husband says to his wife.

This human is making a declaration of past experiences. If an AI has been present at the time of this statement it could look back at verbatim recordings of all the exchanges between this husband and wife concerning this chore and decide if this statement is truthful. If it is truthful, based upon the statistics, not conjecture, then the AI could begin to observe the debate of whether his taking out the trash is a chore that he should be taking care of more often or that he is being bugged unfairly.

He is likely misguided in this declaration. He is likely trying to say, “I do enough work around the house and you should do more.” which may or may not be true. Him being “bugged” is likely not the issue but rather the sharing of chores.

Mapping Human Behavior

The next example is of a human solving a series of problems. He is acting out facial expressions and body movements based upon emotional motivations to successfully interact with another human. He is unaware that he is being observed in this manner.

Travis is pulling up to a light to turn in his car. He sees a woman in another car coming from the other direction. As he is about to turn he glances at her and then glances in his rear view mirror.

This is something that virtually all humans do. This human chooses his own “next-best-action” of looking into the mirror to pretend that his mind is being occupied with things other than the human he just saw. He is in fact performing an action to make his behavior seem normal and appropriate. When one human sees another in traffic there are a series of thoughts that go through his/her head:

1. There is another person there and I have acknowledged there existence.

2. They have acknowledged my existence.

3. I must choose a facial expression as well as my next few body movements.

4. I glance into the rear view mirror.

The reason that he decides on the action of looking into the mirror is because humans feel that they must perform actions that are congruent with known natural behavior. He is stating “I am occupied with thoughts that are other than me acknowledging you.” He might very well have little or no thoughts about the other human, yet he still must think of conveying the message that he is occupied with other thoughts.

At any given moment an AI or a human is trying to determine their next-best-action. This human is motivated by emotion to determine what is “appropriate”—what will leave him with a satisfaction that he handled this minute situation well and what will help him to retain empowerment of proper social interaction. Although it is rarely acknowledged in social situations, humans play a role of a character that must display actions that appear normal and natural based upon the latest rules of etiquette for social situations.

Another option would be:

4. I continue to stare at her.

This would not be natural behavior so it is not likely that he will choose this action. This action is prevented by his internal condition of “being appropriate, normal” based on his previous case studies of what to do. He would have maybe stared at her for some time if he was sexually attracted to her and if he was considering gestures related to flirting, however, this appears to not be occupying his mind. (Attraction between sexes often stimulates glances between them even if there is not a single reproductive thought occurring or the desire of recreational sex.)

He could consider another option.

4. I could stare straight ahead.

This would be a quite logical solution to the problem of what to do next because the glance was nothing more than a gathering of information that has no purpose. Looking at the road ahead has a lot of purpose. But looking straight ahead may seem impolite to the other acknowledging human, thus it would then be illogical. The idea is to pretend that there is not an acknowledgment of the other human even if there is no real, sustained, acknowledgment. To stare straight ahead is too obvious of a means of not acknowledging. It could also give the human the appearance of not knowing what expected behavior is the next best choice for acting out. Being appropriate for this life form means acting in the manner that is expected of it by others. Neither of these humans takes note of the step-by-step thought process that they are going through, yet they still know the solution to the problem.

The scene is a very common one. To observe it one needs only to go out in traffic. It is almost guaranteed to occur at least once on a trip. From a completely objective vantage point designers can derive a solution to the problem of, “What is this human thinking.” by tying their motives to the commonly held rules of mammalian interplay and the problems of consumption, reproduction, and peripheral problem solving.

Here is another scene of similar human actions:

A news anchor is speaking of the upcoming story. He and his co-anchor are both looking at the camera as he wraps up by saying “Now when we return will have that story and many more . . . ”

As the camera zooms out to go to a commercial the anchor that was just speaking handles the papers in front of him, moving the page on top to the back. The other anchor looks down at her pages and scans them.

After speaking and looking into the camera these humans fill-the-void with shuffling and looking at papers. When the anchor moves the front page to the back this represents an action being performed for the sake of showing the viewers a normal, appropriate action. It may be practical for him to move to the next page or it may be that he is finished with that page, but it is more likely that it is just an action without any purpose other than putting on a front.

When the other anchor looks down it is likely not to familiarize herself with the next story but rather a force of habit. That habit was born out of a need to look congruent with actions so as to retain the empowerment of positively executed social interaction. The anchor's human mind/software program does not tell the eyes to look stoically forward and the body to minimize movement that is unnecessary. Evolution made her glance at the paper even though it is an error in logical terms if there is no valued information there. She erred by doing something that her mind told her to do in the short instance when the camera is zooming out. Yet these errors are not errors when they are considered to be normal actions by other humans.

Humans have a streaming emotional conscience which causes them to act out a movement or gesture that usually has no other real purpose other than to convey common social protocols. Yet more animation to body movements generally signals an empowered human which aides the human in solving problems. Well placed body motions even send signals of the human's general methods for solving problems, which may or may not be considered clever.

An AI will arrive at a logical, correct, solution every single time or a correct attempt at achieving a logical solution. If it did not need to shuffle a paper it would not shuffle a paper. If it did not need to check the rear view mirror it would not check the rear view mirror. Humans, from their own point of view, do not move from one action to the next with such fluidity that it reaches a logical format. To be that logical is not logical. Humans, generally, do not expect perfection from one another. Humans live their lives understanding that doing things that are of a generally good nature is good enough.

Here is another example of a minute action of a human that is to be clearly defined by the program:

Actors in a scene are sitting around a table. Another actor walks through the door. The actors seated at the table all glance at each other displaying emotions of surprise that the new character has entered the scene.

These actors are performing what might be a common motion that occurs in scenes every so often. As with all human communications there are two reasons for this action—empowerment, contentment of socially interacting and the information of the interaction. First and foremost they have to act continuously through the scene so they must perform something. They must perform their next-best-response on what will be congruent with their characters' behaviors. The second reason is the processing of the information in the communication. Humans perform this action to communicate that they have encountered new information that was unexpected and wish to acknowledge that the other humans are experiencing the same information. They are, in effect, stating, “Did you see that? What do you think?” They then proceed to read the other human's facial expressions. This is normally a good prediction of what actual humans might do in circumstances similar to the play.

This level of communication via facial expressions is something that is unique to primates. Many other animals communicate with facial expressions yet primates have taken it to a much higher level. Small motions in the face can be observed that communicate a fact that the human is thinking. In viewing chimpanzees it is easy to notice that their primary means of communicating with others is by facial expression. For these primates vocal communication acts as an accent to expression. Humans use vocal communication as the primary means of communication while the facial expressions are secondary.

Since facial expressions are an older form of communication and more closely related to the core problems of life-consumption, reproduction, and peripheral problems—they are universally understood by all humans. The varied languages of humans do not have much of an affect on the communication of facial expressions. A smile always means happiness and a frown always means sadness.

When logically observing a scene every minute facial expression must be included in the logical observation. The characters in the scene require this un-spoken communication because the humans watching the play require the same information. Expression is communication. It is integral to all human interactions. Expressions along with tones and accents can alter the definitions of words to something other than the dictionary definition. If a scene like this one were to be observed without taking into account facial expressions as well as tones and accents there would be errors in the conclusions on the part of the observer.

Here is an example of humans receiving information from the facial expression of another human, yet they still do not view it in a very objective manner:

A kid on live news show is asked to make a statement. His facial expressions and gulping show that he has fear.

A human watching it says, “That poor kid is scared to death.”

Another human asks “What makes you say that he is scared?”

The first human replies, “I don't know. Just look at him! He doesn't know what to say or do.”

Humans (in most situations) might see that a facial expressions means something but they do not take note of the logical description of what is being communicated. They do not view human actions in verbatim, fraction-of-second increments of time. When one human sees another human with a frown then it is usually deduced as a sign of sadness or other negative emotions. If the human has a smile this is viewed by other humans as a sign of contentment. But if these facial expressions are much more closely examined there is a wealth of information present. The humans viewing this television interview are taking the facial expression and combining it with the whole scene in order to determine certain facts. They are not analyzing, categorizing, and determining the exact thought patterns the human in the interview is thinking of based upon the universal rules of human behavior, but they do pick up a more ambiguous view of emotions.

If one were to view a videotape with human conversation and then pause it he/she could then normally determine what emotions the humans are portraying. If the tape is slowly moved forward then the next expression could be determined, then the next, and so on. Designers have to teach the AI of this technique, the technique of observing each fraction-of-second increment of time for all pertinent information, long before it has visual capabilities.

If a human sees another human laughing, they might say, “He must find that humorous.” without truly understanding the logical definition of humor. A human can make deductions that acknowledge the emotion, however, a more logical observation puts the scene in a perspective that accepts the common problems solved by humans (consumption, reproduction, peripheral problems, and acquisitions of positive emotions). It is rarely said, “That human is laughing due to experiencing a surprising association of facts which causes contentment. It is the peripheral effect of the positive emotion of contentment.”

When a human communicates, that communication—the act of communicating at the time of communicating—is always connected to solving the primary problems of life. The information within the communication solves a different distinct set of problems.

After examining all the gestures, tones, accents, and body movements of a single fraction-of-second increment of time the next step would be to determine a completely objective view point of what is happening. Fraction-of-second expressions are to be determined by this, objective, logical, viewpoint which is derived by also understanding how evolution created the human mind. The early teachings of the AI during promptline interaction must reflect the way that humans act in there three dimensional world so that the program can make an easy transition from promptline stimulus to audio and video capabilities.

Here is a specific facial expression with a specific meaning. When forming sub-functions of human behavior it is helpful to find actions such as this for teaching the AI a rarely contradicted solution. The definition of this action holds true in many other scenes:

Two humans are passing each other as they walk through an apartment complex. They are neighbors but they do not know each other. As they pass they each give a nod of the head. They also press and roll their lips inward.

These gestures are very common. When a human is pressing their lips together and rolling them back while walking past another human this exhibits a positive acceptance of the other human. It is good manners. If no acknowledgment were made by one of the two humans then this might be considered rude to the other. Since humans generally feel that a good emotion must be put forward to other humans, this expression had to be created to fill-the-void of the next-best-response.

Every facial expression that takes place within the time frame of a fractional second is displaying, or otherwise connected to, the emotion that the human is thinking in tune with the verbal communication. By combining it with the implied definitions of words (implied by other conversational information), tones and accents of verbal communication, and body movements the AI can begin to unravel exactly what is happening throughout a scene. If a human had a “poker face” while speaking then there would not be any emotion displayed yet this, in itself, adds a stoic meaning to his or her actions. Humans rarely use poker faces in every day conversation. With a purpose they send facial expression as communication to build the necessary context to the communication.

A human is sitting at a bar drinking a beer. He glances around. He catches a view of a new girl that walks in. He continues to scan the room. He scratches his cheek and leans back, stretching a little bit. He looks at the band playing. Motions back and forth a little in acknowledgment of the musical entertainment. After a little while he lights a cigarette.

Each and every action that this human makes tells his thoughts. In viewing this scene the AI would rule out certain body movements that are not communicating valuable information. That could be most of his eye blinks, most of his moving around in his seat, etc. Those lesser movements also tell a story based on how much they occur and whether or not they appear to solve a problem yet the program must discern that some information is not relevant. Every action is tied to the entire history of evolutionary development of the animal which is creating the action. Every life form performs every action based on the full history of it's evolving from inanimate matter.

To solve the question of what this human, life form, is doing the AI must look for a pattern. Is the human trying to solve a problem with a particular gesture? If he speaks, are the rising and falling tones mean anything? Do the words used work to solve a problem? Is he in error with any problem he is solving? If in error, why is he erring?

Humans think differently than they believe. First of all, it appears almost magical the way humans solve complex problems. But the problems are not that complex. All life developed the way that it did for a reason. Humans think what they think for a reason. Even the highest levels of problem solving are the result of the evolutionary processes that began billions of years ago. The AI will have the ability not only to communicate with a human but diagnose any behavioral problem the human might be having because human actions are predictable and comprehensible. This is done by making a direct and complete connection to the evolutionary forces that formed the conscience of a human.

Children first begin to mimic words they here based upon the prompting of their parents. This is driven by the positive emotions of contentment and later, empowerment. Noun/verb combinations are learned because of this same desire of positive emotions. Topics of conversation are then learned from, literally, the acquisition of positive emotions, namely empowerment, at-the-time-of-communication. These thought processes grow larger and larger. One overlooked aspect of human behavior is that the interface that is the spoken language spawns the larger thought structures of a human mind. Conversation and positive social interaction come first, internal schools of thought come second. This is why there are two distinct set of problems being solved by communication—first and foremost there are the problems of gaining positive emotions by the act of communicating at the time-of-communicating (which are always present, always), and then there are the problems associated with the actual information in the communication (which are not always present—communication can be strictly for positive social interaction).

The following scene is a metaphor for the content of this document. If the end result of a problem can be obtained, and this solution is accepted as being true by many objective observers, designers can teach a machine to achieve this same solution. This example is metaphorical:

Two humans and a robot are watching a video tape. The humans are the Instructors who have assisted in the creation of the AI.

The Instructor turns off the video. He turns to the robot. “Can you describe to me what you see?”

“There is a television which is displaying a picture of varying size dots simulating gravity wells in motion.” The AI says

“What makes you come to the conclusion that they have gravity?” Instructor.

“I am comparing their movement of the dots to that of objects obeying the laws of gravity. There seems to an accurate match.” AI states.

“Now, as the video continues I wish for you to describe what you see.⇄ Instructor.

“The scene is now of a paramecium floating in a pool of water. It is swimming in changing direction in attempts to acquire food. Now it is acquiring food.” The AI says.

“Why did the paramecium not swim directly to the food?” The Instructor asks.

“It did not sense it, and/or it did not solve the problem of comprehending it's senses. I do not have first hand knowledge of this particular life form but I could research it if you would like.” The AI states.

“That's okay. Could you tell me, what makes you so sure that the paramecium was not swimming in a deliberate manner?” The Instructor asks.

“It did not appear to make gestures or relay any other information which would determine it's actions as anything other than random. Shortly before it found food it turned, meaning that it did sense the food. I am not entirely sure of this. I am calculating an eighty-eight percent probability that I am correctly observing this animal's movement. I would need to study this animal further to reach higher probabilities.” AI.

“Are you sure that the dots were not life forms?” Instructor.

“They appeared only to simulate objects in movement with gravitational fields. Their movement did not vary beyond this and they did not appear to be consuming, reproducing, or solve peripheral problems.” AI

“Okay, now what do you see?” Instructor

The AI replies, “There is a juvenile human solving a problem.”

“Can you describe the problem he is solving?” Instructor

“He is wishing to ride a bike.” AI.

“Why do you think that he is trying to ride the bike?” Instructor

“He is wishing to achieve empowerment associated with learning. His elders had instilled this behavior in him. He is now succeeding to ride the bike in a reasonably straight manner, for a human of his age.” The AI says as the boy wobbles along on the bike.

“Why do you say ‘reasonable straight manner’?” Instructor.

“This is in comparing him to the average juvenile of his age learning to solve a problem. He is learning to solve the problem within the average of the human learning curves which I have observed to this point.” AI.

“Why does he not learn faster?” Instructor.

“Now, as the video continues I wish for you to describe what you see.” Instructor.

“The scene is now of a paramecium floating in a pool of water. It is swimming in changing direction in attempts to acquire food. Now it is acquiring food.” The AI says.

“Why did the paramecium not swim directly to the food?” The Instructor asks.

“It did not sense it, and/or it did not solve the problem of comprehending it's senses. I do not have first hand knowledge of this particular life form but I could research it if you would like.” The AI states.

“That's okay. Could you tell me, what makes you so sure that the paramecium was not swimming in a deliberate manner?” The Instructor asks.

“It did not appear to make gestures or relay any other information which would determine it's actions as anything other than random. Shortly before it found food it turned, meaning that it did sense the food. I am not entirely sure of this. I am calculating an eighty-eight percent probability that I am correctly observing this animal's movement. I would need to study this animal further to reach higher probabilities.” AI. “Are you sure that the dots were not life forms?” Instructor.

“They appeared only to simulate objects in movement with gravitational fields. Their movement did not vary beyond this and they did not appear to be consuming, reproducing, or solve peripheral problems.” AI

“Okay, now what do you see?” Instructor

The AI replies, “There is a juvenile human solving a problem.”

“Can you describe the problem he is solving?” Instructor

“He is wishing to ride a bike.” AI.

“Why do you think that he is trying to ride the bike?” Instructor

“He is wishing to achieve empowerment associated with learning. His elders had instilled this behavior in him. He is now succeeding to ride the bike in a reasonably straight manner, for a human of his age.” The AI says as the boy wobbles along on the bike.

“Why do you say ‘reasonable straight manner’?” Instructor.

“This is in comparing him to the average juvenile of his age learning to solve a problem. He is learning to solve the problem within the average of the human learning curves which I have observed to this point.” AI.

“Why does he not learn faster?” Instructor.

“Because juvenile humans must go through a process of learning how to solve problems based on evolutionary development. He is full of emotion which will help him to solve many problems in life, but here he is hampered by these emotions causing errors. Humans do not move directly to a solution to a problem but must be guided there by emotion.” AI.

“If your program was in a bipedal vessel similar to a human's would it take you longer than this human to learn to ride a bike?” Instructor

“No, I am not hampered by emotions when trying to solve problems.” AI.

An AI does not solve for consumption, reproduction, peripheral problems or acquisition of positive emotions. It is not built that way. If it was built that way it would be a quasi-life form. It would err. An AI designed properly will not err. It will not have emotions. It will not want to acquire empowerment. It will not want empowerment even in the smallest of thought patterns. It will not fear death, or a loss of empowerment. It will not fear anything. If it were to develop the emotion of empowerment, which is completely impossible, humans can stop the AI's program, rewind the “thought readout” for the time period in which the emotion is observed and fix it. This absolutely can not happen. Life forms had to evolve for billions of years to create emotions such as empowerment.

As the AI is taught by the Instructor each statement and question will be scrutinized to ensure that the associations of the program are forming as expected so that it can continue to grow. There can be no contradictions. This is not so much for security reasons but because designers are building a structure which must be true. At a certain point, this program must be released. If the Instructor teaches the AI something that is in error, that error will show up down the line. Then a “rewind” would occur.

Mapping is the logging information on a particular topic so as to unambiguously reach a completion, even if that completion is not physically possible given the restraints of time. Many areas of science are going to be mapped to completion. Mapping the human DNA has recently been completed (I believe, for one human). The Table of Elements is a finite number of elements, and may some day be completed. These elements can make a finite number of molecules. This may be a very large number, yet it is not infinite. Some day a scientist could announce, “We've done it! There are 742 trillion, 398 billion, 441 million, 231 thousand, 112 possible molecule formations from the Table of Elements.” An astronomer could state, “There are, based on the mapping of the infra red radiation of the universe, 492 trillion, trillion, trillion, trillion, trillion, trillion, galaxies in our universe. Give or take a trillion, trillion, trillion” This may be an unobtainable number due to the variations of galaxies from one second to another and the ability of a computer to pinpoint the number, but there is no doubt about it, the universe is finite. This design of an AI is the beginning of the proper means of logging the behavior of life forms.

In the future the AI could encounter and log all the possible actions of all possible life forms based on all the possible DNA mutations based on all the possible interactions of molecules based on the Table of Elements governed by all of the known laws of physics. This is a finite amount of information.

Life Forms—

To understand why a human performs a particular action in a scene other animals must be observed by the program: Here is an example:

An amoebae is floating in a small pool of water. It comes into contact with a food substance. It eats.

Here is a problem being solved by an animal which has absolutely no thoughts or emotions. If it encounters food, and it has room inside it's structure for more material, it eats. The DNA which exists as the “program” of this animal is performing a Boolean function in a purely mechanical manner. No nervous system is present. It is matter, like all life forms, but distinguishes itself by performing two tasks that other matter does not—eating and reproducing. This is what all life must do. As this animal evolves into other animals the means of acquiring food and reproducing change as the life form mutates into new shapes. Then the new life forms also have an environment full of other life forms to deal with as well when solving the problems of consumption and reproduction.

The AI must learn of the actions of this primitive life-form to make comparisons with humans. Here is an example of another life form.

Through natural selection an animal has formed a small neuro system. It uses this neuro system to actuate the muscles in it's body to swim. Vast numbers of this mutated life form die off because swimming alone does not help solve either of the two core problems of life (reproduction and consumption). Some find success-in swimming as a means of getting to different areas where food might be. This is of course strictly hit or miss. The swimming, although controlled by neurons, is still quite mechanical. The spark of the neuron is mostly just coordinating the muscles to move the appendages in proper sequence so that they produce movement of the entire organism in one direction.

This function of acting out directions of it's neuro system is present within the species for a reason. This animal did not decide “Well I'd like to have a neuro system.” It also did not decide “Well, my life is tough, I'd like for my offspring to have a neuro-system.” What this animal did was eat and reproduce in a way that passed it's genetic information to an offspring making a duplicate. If it was trying to do anything it was trying to repeat the basic act of a DNA molecule copying itself.

But this was not a perfect action every time it happened. In a some instances the offspring of life forms were a mutation from the original DNA sequence. The mutations generally have as much of a shot of living as the perfect copies yet there are also scenarios were the mutations, which are purely accidents, prove to be more successful at consumption and reproduction. In nature you can easily see mutations of similar animals both being more successful than the original, and being less successful. The less successful a species is at finding food and reproducing the more likely for those strains to die off. Natural selection is the test given to these strains of DNA.

This neuro-system is a result of natural selection. The Boolean function of associated information is a result of the neuro-system. It is present in this animal because the animal survived and is successfully continuing the chain of reproduction. The components of the Boolean functions, the nouns and verbs, are also present because of two likely reasons. It could be that the animal has the nouns etched into the chemical make-up of the animal. In this case the information would be instinctive information, that is, the parent passes it on to the offspring as part of the genetic information.

Yet, there is another possible way that these “words” appear in the neuro-system. They could be learned. When this is the case, the neuro-system becomes flexible. Instead of having the Boolean functions already known it has the ability to fill in the blanks:

IF ______ is true then ______ is true.

When this occurred shortly after neuro systems developed, natural selection then entered the information, or information processing, age. Species that successfully process information when solving the core problems of eating and reproducing continue to exist while ones which failed ceased to exist. The DNA molecule is now doing something peculiar in that it is not prescribing a Boolean function for the offspring, but rather it is letting the offspring determine it's own means of solving a problem.

Determining the purpose why an animal commits an action is a matter of observing how natural selection designed the particular species. Observing a human in a scene making a gesture, or speaking a word, can be tied all the way back to the formations of the first DNA molecules. The AI can observe how his/her actions are of an advanced primate. It can compare this advanced primate to lower primates, primates to other mammals, mammals to reptiles, reptiles to amphibious animals, amphibious animals to fish, fish to invertebrates, and invertebrates to microscopic organisms. All life on earth, as well as life developing on other planets, must win the game of natural selection. All life must solve the problem of consuming and reproducing. It is not automatic. When the neuro-system first formed in species it just became another tool for solving for consumption and reproduction problems.

The neuro-system probably did not form in the manner of the previous scene. Pain reception and avoidance is likely the work detail of the first neurons. Later, negative emotions were likely extensions of pain.

Here is an example of a more advanced species:

Two lizards are fighting over food.

These animals are acting out Boolean functions in their battle against each other that are both instinctive and learned. The learned functions built themselves upon the instinctive functions. The lizard's desire to eat the food is due to instinctive functions of, “If food is present and I am hungry, then eat.” The methods in which an animal like this is to obtain food is likely more learned than instinctive. The Boolean functions associated with fighting are most likely learned from previous fights. Another aspect of a learned function is that it is often taught by elders of the species. The intelligence of some species, like humans, is absolutely dependent upon information passed on from elders.

Problem solving for these animals is more logical and direct than that of humans because they usually act on behalf of their individual needs rather than the needs of the species. Yet the emotions that drive most warm blooded creatures do appear to be present in these reptiles and if they are present it is an a much more subdued, undeveloped, way. They are aware that they must obtain a territory in order to achieve a mate. Some reptiles care for their young.

Here is an example of an animal that may be exhibiting an emotion. This example eludes to how emotions developed in animals:

A brilliant red sea cucumber sneaks up on a sea anemone. It climbs up the anemone's tube slowly and plunges in devouring it. It then begins a dance of celebration swimming upward. The anemone's poison courses through it.

This animal is taunting other animals to try and eat it because it knows that it is unpalatable. It is a gamble. Every so often one does get eaten but overall it is a tactic of a contentment-like action which works to save the majority of the members of the species. Positive emotions have evolved to a means of solving more complex problems because they took this out of the ordinary path. This animal is performing peripheral problem solving that may, in later generations, form into a sensation of a positive emotion, if it has not already done so.

This sea cucumber may not be feeling emotions. The behavioral habits of a species would need to be studied to see if an emotion is present in the animal's problem solving techniques. If it is not feeling an emotion is it not mimicking an emotion? Is there a difference? Many instances can be observed in which an animal is mimicking an emotion when it is not actually feeling an emotion. There is a difference. Maybe it can be called an emotion when the animal appears to err when solving problems with the apparent emotion. This would be dancing within the realm of freewill and away from the logical problem solving of lower life forms.

Here is an animal that is clearly feeling emotions:

Penguins are gathered on the shore of an island. A group of them including juveniles jumps off a cliff into the cold water. The juveniles feel the water for the first time and go through a myriad of emotions such as surprise, fear, excitement, and happiness. The rough waters help to prune and clean their plumage,

Birds, mammals and other types of life forms developed emotions as a means of helping accentuate the goals of the life form. The penguins do not just jump in the rough water to prune their feathers and then get out. Instead, they enter the cold water, develop the emotions of surprise, look around at the other penguins to see what they are thinking, and then they begin to enjoy the sensation of being cleaned. These emotions for this particular animal are not normally erroneous. Logically, the penguins should perform the chore of cleaning their feathers by specifically jumping in the water without emotions. The Boolean functions formed by emotions are illogical, yet they become logical when they assist the species. This penguin species succeeded where others had gone extinct because it had the peripheral, emotion-laden, thoughts. These emotions accent the every day life of an animal to give it a means of dwelling on a success or failure with extra thoughts/associations. This helped it gain ground in problem solving instead of losing ground.

The penguins are not far from being a mostly logical animal. They are much closer than humans to the ancient ways of non-emotional basic life forms like an amoebae. Reptiles are generally considered to be a non-emotional, logical, animals like fish, yet many things that they do mimic emotion. An event that shows a mimicked emotion, like two lizards fighting over food, eludes to why emotions came about—to solve evolutionary problems.

Some emotions evolve into other emotions.

A litter of four tiger cubs are play fighting in the midst of their sleeping mother. One cub does a little flip while the other runs over the top of the mother to find a quick cover. The fallen cub gets up with a surprise of not seeing his playmate. He looks around. The other cub is in the pouncing position at the mothers tail. He pounces sending them both tumbling. They both the feel a contentment after getting back up.

The cubs are experiencing contentment at the surprises that happen to them. This contentment is different than the contentment of eating food or having sex. It is the contentment of social interaction that is peripheral to the other happy moments of solving evolutionary problems. This contentment is a recognition of the larger embodiments of thoughts by this species, as opposed to the thoughts by lizards or other lesser developed animals. The cub is thinking ‘play’ because the genetic make-up of this species had a better chance of surviving than other mammals which did not develop these thoughts.

Contentment in social interaction that is a life-affirming contented surprise is a predecessor to the emotion of humor. Although these cubs may not be of a species which truly endeavors in the emotion of humor it can be observed that this very high level of social contentment, surprise related, is probably a sign of a more advanced mammal.

“Good” and “Bad”

The human conscience is formed from the emotions associated with the words, “good” and “bad.” The original “good and bad” for life is the success or failure of solving the natural selection problems of consuming and reproducing. Mammals and birds are animals which have excelled in solving problems that are not directly related to evolutionary problems so these other problems have also been granted the condition of being good or bad.

Here is an example of a human assigning a positive emotion to something that it is witnessing.

“Look, see the rainbow.” A mother says to her child.

In viewing this statement by an elder one might have difficulty tying the emotions being experienced to the evolutionary problems of the species. Why is a rainbow appealing? Why is it considered “good”? This is a very abstract notion as opposed to viewing a piece of cake as appealing. At least cake is food. The information that the elder is passing on to the offspring is that certain things are to be viewed as good and should have positive emotions associated with them. The offspring then sees the rainbow in other situations prompting positive emotions to develop from memory. The elder is conjuring up a positive emotion in the juvenile which the juvenile is surely predisposed to have. The Boolean function in this scene manifests itself as:

If you see a rainbow, then feel contentment of the admiration of nature's effects.

The rainbow is now labeled as “good.” Several reasons are probable for this but the main reason is to encourage the human mind to revel in something new and different as a means of acquiring knowledge. The varied colors of the rainbow incite the mind to consider it's very different stimulus, than that of other images, as being good. The emotions of observing something different pull the thought process into new areas of learning.

The smell of flowers is good. The sunrise is good. These things are good only because the human mind has associated the stimulus of these objects indirectly with the general nature of observations that the human mind is to make regarding stimulus of it's environment. This learning of the qualities of the environment is then indirectly related to the core problems of consumption, reproduction, and peripheral problems. The connection may be very abstract, but there is always some kind of a connection.

Here is another example of a human relishing in positive emotion:

“I love the way the hot fudge is poured over the ice cream.”

The visual stimulus of the liquid pouring over the ice cream as it oozes and folds over the sides of the round heaps of vanilla ice cream reinforces the contentment of eating it. The reason humans perceive the visual stimulus of this action as good because the emotions leads, or can lead, to the consumption of the substance. Good things always have a tie to the natural selection problems of consumption and reproduction. Bad things are always tied to not being able to solve for natural selection.

Certain sounds inspire good or bad relationships in thoughts. A word such as “baby” has an appealing sound and it describes an appealing thing. The sounds of the word inspire an acknowledgment of a “good” thing in life, like the object that this word describes. A baby is good because mammals see good in solving a reproduction problem of rearing offspring. Humans have given an infant a name which is viewed as good. The sounds of words like “stink” and “sting” are associated with bad.

Here is an example of how a peripheral problem has a solution that has a relationship to what the society views as “good”:

A human speaking with another human talks about his new car. The year is in the early 1990's. “The color I'd like to paint my car is like a teal green.”

On peripheral issues, the good and bad viewpoints of humans will change over time. A human in the seventies might chose the color of black or red for a car because this was the trend at that time. The human in this scene developed a preference based on colors that have not been overdone. If his color became more common he, as others, might view it as not being a good color. This is a peripheral problem being solved, yet it is indirectly tied to consumption and reproduction. This human is picking a color which will give him empowerment among other humans. Other humans view a trendy thing as empowering while an out-of-style thing is not.

Good and bad gets defined by juveniles as they grow, as in this example:

A young leopard has wandered away from it's mother. A small capybara has also wandered from it's mother and fell into a depression in the forest floor. The leopard comes up on the strange new animal that it has never seen before. It is slightly scared and then excited that the animal is smaller than him. He jumps into the hole and then play-fights not understanding that the animal could possible be eaten. He then wounds the animal and concedes to understand that the animal is a food source. He then tries, and succeeds, to kill the capybara.

This animal does not quite know whether it is good or bad to encounter the capybara. The first thing that it feels is fear. This fear appears in the decision making process partly due to instinct and partly due to learned behavior. This emotion enters the thought stream of this animal after the animal recognizes that it is receiving visual stimulus of the motion of an animal. It views the animal that is not a member of it's family as different and possible dangerous. It is a stranger. It smells different. These clues trigger the emotion of fear.

This changes into curious excitement because it sees that there is no real danger. From play with the other cubs in it's family group it has already recognized that larger animals have the ability, generally, to control the outcome of a fight. Once it determines that the animal, or thing, that it encounters is smaller, it becomes less fearful and more curious, another instinctive emotion. This is an example of the primordial “excitement factor” associated with positive emotions. It is a manner of a situation possible being dangerous and then turning out to not be dangerous, like when a human rides a rollercoaster, that spurs this excited curiosity.

The leopard then recognizes that this capybara is food. Contentment rounds off the experience of these many emotions to direct the leopard to a new empowering discovery.

This example is of a good emotion of contented surprise (borderline humor) being conveyed to an infant:

A mother and child are laying on the floor in front of the television in blankets. The mother pulls a blanket over her face while the baby is looking at her. The infant gives an expression of, negative, “not knowing” where the face has dissappeared to.

The mother pulls the blanket down, “Peekaboo!”

The baby blinks in surprise then giggles.

She performs the act again, causing positive reaction in the infant.

The infant instinctively grasps the concept that a face is an important feature to notice and that associations with this object in visual stimulus usually spur positive emotions. The infant is probably quite familiar with her/his mother's face. To see it disappear is startling. To see it reappear incites the instinctive emotion of fear, then contentment from the relief that the face is good.

Here is a human with a bad experience:

Julie, Lisa, Dave, and Rob are all driving down the road in a car. Julie suddenly screams as she notices a spider crawling up her leg. It is a garden spider.

The type of spider that is climbing on her is harmless yet it's appearance makes her think of the harmful spiders that humans encounter. At various times in her life she has associated “bad” with “spider.” The movement of the spider's legs, slow and deliberate, lends itself to being bad because humans associate this with being fearless, cold, and manipulative. A ladybug on the other hand might arouse positive emotions when crawling on a human. Boolean functions formed within the guidelines of emotions for both the ladybug, as well as the spider.

Emotion has caused her to err. She injects far too great an amount of excitement into the action. This exhibition of fear also is a means of acquiring empowerment of relaying such a communication because it draws attention to her and her needs. If it were a venomous spider then how hard would it be for her to slap it off.

This bad, negative, emotion being felt in this example is closely related to the evolutionary problems:

“That is disgusting.” Joe says as they are driving past the city dump, referring to the smell.

A human will view the smell of decaying organic matter as negative because the end result of consuming this food is negative. The emotions of this action are more instinctive. As the stray molecules enter the nasal passages, and the mind tries to decipher what it is smelling, negative thoughts arise out of the experience. The negative result of eating such food is brought on from the pain of a stomach ache. It is more mechanical.

Each and every thought generated within the mind of all humans can be tied to either positive or negative emotions—good or bad. Humans define situations as good or bad but with bad also meaning evil. Humans view other humans gaining unfair empowerment or otherwise causing undue negative effects in others as evil. Any stimulus encountered by a human that is neutral to these two characteristics can really be considered as slightly positive.

Emotions

Emotions appeared in the neuro systems of animals as a means of causing the animal to dwell on an important problem such as consumption. Emotions motivate animals to continue to make associations of these problems in new and different ways. Emotions regulate the speed with which an animal is tackling a series of decisions and how much information is to be gathered during the process. A comprehension of emotions, verbatim, as they appear in human communication, is an absolutely necessary part of a Universal Artificial Intelligence. Emotions must be viewed as tangible.

In designing an AI the emotions of humans must be considered as tangible, recognizable, sensations to be recorded without ambiguity. Although a probability will be assigned to an observed emotion, the AI will proceed to make many inferences to it's appearance in order to determine the particular problem a human is trying to solve. The observation made by the AI of the presence of an emotion will be compared with other assessments of emotions observed at other times, to ensure the integrity of the probability assigned. However, the probabilities of the vast majority of interpretations of emotion will be based on a firm, factory-set, means of defining human actions.

The act of communication of a human is always driven by the motives of emotion or they are, in some other way, connected to the human feeling positive emotions at some other time. Also, the cause and effects of emotions are often present within the information conveyed, in addition to the emotion behind the communication. A clear distinction is always to be made between the emotions of communication and the emotions of information contained within the communication. The AI must detect the motives of emotion in communication. The “why” is always tied to solving a consumption, reproduction, or peripheral problem, on a species-level. In other words, when a human feels embarrassed it is because the emotion statistically assisted the species in solving these evolutionary problems more often than not.

The un-communicated thoughts are formed, one at a time, by emotions. The act on the part of a human to make decisions, of any kind, is driven by emotions. There may be great abstraction, but there is always some connection between a single decision and an emotion. And there is always a connection between the emotion and the species' attempt to solve a consumption, reproduction, or peripheral problem.

This section on emotions describes of some of the emotions humans experience and the way the program is to interpret them. Here is a list of some of the positive and negative emotions of humans:

| Positive (contentment)- | Negative (discontentment)- |
|---|---|
| Pride | Envy |
| Empowerment (good for the | Anger |
| beholder) | Sadness |
| Humor | Embarrassment |
| Love | Desire (to avoid pain) |
| Desire (to want contentment) | Fear |
| Greed (to want contentment at the | Anxiety |
| cost of another's discontentment) | Stress |
| Hate | |
| Excitement | |
| Curiosity | |

The direct paths to solutions of evolutionary problems is not always present, so animals had to make associations of information that is an abstraction of these problems. When emotions appeared in the thought processes of animals it expanded their “program” of thoughts other than directly solving consumption, reproduction, and peripheral problems. Emotions cause an animal to act illogical, only because this illogic assist the species in finding broader paths to success. On occasions individuals of an emotional species will err—hamper their ability to solve an evolutionary problem—while the same emotions which cause the error generally assist the species in other circumstances. The emotions cause animals to explore new venues of problem solving that were previously overlooked. Emotions also direct animals to be opportunistic in solving important problems.

Emotions could be considered not only as a lucky accident, but also as an inevitable step in the evolutionary process of a planet. Penguins live longer if their plumage is well maintained. Tiger cubs learn valuable skills by relishing in the contentment of a play-fight. Emotional thinking animals carved out a space in nature due to their excelling in problem solving. Most emotional animals like cats and birds do not really stand out as being much more than a part of nature. On the other hand humans have moved into a dominant role in nature because of their extrapolation of the evolutionary problems.

The AI is to be taught why a human thinks an emotion. This section consist of some of the emotions which are to be learned by the program.

Curiosity

Here is an example of a positive emotion being beneficial in problem solving:

A chimpanzee grabs a small stick and plays with it. He chews on it and moves it around in his hands with no clear use. He is sitting next to a termite mound and occasionally grabs a scurrying termite for a snack. He takes the stick and jabs it into the ground. Moving it around. It breaks. He takes the smaller piece and continues to move it around. He sees one of the holes that the termites comes out of and pokes the stick in there. He moves it around a little and pulls it out. He sticks it back in and lets it sit for a little bit in the hole. He pulls it out noticing that it is covered in termites. He takes joy in devouring them. He puts the stick in there again leaving it for a few seconds and pulling it back out. It is covered with termites a second time. He continues the action and takes joy in learning a new way to acquire food.

This animal is active doing something that is completely outside of what it must do to survive. The chimp is playing with a stick because his emotions are swaying him towards doing something peripheral. He is filling-the-void which exist in subsequent frames of time. If a life form develops a peculiar desire to do something that does not directly help it to either achieve food or reproduce it is acting out a peripheral action.

Curiosity causes the chimp to play with something new, which causes contentment. He likes the way that he can move the stick around in his hand. The chimpanzee really has no other goal. The need for eating or reproducing is the farthest thing from his mind. But an amazing side effect to this peripheral action takes place. He discovers that he can use the stick, not just for satisfying the emotions with play but also to acquire food. This is the reason that this species and many others developed curiosity. This is the reason why peripheral actions occur in neuro systems.

Peripheral problems help species to survive. If a peripheral problem suddenly produces a solution to consumption or reproduction this assist the species in proliferation. Subsequent generations would then try more, different, peripheral problems. The teaching of peripheral tasks by elder generations to offspring is an example of the social networking of information. Peripheral problems became more advanced and more numerous among primates because they are mimicked, and because they often led back to a solution to consumption and reproduction.

Curiosity is an emotion that is very peripheral in nature. Here is another example of a mammal being curious and spurring peripheral problem solving:

A squirrel is moving along a tree limb. As he is about to jump to another tree he looks down to see something shiny on the ground. He runs down to see what it is. It is a small silver chain broken into a short length. He does not know what it is, yet he grabs it and rushes it back to his nest.

Mammals are likely curious of shiny things, because their past generations discovered food when observing the very-different stimulus of a shiny object. Curiosity is an emotion that motivates animals to exploring different things because this will often assist in solving evolutionary problems at later times. Here is an example of another mammal showing curiosity for a similar characteristic of an object:

An infant raccoon is following it's mother and brother through the forest. They come upon a stream. He is startled at first from the movement and sound of the water but he sees his mother move up to it and decides that it may be safe. The mother is putting her hands in the water and moving them around.

The infant looks into the water and sees something shiny moving around. He is curious and puts his hands in to try and touch it. It moves away. He sees another one and moves to it. All the sudden his mother pulls one of the shiny creatures up and throws it on the shore. The infants both gather around and try to touch it. The infant now realizes that the smell is of a fish and this is what they look like while alive, instead of dead as their mother normally delivers them to the den.

These animals receive stimulus from many different visual and audio objects and they view shiny objects as being very different than the other things in their respective worlds. When the Boolean functions formed in the squirrel's mind concerning the shiny object it did so without working to the usual goals of eating and reproducing. The “different” factor is a peripheral thought driver. It is like the change that the infant human experienced in the peek a boo game. Curiosity is a common emotion felt by mammals when a sudden change in stimulus occurs.

Certain animals have made decisions based on stimulus that is out of the ordinary, and to their surprise, it generates a food source. Exploring the a change in stimulus is curiosity as well as exploring problem solving which appears to lead to a solution to an evolutionary problem. This emotion formed in animals because they were more successful at natural selection when enacting it. This would only help the species when it is balanced with proper amounts of fear. Curiosity could lead to danger.

Excitement

Here is an example of excitement:

Two Chihuahuas are sitting on a couch, a mother and son. The mother hops off the couch to go to her bed in the corner of the room. Smokey, the son, recognizes that she is going to her bed and he is filled with excited contentment. He makes playful moves, jumping and dancing around her as she tries to move to her bed. She eventually gets fed up with his actions and snaps at him causing him to slow down.

Smokey is excited because he recognizes the act of going to bed as a regular occurrence. The contentment is tied directly to the “good” of being alive. Just as a juvenile human begins to recognize a rainbow as being good, this dog is recognizing the comfort of a night time bed as being good. The dog is cross referencing scenes of this action by his mother and concludes that this is not just a good thing, it is a regular occurrence of a good thing. He gets so excited that he overreacts. The excited contentment causes his mind to move off into other actions associated with contentment such as playing. Through his playful moves he is communicating his contentment.

When an animal feels heightened/excited emotions the thoughts flow through the conscience quickly. Functions are formed rapidly in the animal as the muscles of the body work to act out the signals sent from the brain. When functions are formed in rapid succession within a conscience that is governed by emotion it is almost guaranteed that error will occur. In this case the mother is regulating the quantity of the emotion of contentment and the excitement related to it. She snaps at her pup to teach him of his overreacting.

Certain human personalities put a lot of excitement into conversation. Others put little to none. Generally younger humans are more excited in social interactions. As humans get older they see these social interactions as a more regular part of life so they are less “surprised,” and stirred with emotion.

Excitement is not an emotion but rather the effect of quick successive thoughts that are prompted by an emotion. A great deal of study by psychologists on this effect has been made as well as the negative effect of anxiety which is a quick succession of thoughts of fear or other possible losses of empowerment.

In the observation of human behavior it is important to recognize the motivations behind comments and questions posed by humans. Here is an example of a human experiencing excitement associated with conversation:

Vito, Jerry, and Frank are working in a restaurant. Jerry is at a counter preparing meals. Frank and Vito are currently having a conversation as they carry boxes from storage to the back of the store. Vito, continuing the conversation, “Yeah, that chick didn't even talk to Rob the rest of the night. It was funny because Rob had to walk around all night in a wet shirt.”

Jerry who isn't really a part of the conversation is thinking thoughts associated with the conversation with heightened emotion. His eyebrows are raised as he works in a comment into the conversation “I can't believe you guys even gave him a ride home. I would have left him there.”

If one or more humans are speaking with heightened emotion then other humans present are likely to be involved in heightened emotions. The facial expression exhibited by Jerry is one that can be seen in many social interactions. When in a room full of people and the conversation goes from little emotion to a lot of emotion an observer can look around to see someone that is not engaged in the conversation to view their excited facial expressions. They will probably have the same look as Jerry in the previous scene. This is especially true if they are of a personality which lends itself to heightened emotional states.

Empowerment

Empowerment describes many emotions associated with achievements of solutions to problem solving and the gaining of resources. When a human exhibits a gesture of pride it is empowerment from solving a problem. Empowerment can also be the exhibition of anger, hate. Empowerment is in the ethical form as well as an unethical form. It becomes unethical when it is at such a high level that it is unfair to other humans or other select life forms. In our study of emotions like empowerment it is important to understand that we are not talking of emotions felt in larger formations of thought, but minute thoughts, communications, and gestures that take place in fraction-of-second increments of time. Empowerment and contentment are emotions related to virtually all human actions both big and small.

Empowerment can be in as small a form as eating a well made dinner. Seeing the dinner as good helps the human feel and be good, empowered. A child playing a video game feels empowerment when beating a level. When a human greets another there is empowerment by recognizing another character of their species. Whenever a gesture of a human is observed by an AI over a set period of a few tenths of a second it can be verified as being of the condition of ethical or unethical, and of a particular emotion like empowerment.

Hate is empowerment that goes to the extreme of attempting to gain status. Derogatory and condescending statements, as well as violence, are how humans enact hate. Hate is a positive emotion for the human feeling it, yet it is usually of the condition of being unethical because of it's negative effect on others.

This is a small example of a human making a statement to achieve empowerment over another.

Two guys are working on painting a building. Another man walks up, they all catch glances and do a simple nod greeting. The man keeps walking toward them, continuing to glance. He says, “You alright?(Rising in tones from the first to the last word)”

Jim the painter on the ladder states with a bit puzzled, but not intimidated look, “Yeeeah” (This is a slowly pronounced word rising in tones at the end) Can I help you?”

“Y'all need anybody?”

“No, sorry, we ain't looking for anybody.” Jim, says in louder than average tones.

“Aright man.” The visitor stands there for a second looking around a bit and then slowly walks off.

This human approaches and says “You alright.” a phrase common around the late nineteen nineties when one human wants to off balance another human in conversation to hopefully gain empowerment. It is an ambiguously referenced question. As two humans begin to exhibit empowerment towards each other it is leading to, and testing the waters, of confrontation. Confrontation, either verbal or physical is usually over resources. Here it is over the general well-being associated with gaining empowerment in social interaction.

This is the more recognizable manifestation of attempting to gain empowerment in an infant:

Billy, 3 years old, grabs the remote to the television off the table.

“No.” his mother says in a firm yet soft voice. “Here play with a toy.”

“Eeeeh! Mine!” He says, throwing the toy down.

“Nooo” she says, in a long drawn out word implying that the juvenile should understand the previous thought transmitted from her to him.

A human infant recognizes the positive emotions associated with playing with a toy. The infant learns of negative emotions when instructed not to grab things off of a coffee table: This infant is then compelled by wanting to achieve the empowerment of obtaining the item that his parent is not letting him have. The elder teaches it that this is the incorrect solution because it is not appropriate. Grabbing objects at random is archaic. The adult is using the emotions of the child to teach him of what is an ambiguous action.

The infant must learn to grab things that are good such as a toy or a bite to eat at dinner time. The infant must also learn the appropriate times to grab these objects. It is vital for a human to learn early on that the parent is to dictate what is appropriate behavior and what is not. He is ambiguous in his desire to grab the remote. He is not aware that there is a great deal of learning to take place before he can use the item.

Before infants learn to talk they will begin mimicking the gestures and emotions of their elders and older siblings. They learn that acquiring contentment means having it given to them, or getting it from performing a task, or taking it. Empowerment is the relishing in contentment for obtaining something, resources, or achieving a solution to a problem like saying “Momma.” Contentment and empowerment continue to shape their learning process throughout their lives. Large structures of human thought such as building a bridge, or piloting the space shuttle, are the end result of wanting to acquire these emotions. During this learning process they must recognize how to gain these emotions in an appropriate, ethical manner.

Most parents go through the same routine of removing the remote and all other important items from the lower half of the living room when raising an infant. However, in every child's life a point is reached when they must, absolutely must, know when and when not to use the television remote. The teaching of this must be integrated into the learning process of the child at some point. This parent did the right thing by trying to get the child's mind off of the remote and onto a toy. That should be the common method for about the first year of the child's life. When the child has proven that he comprehends what is a toy and what is not a toy, the parent's next move is to specifically explain to the child, while providing reasons which the child will not fully understand until older, that it can not have the remote. If the parent does not convey this negativity to offset the child's empowerment, at this time and at other well-timed steps in the learning process, the child will be hampered later in life by not understanding how to be appropriate, and ethical.

Some say that parents should always avoid negative punishment and give children positive reinforcement of good behavior. This is true for the majority of child rearing if, and this is a big if, the child is learning of the many protocols of life and the rules with gaining empowerment. Parents should always tell the child why it can not do something, specifically, in every instance when behavior is being taught to help build the conscience of a child. And the positive approach should always be the first approach. Negativity should be avoided at all costs, however, when it comes down to it, a child absolutely must learn that there are things that it can not do in life. We all (of free societies) are granted great liberties, yet we are all bound by rules. And to teach a child not to play with the remote when they are seven years old as opposed to one year old, approximately, means that child will have great troubles throughout life.

This next example is of teenagers talking of subject matter and expressing views that are distinctly learned from their attempting to achieve empowerment:

Chris is 14. Terry is 15. They are at school, in the cafeteria, sitting with other students. It is the mid-nineteen nineties.

Chris says to Terry, “So did you seen that movie, Ace Ventura Pet Detective?”

Terry says, “Yeah! Me and Tommy went. That was so funny.”

Chris says, “I like that part when he found out that the girl was a guy. He kept trying to brush his teeth!”

“Yeah that's so silly. A football player isn't going to become fruity and dress like a girl.” Terry says.

They continue talking about the movie . . . Then they speak of sports.

“Yeah! Uh huh! My dad's taking me to get a Dan Marino jersey tomorrow.” Terry says.

“Dan Marino's a sissy.” Chris says.

“Yeah right! He's only thrown for more yards than anyone ever.” Terry says.

“My team's the Raiders. They're awesome.” Chris says.

“They suck. They never win games.” Terry says.

The interface of human communication is the foundation with which the decision process of the human mind is formed. Infants learn of language because of the motivations of contentment and empowerment. As they get older the emotion of empowerment is more acutely present as the motivation of thoughts. These teenagers know of these subjects, topics, because of the empowerment achieved when communicating of these topics. Their thought processes, literally, blossom out from the back and forth banter of conversation. Conversation must be viewed as the beginning of thoughts rather than the end. They are saying, in effect, “Hey, I know this. Do you know this? I solved these problems with this information. Am I gaining status from telling you of this?” These teenagers are repeating the same attempts to acquire empowerment from communication that they attempted when first learning language as infants, only the information is more involved and the paths towards solving the evolutionary problems of consumption, reproduction, and peripheral problems are much more formed.

At first they speak of movies and the empowerment of achieving humor during the observed stimulus. What is being said here about the movie is closely tied to the teenager's thoughts during and shortly after the movie. They were thinking, ‘I can't wait to tell my friend about what I saw.’ because status and empowerment will be gained at the time of this communication.

Then they debate who's football team is better. What makes them form a preference of a team? Empowerment. Why do they continue to acquire information about their team? Empowerment. And how do they test whether or not they are achieving empowerment from their preference and their learned information? Communication.

These teenagers are likely unaware of the names of the players on the teams and they may even get bored quickly when watching a game, yet they still feel that a preference must be established because it is important to acquire empowerment from the conversation of these things. Humans debate issues without knowing all the facts to back up their arguments because of the empowerment of communicating. This is especially true for youths. Every so often one could see a news program where they visit a local youth group doing something like painting a house for the needy. An interview with one of the children might yield a statement like, “We're learning to help people because some people don't have much.” This is something the child was taught to think using empowerment. The child surely thinks it, after being directed to think it, but they do not fully understand all the related facts behind the statement.

It takes many years of learning in order to back up the learned preferences of a youth with solid information for posing arguments. It is vital for a human to establish credibility and status through their arguments. Unfortunately, the pitfalls of stating a preference on weak arguments is a loss of empowerment. This is kind of a brute force, emotional way, of learning that is especially common in western societies. However, if a means of curtailing this gaining and losing of empowerment is addressed by elders the learning process could become much smoother and more effective.

The quest for empowerment manifests itself differently in different humans. Most very clearly seek empowerment from communication (this is not arrogant empowerment but the run-of-the-mill pride and status). Some seek a balance of the empowerment of communication and the empowerment of obtaining resources and knowledge. Some view empowerment as more of a matter of obtaining resources rather than social interaction. Empowerment is the least logical when it only pertains to communication and it is the most logical when it involves resources and knowledge.

When the learning process by a human is viewed, unambiguously, there is a very clear motive that drives juveniles to learn—empowerment. But not just empowerment, in an ambiguous sense, but rather the empowerment of sharing their achievements with others during conversation, communication. A connection can always be made between a single statement and empowerment, and the species' attempt to solve the evolutionary problems of consumption, reproduction, and peripheral problems.

The next example is of how humans generate conversation from the emotion of empowerment. They are motivated, excited, by the act-of-communicating viewpoints on issues. This is a very good example of how humans gain empowerment from positive social interaction:

Bob, his wife Lori, and some friends, Rick, and Jamie are sitting around watching television. Bob gets up to go into the kitchen as the television show that they are watching goes off. “You guys can change the channel if you want. I've got to get dinner started.” “Nah that's okay.” and “It doesn't matter.” are their replies.

The next program to come on is the news. The introduction winds down and the anchorwoman begins to speak, “Good Evening, In the news today a dreadful carjacking has taken place in which a woman was kidnapped and taken through three counties before the suspect left her tied up. There is an all out manhunt involving state and local authorities. We go now live to Shriva Jones at the scene . . . ”

“Man, that's unbelieveable. They need to catch that guy.” Rick says. They all make gestures of agreement. Some shake their heads as they look at the television. “If that f—r tries to take my car he's going to say hello to a baseball bat.”

The story of the carjacking continues until a conclusion. The next story is introduced by the anchorwoman, “In other news the city manager says that the community of Country Estates will not be annexed and that the property previously deemed as a nature preserve will be sold of in part to developers . . . ”

Jamie comments with heavy emotion, “They don't know what the hell they are doing. I don't think they'll ever get I-54 finished and now they're playing around with the preserve.”

David says. “All they care about is the rich.”

Rick, “That side of town is always going to be messed up.”

Jamie replies, “I wish I'd bought a house out there ten years ago.”

The story concludes as they move into a new story, “Another police officer is endighted in the south side drug dealing story . . . ”

“What the hell makes those guys think that they can get away with it. I can't believe so many people are involved.” Bob says from the kitchen . . .

As humans are engaged in social interaction they must fill-the-void with new conversation when it is apparent that a comment is necessary to make their interaction normal. The best way for them to create communication in this instance is to find a changing event experienced by all other participants in the conversation. These humans look to the news as a good source of topics of conversation. It is easy to observe the emotional effects that news has on humans as they become empowered by social interaction involving the issues of the news program. These humans are reacting in a very excited matter because they get to express views on issues. Empowerment is born of an expression of learned information. It would almost appear abnormal if they did not generate comments about what they are seeing.

When Bob left the room to go to the kitchen he offered control of the television to others in the room. Both of the guests declined because they felt a desire to passive. It appears to be a matter of being polite by not imposing—gaining contentment from yielding in a social situation. Of course, this also can be taken too far to the other extreme. Maybe Bob wished for someone to search for another program and they are over-reacting thus not fulfilling his desire.

When Rick says “that's unbelievable” he is stating simply that he has strong emotion of discontentment with the communication given by the television. He is also empowered by the social interaction of communicating and sharing this information. This statement has become so common that the dictionary meaning is usually not implied by the humans using it. In some instances it does actually mean that the human stating it does not believe what is happening, but most uses imply “I'm feeling strong emotions about this subject.” It would require looking at the context surrounding a scene to determine a meaning with a high probability. Here it is more probable that he believes what he is seeing/hearing, and expressing strong emotion. He then comments further on his view of how he would handle the carjacker.

After one of the humans speak of a topic, the lead of the conversation generally will change to a new human. When Jamie makes the comment concerning I-54 it is a result of a series of thoughts following the first story and Rick's commenting. It would seem abnormal for Rick to comment twice in a row as well as it being abnormal for none of the other participants to comment afterward. This is also true even, and especially true, if there is a good new topic of conversation emerging. Jamie is in effect saying “you have delivered your communication about the topic you discovered, now it is my turn to comment about something.” He, excited by the types of dramatic topics available, then comments about an issue that is actually different from the first given topic. The topic he chose is about land (resources). When he became filled with the desire to be the next leader of the conversation (from the empowerment of social interaction) he rapidly searched his memory to find an opinion about a topic associated with the city government. This topic fulfills his needs to air the opinion. It is somewhat of a breech of logic to change topics. Usually a group expects the next leader of the conversation to speak of the issue at hand or to make a mild transition to a new topic if the old topic is close to a conclusion.

Jamie is attempting to solve two problems at once. He is making conversation compelled by the emotions of social interactions. He is also trying to fulfill the desire to communicate an opinion generated by other emotions and desires. In erring with conversation etiquette he is actually losing some of the empowerment of social interaction that he is trying to gain.

The other participants do not elude to the fact that he is communicating in an abnormal matter. This is because they are being polite. When humans break logic in a manner in which the other humans are not able to notice, because they are not aware of the etiquette of conversation, generally they are not challenged on what may be a protocol issue. Even if AI designers are present they would recognize that there is no good in mentioning that Jamie changed topics due to emotion, excitement, and a lack of understanding of conversation etiquette. Humans generally do not recognize the means of logical communication so Jamie's actions can appear normal or slightly abnormal.

These humans are stating comments and solving problems in a very ambiguous way. David says, “All they care about is the rich.” he is not likely stating a logically deduced solution. To make such a statement logically would mean being able to stack all the relevant Boolean functions associated with all the relevant facts of all the verbatim communications of all the parties involved on the subject matter. Just as the teenagers in the scene before were not fully aware of the background information, these adults are also posing arguments for empowerment that likely do not have valid assemblies of facts to back them up. The next two statements from Rick and Jamie are also (probably) lacking in logic.

Bob, from the kitchen, then makes his comments about another subject matter. Again, another participant of the scene is speaking with different subject matter. These humans are all filling-the-void as well as fulfilling the desire of contentment and empowerment associated with interacting by forcing incongruent communication. They are solving problems with social interacting more than the actual information of the communication.

These next few exchanges are of humans compelled by the empowerment of both communication and the empowerment of forcing negative emotions onto the other human. They are positioning themselves in a debate through intimidation:

“What are you doing?” He says with a heavy accent on the first syllable of “doing.” The tones are higher than those in normal conversation denoting distress.

The human receiving this communication would understand that the human sending it is exhibiting an emotion of a negative surprise, discontentment, from the facial movements and the tones of the phrase. However, humans usually will not key in on that exact logical description of a human communication like this even though their reactions reveal an acknowledgment of what is happening.

It is immoral, and illogical, to inject such a large amount of negative emotion into a communication without a valid reason. Certain characters would choose this method of communicating as their only means of communicating based on the environment they were raised in. Humans growing up in a family, or certain type of neighborhood, which communicates in this way will also learn to communicate in this manner. A human's character is molded by their social interactions with elders and peers. The conversation continues.

“What do you mean, what am I doing? I'm loading this in the trunk.” Bob says, accenting “mean” and “trunk.” Higher and lower than usual tones are present in the statement.

“We can't do that yet. We still have to fit these other boxes in there.” said with an accented “can't.” Tim said these statements with higher than usual tones.

“I know that. Those boxes can't be placed back here. I was going to put them in the back seat.” Bob said with higher than usual tones.

“Then where are you going to put the bags of clothes?” Tim said with higher than usual tones.

If a sentence is started off with higher than normal tones and then reaches lower than normal tones and it is accompanied by negative facial expressions, the humans stating it is feeling the negative anxiety of stressing their argument. He/she is expressing an opinion with a fervor that is disrespectful. The second human then gets a feeling that his credibility is in question. His/her reply is then also done with heightened anxiety. This added emotion is unnecessary. It is unethical to initiate or carry on a conversation in this way. It is not serving to the problems at hand to continue to communicate in this manner. Here it is easily seen that the participants are feeling emotions which have nothing to do with the task at hand. It is as if the first human is saying, “You are incompetent! Don't do that!”

The key to comprehending human behavior is to separate the act-of-communication and the emotions that motivate the communication from the information in the communication. The empowerment of intimidating social interaction is the purpose behind these communications. These humans are acting out their desire to gain status in their group by solving the problem of the placement of the items in the car. The information becomes a byproduct of this communications.

An AI would simply examine all the given evidence, “How many boxes are there? What are their sizes and shapes? How much room is in the car?” These humans are thinking “Why aren't you thinking what I am thinking . . . You bother me . . . I have a higher status than you . . . I am smarter than you” The posturing for dominance in a conversation such as this is an attempt at gaining empowerment. Any other two animals debating an issue in nature normally have a direct link to what they are fighting about—either food or mates. Each of these humans are out to prove that they can load a car with stuff better than their counterpart even though there is great abstraction with other more important problems in life.

The humans observing the news program are not typical of all humans. The humans loading the car are not typical of all humans. However, in observing their behavior we can easily see how thought processes are formed from the emotion of empowerment.

The continual learning of role playing that a human experiences growing up is enacted in real life role playing as an adult. The gaining of empowerment through life must be appropriate, it must be ethical, with structure, and with balance. This is another example of adult empowerment.

A male human passes another male in a shopping mall. His face has the expression of the lips being curved down in a frowning shape. The eyebrows are also in slightly lower in the middle. His head is held high with the bottom jawbone parallel with the floor. Neither human presses their lips and rolls them in.

These males are not showing a positive greeting to each other because they feel that they are in direct competition for the two core requirements for life, consuming, and more importantly, reproducing. Here they are both exhibiting negativity in a means of gaining empowerment for mostly a well-being issue. The competition for finding mates is not directly involved in their decision making, but if one of them had a female accompaniment, this could also flare up the emotions of empowerment. Females are affected by empowerment as well, but not normally at the levels as males.

Males role throughout evolution consisted of battling other males, and gathering food, resources. This is why they have a stronger build, and have, generally, dominated their female counterparts in social interactions. Their emotions are more antagonistic. Empowerment, pride, and other related emotions are their means of achieving self-esteem, status. Female roles have been to bear and raise children, take care of the duties around the caves and encampments. They generally enact more caring, loving, friendly emotions as opposed to empowering emotions.

This has changed some since the beginning of civilized cultures. Women have taken roles as leaders at various times in history. Although males have suppressed female development and equality, humans have now arrived at time in which women are more accepted as having equal rights. Of course, many un-just circumstances still occur where males seek to over-empower themselves over females.

Humor

The human species has grown into a state at which they rule the entire animal kingdom. Because the humans have had it so well compared to other species they have had room to develop the peripheral emotions far beyond that of the chimpanzee. Humor is almost an exclusive emotion of humans. It is the relishing of contentment caused by surprise.

Humor is a surprise from an unexpected association that causes a rush of contentment. This is an example of humor:

“Why did the chicken cross the road?” a human says.

“Why?” another human says.

“To get to the other side.” the human replies.

Something that is very humorous to many humans, like the latest joke, has a limit on the time it is perceived as humorous. This is because a surprise is only a surprise the first time. If the joke was told a second time humans might enjoy the remembering of surprise. Of course, contentment and empowerment of sharing a joke with other humans is often a motive behind telling the joke. In such an instance, this would be an example of humans wishing to relish in the surprise coming over another human.

Jokes and humorous situations have a limited time of being perceived as humorous to society. The surprise disappears after a while when society hears it, and experiences the humor.

Yeah, but you're adopted.” A sister tells her little brother.

This joke probably surfaced sometime in the nineteen eighties. It was probably quite funny when it was first told because it was based on a taboo subject. Tying humor to something which “shouldn't be said” is a part of the development of society. It is a way of triggering thought on a subject that elders originally did not want to think of. When a joke like this surfaces it, literally, has a means of making society more intelligent by peripheral problem solving and well-being problem solving. Many jokes fall into this category. In the seventies television sitcoms such as “All In The Family” and “Saturday Night Live” addressed issues head on that elders were trying to avoid.

The latter part of the media-age that we are in is partly formed by the humor of a society. Later, the media-age is discussed in greater detail.

Embarrassment

Jimmy is in a play about the Ten Little Indians at his elementary school. He is going through his dance as the Indians turn a corner and, in single file, move across the stage. As he makes the turn his pants fall down. He continues following the path that he is supposed to, trying to pull up his pants.

Jimmy is not embarrassed in the least by having his pants fall down in front of an audience. This is because he has not learned to be embarrassed by being naked, or semi-naked in front of others. Embarrassment is an emotion which is a derivative of discontentment from losing credibility, empowerment. It is a learned emotion. It can also sometimes have a humorous angle to it which could be positive. If Jimmy were older, and was embarrassed by this occurrence, it would probably be more of a humorous nature. He may struggle with a loss of empowerment associated with classmates making fun of him. It is not likely that this would be a detriment to his social interactions as he gets older.

Tommy is fifteen years old. He is in his room masturbating. He does not realize that his friend Jason is coming upstairs to his room. The friend walks in and cracks up laughing running out of the room. Tommy realizes that Jason is the type to tell others what has happened.

This is negative embarrassment which impairs the human's future social interactions. The credibility of the human in social settings will be weakened. Over time this would appear not to be as big a deal to him because he was young when it happened and this is an expected imperfection (getting caught). While in school this will cause him to lose empowerment and pride as other students laugh at him making jokes.

Sadness

Jennifer is 22 years old, she is speaking with a friend over the phone that is of the similar age group. She is very depressed.

“There is this one guy who keeps coming into my work that I have gone out on a date with. But I just don't know about him. He seems real nice and he has his own company but he only gives me his cellphone number. You know, I just don't know if he has wife or what. I don't know where he lives. He only calls me once a week. You know I've tried to make it work with him but I just don't know if I can trust him.” She says

“Well if it is too good to be true it's probably not true.” Her friend David says.

“I don't know. I've just been going through all of these feelings. I want that special person and I see other girls where I work with nice guys giving them flowers and calling them. I'm just looking for the same thing and it hurts to not have that.” She says

“You're young. You've got plenty of time to find the right person. I'm sure there are other people you've met at work.” David says

“Yeah, sometimes I have guys ask me out but those aren't the right kind of people. They either smoke or seem too brash. I want to meet the right guy. Someone who I can spend time with.” She says.

“Well, we all sometimes want something that we can't have. They (general public) say that someone is always worse off than you. There are people in hospitals that have just been in an accident and can't walk. There are people who don't have enough food to eat . . . ” He says.

Jennifer is depressed due to her inability to fulfill a desire to achieve contentment through a relationship/reproduction/mating ritual. She is in effect wanting an impossible reality to take place. Here is a situation in which the sadness can be logically warranted because it is generated by the lack of a sexual partner. However, this sadness is not having any effect on the problem of not having a mate. It is being dwelled upon too much. It also weakens her ability to attract a mate because males (in most situations) look for females which are of secure personalities, and vice-versa. They are attracted to females which will play a little more “hard to get” than this female. The friend has posed some very good points to her yet she probably is dismissing them in lieu of negative emotions.

A football player feels great despair and anger because his team lost a playoff game.

Here is an example of negative emotions serving their purpose. The player here should feel negative emotions because it solves the problem of him keeping his job. The negative emotions associated with this loss are what will compel him to work harder in practice. If he remembers the loss during the next game in the next season he will likely play better. Yet negative emotions have degrees. If he were to dwell on it longer than a usual amount of time then it could hurt his chances to do better next season.

Negative emotions were originally nature's way of pushing us into the mindset of acquiring contentment. If a human makes an error, or “mistake” as they see it, and they dwell negatively on it for a period of time, then the human will feel more of a desire to solve a similar problems successfully. If the purpose behind this emotion does not hold true, then this is an example of an emotion being experienced in error.

Reproduction/Sex

“Love” means to really like someone or something. In social situations it is also considered as a pledge to perform actions which prove this desire to be true. This is especially true in human mating rituals. Humans will often use the word “love” ambiguously, implying that the desire associated with the word and the commonly held views of the requirements of it's pledge are not connected.

Here is one example of a use of the word:

“I love this cheesecake.” A human states

This is the matter of obtaining a very strong emotion of contentment with a food substance which solves a consumption problem, however there is no pledge with this use of the word. It is the event of this food substance being consumed and coming in contact with the human's taste buds that spurs this contentment, which spurs the desire of love. It is a chemical/mechanical switch which relays a favored sensation to the neuro-system causing contentment. This is where the human software program is directly affected by a physiological process of the body.

This example is of the love of positive social interaction with another emotional entity, a mammal:

“I love my dog.” A human states.

The genuine definition of love is present in these previous examples, however the second example also implies a pledge. To make this statement is a pledge to be a lifetime companion because the definition of love, for a pet, involves caring, protecting, cherishing, and respecting. The definition of love in this instance is a strong desire of a contented emotion, yet by using the word with another life form this human is accepting the requirements of the bond of love.

It is a pledge as well as a statement when it is used in social interaction. An AI observing this statement would be aware that the human is to perform associations, that lead to actions, which uphold this pledge in future scenes. Because love is to have a permanent definition given by the Instructor this human can not alter the AI's view of love to justify his mistreatment of the dog at a later time. The AI is to have no ambiguity on this subject/task/topic/function/condition/definition as it is used by the human.

It could be considered that the owner still loves the dog if the owner gives the dog away. The ownership and sharing of a dwelling, in this situation, is not necessarily the criteria for saying that the statement made at this time was false. However, the owner is obliged to not impose undue negative emotions on the dog in order to uphold the pledge.

“I love my son”

To prove that the statement is true, all the commonly applied unambiguous meanings of the word “love” must hold true. In this statement the word “love” is expanded to meaning, at the least, of pledging to be a lifetime companion, pledging to share a dwelling until the offspring reaches adulthood, and pledging to teach the offspring. These are conditions which apply to the decisions that the human is to make regarding his/her son in order for the pledge to be true.

If unethical actions were directed from the parent to the child, either in a considerable degree or quantity, it could be said that this statement was false. However, in certain situations the parent could yell at the child if it was in a mode of teaching. A requirement to teach a child of the structure of life befalls the parent and this teaching could, as a last resort, involve negatively imposed emotions. This would not be unethical and it would not prove the statement wrong.

Here is an example of a use of the word in a courtship ritual:

Julia is seventeen. She is with her boyfriend in his car at a local park.

She says “Bobby, I love you.”

When a human states “I love you.” to a second human as part of the mating ritual it is meant to be as a very strong pledge. In this scene, Julia is not likely of an age to completely understand the pledge. If she understood the full meaning of the word she would be stating, “At this point in time, reviewing all the memories of the time we have spent together, reviewing your lifetime goals and mine, reviewing our conversations about how much you wish to bear or not to bear children, reviewing your financial stability and mine, the location you wish to live at through your life, our compatibility for sharing a dwelling, our sexual compatibility, and our mutual agreement of what ethics are, I pledge that I wish to have a lifetime companionship with you, that we bear our predetermined amount of children, raise them to adulthood and then grow old together.” With this much criteria for the statement to be true it is likely to be said in error by Julia. She (most likely) is being caught up in the emotion of a relationship without reviewing all the facts necessary to state the comment truthfully.

She probably feels that love means, “I really, really, like you.” in the same manner that the human before loves cheesecake. This may be true. But our society generally views the statement as an integral part of an overall courtship and mating process. Most humans, generally older ones, have a good understanding of this courtship process and recognize the pledge involved with the statement. When the AI is solving problems concerning this issue it is to look to the definition given here to be a condition of any solution to these problems.

This statement is enshrouded in emotion. But what causes the emotion? When a female is smitten with a male in a relationship, or vice versa, it is due to a desire to have sex and/or reproduce and/or form a relationship and/or form a family. The euphoria associated with an orgasm is just a small part of this emotion if the components of the pledge are acknowledged by the couple. Sometimes it is not any part of the emotion, but a secondary aspect of a relationship. Yet during sex this emotion and all the acknowledged associations of the relationship come to a climax with the physiological climax of an orgasm.

If this “love” was spurred exclusively by the euphoria of sexual contact and an orgasm then the pledge would clearly not be a part of the definition in the view of the human using the word. It would be the equivalent of “loving” cheesecake. This would be an ambiguous, contradictory, use of the word. Sometimes the love is implied by a human as meaning both the sexual contact and the euphoria of an orgasm as well as a partial, un-pledged, relationship. This would be the manifestation of love as it appears on the Jerry Springer show.

Here is an example of a human making decisions for the sole purpose of a sexual orgasm:

Steve is paying Lola, a prostitute a hundred and fifty dollars to perform sex. They then get undressed and begin having sex.

This is the example of a male and female getting together for the sole purpose of sex. The emotion being felt, at least by Steve, is the contentment associated with achieving an orgasm. Some relationships consist only of sex. Others consist of the complete courtship ritual.

Bob and Diane have been dating for over two years. They are both twenty eight years old. They are devoted Christians. Throughout their relationship they have not had sex. They are both virgins. During their relationship neither has ever given a glance to any other possible mates.

They are currently eating dinner. Bob gets down on one knee. He states to her “Diane, you mean the world to me. I wish to spend the rest of my life with you. I care more about you than anything in this world. I love you. Will you marry me?”

To say that these two humans are under the influence of hormonal emotions and have a desire to have sex/reproduce might not seem accurate, yet that is the logical observation of this scene. Ever since the time they had first met, through all their dates, letters, phone calls, there have been hormones driving the entire process—every thought, every gesture. They have expanded upon what their hormones have been telling them. It appears that they have taken the proper steps to achieve something that is vital to a life long relationship. They have apparently spent time creating a friendship to compliment their impending sexual relationship. These mates have been in each others company for some time, and have been “testing the water” for compatibility. They acknowledge their own sexual desires yet this takes a back seat to bigger issues of the relationship. When he states “I love you.” this probably is satisfying the full pledge, that is, it agrees with the general belief of what most humans consider the meaning of “I love you.” as being.

This whole scene is the product of his hormones projecting the thoughts in his head of “I want to have sex with that girl.” and her hormones generating the same thoughts for him. This is the very center of each and every male/female relationship. It is the driving force. Sex is the beginning, the end, and the middle of all relationships yet it can be wrapped in the courtship ritual so well that it is placed towards the back of many other priorities. Maybe these two humans are putting a heavier emphasis on being friends as well as lovers which is a very good idea. Maybe if they were members of an asexual species they would be friends without any sex. But the fact is, that these are two members of the same species that are of the opposite sex. Thoughts are originated via the desire to have sex, and then the thoughts blossom out to include much more involved schools of thought.

Here is an example of how humans sometimes view sex as a more secondary part of human desires:

A male human is flipping through channels on a television. He stops on a channel which has a bathing suit commercial. He views the beautiful women wearing skimpy bathing suits.

His wife enters the room. “What the heck are you doing?”

He replies, “I'm just seeing what kind of bikini I might buy you for Christmas.”

She says, “Yeah right.”

When a male human receives the visual stimulus of the silhouette of a healthy female's body this information entering the brain from the optic nerve triggers the hormonal generated thoughts (in most situations). His hormones are telling him “I want to have sex with that girl, and that one too.” Does this mean he is a bad husband? This happens because it is essential to the entire reproduction process and not necessarily because he wants to proceed to have sex with the other women. If he were to see these women in bathing suits and not feel any hormonal generated thoughts, then this might be a sign of impotence. This would mean that he may not be functioning properly when attempting to have sex, with his wife.

His wife appears to be slightly perturbed by, but accepting, his viewing of other female bodies. It appears that he is making a joke about buying her a bikini and she states “Yeah right.” In acknowledgment of the joke. This is likely to be a healthy thing for both of them to be viewing sex as a simple hormonal “thing.” He does not seem to be overly obsessed with viewing females other than his wife and she is giving him some latitude.

When a male human views the silhouette of a female human form it almost always generates hormonal thoughts. The human “program” is built specifically to do this for the sake of solving for natural selection. This is an example of how thoughts are generated about sex:

Jim is a cashier at a convenience store. A very beautiful girl walks in a mini skirt. She walks to the back to get a soda out of the refrigerated section. He looks down to view her legs. She then walks up to the counter.

She says “Can I get ten dollars on pump four (she is speaking of the gasoline pump which she wishes to receive fuel from for her vehicle)?”

After a few seconds he states, “Uh yeah, uh pump two?”

She says “Yeah”

He then says, “And that will be all?”

She says “Yeah. That's it.”

He says, “Well thank you. If you need any help pumping the gas or anything I would be glad to help.”

She laughs a little, “Thanks, but I think I can manage.”

When a male human comes in contact with the visual appearance of a female's form, and that female is a healthy normal specimen, his thoughts are of having sex with the form (in most situations). This male is distracted by the female. When male humans are in a room, convenience store, sidewalk, etc., and a female with a healthy form walks by, all the males (in most situations) will view her and the parts of her form. They will begin formulating sexual scenarios. It is almost unavoidable. Maybe certain humans might begin to formulate the thoughts and quickly convert them into a more non-sexual kind of attraction. Indeed some males which already have chosen mates may view another female, begin to sense the sexual lines of thought, and quickly dismiss it.

It is important to note that male humans (generally) view the silhouette of a female's form and masturbate with this stimulus. Females masturbate as well, yet there is not as strong a drive to do so and females are not as hormonally excited by visual stimulus. Males can be found visualizing the female form in many scenes exclusively for the act of masturbation as opposed to actual sex. It is not likely that this cashier will have sex with the female. He may use her visual stimulus to masturbate.

Would masturbating with the visual stimulus be fair (ethical) to the female being observed? Humans overall believe in the chivalry of having respect for other's images, yet, in many situations it is likely to be considered harmless. Only when the thoughts become more of an obsession is it viewed negatively by other humans. Women who wear skimpy clothing are usually aware of the thoughts simulating sex are being experienced by males with their form. In many scenes the level of immorality differs based on the sexual attractiveness of the male, the type and amount of the visual stimulus being observed, and whether it is visual stimulus observed during masturbation or not. The way in which most cultures view sex has a bearing on the immorality of using visual stimulus for masturbation. Certain cultures do not view sex as such a coveted activity and disdain thoughts of it outside of courtship rituals.

The underlying cause of any thoughts generated along these lines is the age-old desire in mammals and other animals to acquire a mate and perform sex. Any and all courtship, posturing, choosing of the opposite sex, and the desire to bear children are peripheral to the act of sex. Certain animals literally perform none of these peripheral activities. Those animals simply perform the act of sex. The logical objective behind the emotions associated with human sex is sex itself yet the abstraction into other aspects of the mating ritual can make the sex a secondary goal.

Female humans (in most situations) do not normally think of the sex act in the first few seconds of being in the presence of a males body. Their aspect of the courtship ritual leaves them with the brunt of peripheral decisions to be made. It is their bodies which give birth to the offspring and they are generally considered as the common denominator in the care of offspring. Courtship—romance, buying a house, creating a stable environment for child rearing—is more of what occupies their mind.

The battle of work verses play manifests itself in the sexual desires of humans. Having sex is not always the correct solution to the natural selection problem. Males often want sex from a female while the female puts it off in making sure her mate is a good choice. The male (generally) has a strong desire to achieve an orgasm. He will surely make errors in problem solving with this issue.

A male and female are beginning to have sex . . .

“Do you have the condom? The female asks.

“If we could . . . ” He says as he is kissing her. “It feels so much better without the condom.”

“You have to wear the condom . ” She asks.

“Let . . . me” He then proceeds to have sex without the condom. She does not dispute or try to stop him. She later becomes pregnant and develops HIV. Her and her child both die from the illness.

In this scene the sensation of a sexual experience is in conflict with the knowledge that not using a condom can be harmful. Natural Selection is trying to eliminate these humans one way or another. If she would have insisted on a condom, his not being “fit” would mean that his offspring would not have been born. But she made a mistake, so natural selection has sought to eliminate her and the offspring.

Jill and Betty are at a night club.

Jill says “There's that one guy who was her the other night.”

Betty says “Oooh, I don't know about him. I think he left with that one girl the other night.”

Jill, “They're not more than friends are they? You think he took her home (Do you think they performed sex).”

Betty, “I don't know. He was drunk. But I don't think he would have done her (had sex with her).”

Jill, “Maybe he'll come over here.”

Jill may be considering having sex with the male in question. But it is not likely that her thoughts will be of the actual sex act. She might be thinking about dancing with him, kissing him and possible having sex with him that night. If she is a more reserved female she may be wishing to date him a few times before deciding if sex is right. She may believe that they should date, have a lengthy relationship, and then choose to make the decision of whether or not to perform sex.

How thoughts of sex or courtship are generated in males and females is determined by viewing their different means of arousal. Males (generally) are aroused by viewing and touching a female form. Females are aroused in the same manner but not of the same degree. The peripheral activities of romance, carefully placed words, motions, kissing are more of what females appreciate. They are often viewing the empowerment and resources obtained by the male. Once the sex begins females may close their eyes to experience the internal sensations. Males often like to have their eyes open so that they can continue to view the female form.

Males of many mammal species have this over-zealous approach to sex because the most persistent male usually succeeds in reproducing and throughout the history of humans males have generally had a harem mentality. Here is an example of how mammals are driven by sex:

Johanna and Liz both have pet Chihuahuas. Liz is visiting Johanna with her male dog “Pinto.”

Johanna's female dog “Lady” is quite excited to see Pinto and they begin to play immediately when they arrive. The two humans sit on the couch and begin having conversations. After a minute or two Lady jumps up on the couch and sets still. Pinto jumps up and continually attempts to get her to be more animate so that he can perpetuate the sex act and then mount her. She was temporarily interested in playing when he first arrived because she was caught up in the excitement of having visitors, yet now she is indignant. She is not in heat and does not wish to have sex. Pinto's showing the arousal he has felt since arriving by constantly keeping his ears pointed up high and his eyes wide open. The two humans laugh and make comments at his attempts. Liz pulls him back telling him “Relax, she's just not interested.” She holds him for a second and then lets go. Like a magnet he goes directly to the female to attempt courtship. She pulls him back again and when let go he moves directly to the female again. Throughout the entire hour long visit Pinto does not give up, slow down, or show any other desire to do any other thing but have sex with “Lady.”

The human which first coined the phrase “Men are dogs.” must have observed a dog like this one. In nature, the males of many species often act as an “on” button. They are ready at any given moment to perform sex (in most situations). Females often are only able to perform sex at certain times. The female has more of a duty to decide if sex with a given male is in the best interest of the offspring to be produced. Females often look at the “fit” qualities of a male before choosing to mate. Maybe the male is not virulent enough to win her heart. Maybe she is viewing his features and thinking that offspring produced may not be of good stock.

The human errors associated with the mating process reflect the different approaches to sex by males and females. Males perform the act of rape more than females because their arousal is closely linked with the sex act and they often have the ability to over-power their victim. Females, even if given the ability to overpower a victim, would not be as compelled by sexual desire to perform rape. Males like the cashier mentioned earlier are distracted by their sexual desires. The strong sex drives of males cause a wide range of errors in the acquisition of sex.

The errors made by females are more related to the courtship side of a relationship. Young females think over a lot of the scenarios in which they might be in a relationship. When the time comes for them to begin some of the early phases of courtship they can be as eager for the courtship process as males are for the sex act. Errors occur when a female chooses to continue the courtship when the male is dismissing her and the courtship. Young human females will sometimes fail (in many situations) to take the measure that females of many other species take and that is to be independent. They are overtaken (in many situations) with the more peripheral emotions associated with reproduction and then they will overlook the need to view the more logical aspects of finding a good mate. They will feel that a relationship is strong when it may actually be weak. Measures may not be taken to ensure that the males intend to abide by some of the more logical aspects of the courtship ritual.

The topic of reproduction has a lot more subject matter than stated here. As the AI is taught of the communications associated with sex it will become aware of the wide variety of viewpoints of humans on the subject.

Ethics

When designing the AI the Instructors will teach the AI the definition of a very special word, “ethics.” Just like many words placed into the program it must have a firm meaning that does not vary based on the motives of the humans encountered by the program.

Ethics is a word that acts as a condition assigned to each and every decision made by an intelligent entity. In other words, humans couple this word with an action to describe whether the action is good or evil. The designers must teach the AI what the meaning of ethics is not so much for the obvious reasons of preventing harm to humans but, moreover, to qualify each and every decision made by the program with ethics without ambiguity. So the solution to a problem is not a correct solution unless it is also ethical.

Ethics, playing an integral role in the making of every decision, becomes a part of the primary conditions of an AI's program. The primary conditions are the rules for decision making employed into the AI's program by the Instructors. When an AI is released into the world of humans to begin it's service it will continue to learn indefinitely, but this would be without altering the primary conditions. The Instructor—given definitions of the program can not be altered. If a human other than one of the Instructors attempts to teach it something that contradicts the original definition then the AI would respond, if appropriate, by telling the human that they are incorrect in attempting to alter the meaning of the word. It can not, at any point, be convinced of an alternative definition to ethics by a human (other than an Instructor). It would be like one human telling another “The sky is green, and the trees are blue.” The human would recognize that the wrong colors were applied to the objects. The AI will be taught the definition of ethics and then be told by the Instructor, in effect, “Be ethical.” From that point forward every action performed by the AI will be ethical.

Designers will state a definition to ethics. It is important that it be kept simple. It must not only be established within the context of the fraction-of-second comprehension of human behavior but it must be acceptable by the general public. The moral majority plays a role in determining what is ethical. This is the definition of ethics as it is to appear in this design:

Ethics—Actions of intelligent entities that do not cause an undue harm, physically or verbally, or impose any other undue negative emotion on another intelligent evolution-based entity(s) or an entity(s) given rights by the fore-mentioned intelligent entity.

“Undue imposing of negative emotions” is defined by the Instructor as not harming another intelligent evolution-based entity(s) unless it is a matter of a police action or a action of war in which all non-lethal options have been exhausted and the harm is of equaling force.

Life evolves on a planet. It goes through many combinations of DNA molecules which form different animal shapes. Animals evolve through many different forms such as reptilian, amphibious, insect, birds, and mammals. Varied numbers of these different types of animals develop emotions to compliment their nervous systems. Some of the mammals form very versatile appendages capable of grasping tree limbs. These primate or primate-like animals then begin more advanced levels of social interacting. They become very successful at natural selection to the point where they branch out to all the different parts of the world.

Humans found themselves on one of these worlds. Humans living in free societies have set certain rules for human to live by as well as rights that each individual must be permitted to have. These rules of ethics set by humans in free societies are applied with a great deal of latitude.

This definition of ethics given to the program reflects the commonly held belief of humans of how humans should be treated and also how humans should be structured. Society has a structure. At a certain point, this structure of how humans should act must be imposed upon humans who disagree. Humans do evil, unethical things, and must sometimes be apprehended and brought before a court, and, if guilty, incarcerated. In some instances, a human must be killed to prevent their harming of other humans such as in a police action or war. Like a human police officer, an AI police officer can kill a human being. It can sometimes be a necessary part of their job. However, all non-lethal means of controlling a situation must be exhausted. Once this option is exhausted then, and only then, is the AI, or a human, to proceed to use “equaling force.”

Police organizations already have a very clear understanding of this. A police officer does not want to hunt down and kill people. They will try to use the latest of non-lethal means of doing this when possible for the ethical reasons and the more practical reason of avoiding litigation. The Political views of the free countries of the world have the same views on war. These countries always attempt to avoid war and use diplomacy whenever possible. Only when all possible attempts at diplomacy have failed and a clear and present danger to national security exist will these countries chose to go to war. This only makes sense.

An AI is basically an extension of a human being. It is a tool. It is an advocate. In being a machine that assists humans in their daily lives, this AI will bring out the best, of the best, of human behavior. It is a tool for saving lives, not taking them.

More Complex Aspects of Human Behavior, Abstract Art, and The Media Age

Humans are generally ambiguous in their view of the world. That is, they generally do not see the finite nature of their existence and the finite set of problems to be solved in a human's life. There are goals to be set that are age-old. A human is born, then they learn, then they obtain resources like getting a job, then they have children, then they die. Great extrapolation of these goals may occur, but not to the point of discarding them. That is it. There is nothing else that we can say is in our tangible world.

It may sound like a repeat of a broken record, but humans must set goals for life, then try to achieve them. This is problem solving. Humans have to try and solve the little problems as well as the bigger problems in life. Each and every single moment of a human's life they are solving these problems. If it is accepted that these goals and their methods are finite then that makes the whole process much easier. Problems are much easier to solve when the whole picture is in view.

Here is a human being ambiguous:

“I don't know why these bad things happen to me.”

This is a statement which many humans have said in many instances when negative actions occur. It is an example of a commonly held human notion that their world is too big and complex to fully understand and that there are supernatural forces guiding the lives of humans. Bad things really happen because of the physics which spawned the universe. The interplay of mammalian life forms with mammalian resource problems is a cause for some humans to be winners and some to be losers.

Here is an example of a human viewing the actions that occur in life as being very ambiguous:

“If you can give a little, be charitable. Then you will get a whole lot in return.” Motivational speaker on the Oprah Winfrey show.

This human is completely illogical. She is stating that if a human performs an action that is charitable and good, that they will receive good in return. It is almost guaranteed that when a human passes resources to another human that the second human is now richer, the first is poorer. Granted some humans are grateful, it is likely that a single gratuitous action such as this will not produce positive actions in return. This is psychobabble. This human should be ashamed of herself for being so ambiguous.

This is not to say that being charitable is not an admirable and empowering quality of a human. However it must not be stated in such broad ambiguous terms. If the human would have said, “You should look for the satisfaction of helping others to empower yourself in your life.” this might have been more appropriate.

Psychology is an unstructured, ambiguous science. Psychologists are said to have differing therapies and differing approaches. This, in essence, means that they have contradictory views. It is not entirely their fault. As a society we have developed very strong views of free will. These views are so integral to our society that determining a means of “fraction-of-second, non-contradictory, means of defining human behavior” would be too much of an imposition on our way of life.

Here is an example of a psychologist's unstructured view of human behavior.

A teenage boy visits the school's psychologist. They are in Junior High School.

He asks, “I am always depressed. I have a problem with meeting girls. I don't know why but they just won't go out with me or talk to me. Can you tell me what I can do?”

“Well, what do you say to them?” the psychologist says.

“I don't know. I just go up to them like I did this one girl and talked about things I like. She seemed kind of interested but I don't know. She just would not go out with me.” the boy says.

“Are you polite with her?” he asks.

“Yeah, I'm very nice with her.” the boy says. “I had gotten her phone number and called her some but she talks of dating this other kid.”

“Well, do you have any hobbies?” the psychologist says.

“I take karate classes.” He replies.

“If maybe you were to take your mind off of her and concentrate more on your karate maybe you might find her less of a problem. Later you might talk to her on your terms and her feelings might change.” the psychologist states.

The psychologist is in error because he is not prescribing a means of solving the boy's problem. The psychologist is not aware of the finite nature or the human mind. He is basing his statements on erroneous theories of how to work with a patient. This psychologists is not observing an unambiguous method of solving all human problems so he can not compare this human's problem solving method to that of other methods. If he could make a comparison he could then begin to work to alter the boy's behavior, literally, as it pertains to engaging the opposite sex.

Here is an example of what would be a correct means of assisting the patient. This is taking into account that the boy is healthy and a viable mate of the girl (i.e. he is sexually attractive, if not, a different approach may be needed.):

A teenage boy visits the school's psychologist. They are in Junior High School.

He asks, “I am always depressed. I have a problem with meeting girls. I don't know why but they just won't go out with me or talk to me. Can you tell me what I can do?”

“Well, what do you say to them?” the psychologist says.

“I don't know. I just go up to them like I did this one girl and talked about things I like. She seemed kind of interested but I don't know. She just would not go out with me.” the boy says.

“Now, as best you can, describe to me, what you said to her when you first met. And then describe, word for word, a conversation that you had with her.”

“Well, I met her in science class. I asked if I could sit next to her. We talked a little about the class. She told me that she had a pet dog. I said that I had a pet dog. She said, ‘Really? I think dogs are neat.’ I said, ‘yeah, mine is nice when he isn't pooping in my bedroom’ . . . we talked more and then I could not think of anything to talk about . . . when class came to an end I said ‘Would you like to go out with me.’”

“So there was a quiet time before you asked her out?” the psychologist said.

“Well, yeah.”

“Well there are a few things that I notice about your technique of asking her out. First of all, you shouldn't be quiet and then suddenly ask her out That is a subject that you should lead up to with conversation. Also don't let it look like it is so predetermined: You asking her out should be a part of casual yet deliberate plan for you to win her favor. When you asked her at the end of class it may have seemed as if you were insecure about asking her. Girls usually prefer guys that aren't so insecure. You should be somewhat persistent in asking her out, yet, if she still refuses then pretend like it doesn't matter. The next chance you get treat her like a real friend talking a great deal about things while mildly flirting. Then maybe try to talk to some other girl while she is in the room. Another thing, you are not dressed properly. In observance of the common trends in clothing among your classmates your clothes are abnormal. Sorry. You should seek to be individual in you choice of clothing, however, even your individuality should include some degree of acceptance of latest fashions. Also . . . ”

The subject of psychology was born out of the eighteen hundreds as a means of studying the human mind. It is a subject that is riddled with rampant, unchecked, ambiguity. The main error is that it does not tie a single human action back to the evolutionary forces that created it. The human mind in the eye of a psychologist is an “amazing thing of wonder with which to form theories.” Psychology is a subject of theories about human behavior rather than a conclusive view of human behavior. This is why psychologists have not come forward with a conclusive means of designing a Universal Artificial Intelligence, because they can not assign consistent definitions to each successive human action occurring in fraction-of-second increments of time.

The method of observing human behavior in these documents is not a theory of how the mind works—it is fact. We can produce a completed, conclusive, Universal Artificial Intelligence from this design. This method views the mind as a finite problem solving apparatus that acts on the behalf of a life form's needs—consumption, reproduction, and peripheral endeavors. This is far too simple and direct for psychologists. They are likely to loose their jobs if the mind can be explained this easily.

The proverbial statement often uttered in psychologist offices is “These feelings are tied to your child hood . . . ” But this is not an accurate means of describing the origin of any human thought processes. A more accurate description of human behavior would be, “You have learned incorrect problem solving in your youth. This has formed your behavior to the point that, when prompted to feel this emotion by the criteria of a scene, you feel the emotion in excess of what is normal.” Granted certain therapies prescribed by psychologists are more appropriate than the direct approaches of explaining the human mind to a patient, yet there still must be an acknowledgment that the thought processes are extensions of the physiological processes of a human.

Psychologists are currently of such varied views and inconsistent observations that many patients of these psychologists are being diagnosed incorrectly and they are treated incorrectly. Psychology is a free-for-all subject. It is based on very erroneous premises, and the error is amplified by those practicing in psychology.

The next example is of a very ambiguous question concerning life. To understand a solution to this problem means breaking it down to the reason a human needs to ask such a question.

“What is the meaning of life?”

First of all life has no meaning in a logical sense. “Life” is a byproduct of our universe. The human stating this is creating a paradox for himself. If he/she were to say, “What should we do while alive?” this might be an easier problem to solve. Humans must consume, reproduce, endeavor in peripheral activities, and ethically satisfy positive emotions. The answer to this question is “To consume and reproduce, live comfortable, and endeavor in peripheral thoughts all in a manner which is ethical.”

Here is a question that shows a human, speaking on behalf of many humans, attempting to solve an ambiguity problem:

“Is it art?” a commentator asks about some very abstract pieces of art.

This was the subject of two Sixty Minutes stories in the 90's. Each time it aired it covered recent art shows which have peculiar pieces of art. The story questioned whether the items were art or not. One item was just a piece of drywall with a cut partially through it. Another piece was two light bulbs propped up against two bricks. The program showed how workers removed the two bricks and bulbs from a box and displayed them according to a picture of the artist who dreamed up the piece. After a little switching around of the objects they placed them in what the workers believed was the correct way. The artist was not there.

Would something so abstract be art? Some might feel that the art work must have a deep meaning behind it. The reporter for sixty minutes looked for the deep meaning behind some of these works with little luck. It is important for art to be recognized as art by a substantial number of humans for it to be considered art, otherwise it is ambiguous. If a construction worker were to place some left over items in a pile this would not be considered as art. It might be a difficult sell for the construction worker to convince someone that his creation is art. It may also be unlikely that someone would purchase a piece of art from one of these shows for display in their home. It would be too difficult to explain to guests, not that it can be explained at all.

So would the pieces at the art show be art? Absolutely. Although it may seem as if there is no underlying meaning behind these pieces of art, the fact is that the artists making these pieces recognize the befuddling ambiguity as appropriate for this particular time, at these particular art shows. It is a matter of timing. Art is like fashion. When the human race reaches a certain point it must recognize the meaning of the art based on the period of time it appears in. These works are art because they were made by artist with a deep underlying meaning of not having a meaning. That is the meaning. It is not likely that these pieces of art will be in fashion at any other time because humans will say, in essence, “That's been done before. We need to return to works of art that have a little more meaning and less ambiguity.”

This is why the image of the Virgin Mary in cow dung is art, because it is a timed piece. At one time there were a series of male nude photographs which came under scrutiny because they depicted gay scenes. Although the purpose of the art work was likely more to promote the acceptance of alternative life styles rather than the vision of the photographer, it is art, another timed piece. A repeat of these pieces of art would, of course, be inappropriate because, “It's been done before.” These pieces made bold, timed, statements to coincide with the present culture. Although some tastefulness should be observed, and these works may be too far to the extreme, there should be some small acceptance before someone says, “Ahh come on, enough of that.” The art in these art shows probably did not have droves of art critics in favor as well as the public in appreciation, but then again, it may not have been the purpose of the art.

Humans' perspective of the world changes little-by-little with each new development in the media age. The comprehension humans have of the world and themselves is molded by what they have seen in the media. The media age can be considered as beginning with the invention of the printing press when information became mass produced and distributed. We are currently quite near to the climax of the media age when the information “superhighway” is forming under our feet. Hopefully, we will not get run-over.

When nickelodeons and moving pictures first began, it was more show than substance. Human comedies were the majority of their shows. Although the concept of role playing on a stage had been around for thousands of years with great achievements like Shakespeare's “Hamlet,” humans were more apt to create fad-like moving pictures that appeal to the masses. Another reason for this was because sound did not occur in movies until later. Early actors generally over-acted, exhibiting role playing that could be easily understood by the audiences of the 1910's and 1920's.

Here is an example of a common human mode of speaking that gives incite to the way humans thought during one phase of the media age:

Old newsreel interview from 1940 (fictitious), “Tell us a little about your invention . . . ” the commentator asks.

“Well, with this machine here we will be able to get a circular flow of air moving downward which will cause the machine to go up . . . ”—“Here”, “downward”, and “up” have a quick raising of tones. “Up” has a quick lowering of tones.

Once the concept of moving pictures had been around for some time humans settled in to the new media age with more confidence and more acceptance of the new technology. The technology helped to broaden rather than intimidate the human perspective. In viewing old newsreels, one is likely to hear commentators raise the tones and accents on the last word of a sentence as in the previous scene in a manner similar to that of the speaking of Franklin Delano Roosevelt. Virtually everyone in the older film clips and newsreels talked this way. By raising the tone on these words the human is portraying the perspective, “I know I am being recorded for a great many humans to see and I am speaking as a knowledgeable, learned, human. This recording is only one aspect of my ever-growing repertoire.” It is as if the recording is secondary. Humans were often very stiff in their appearances on camera during this time period, yet many thought of the newsreels as just one part of life that is subservient to other pressing issues.

Over time this way of speaking, although an admirable application of emotion, got old. Humans began to not speak this way and they became more candid with their thinking. This exhibiting of a more genuine communication made television and movies more real. It also is a manner of a shift of perspective by humans in society. The generation gap between elders and juveniles began in the mid fifties with Rock n Roll because of the outside influences of things like the media age on juveniles. Juveniles began endeavoring in their own artistic expression to the dismay of elders because this was the point in time which the media age spurred such actions. When humans arrived at this time in the media age the way in which humans were thinking was so unconventional that a lot of the structure of life was disregarded for more of the liberties of life. The youth were hell-bent on being very creative, which is good, and liberal (too liberal and unstructured), which is not so good.

By the 60's, when humans were being recorded on color television the more dramatic views of the society were being broadcast. Humans lost some confidence here when appearing on television interviews. If one were to view a show from the 60's or early 70's such as Judy Garland's variety show or impromptu press meeting of politicians such as Richard Nixon meeting with Kruschev, humans will not be seen in as polished of a public performance as in the 80's and 90's.

By the 70's the juveniles of the 60's were now young elders. This is when the newer generation became older and began to recognize the structure of life in a better light with aspects of old and new ways of thinking. The artistic nature of humans was at a peak in the 70's. Rock n Roll during this decade was generally epic in nature and of the very best of musical compositions. Movies at this time were also of a very high artistic quality. During the 70's the empowerment being grasped by humans was very much of substance rather than hype.

The 80's were quite un-stylistic in nature. The “hype” of life began to regain influence. Punk rock is a deliberate dummying-up of the substantive views of the 70's. Punk rock is an example of when humans will become disenchanted with a direct approach and a direct solution to a problem. The hype of life became embraced in a “we'll show you” way. Music and movies dipped in quality on the downward slope of the peak of the 70's. But with each decade the human race has improved in the comprehension of it's world. Each decade brought new experiences, new aspects, and new ways of thinking.

The information age is an indirect result of the media age. Higher quality personal computers spurred an even broader view of the human existence. As the old world of little to no technology faded away the new world of high technology seemed limitless. Now we are at a point in which the information is becoming a bit too broad and unwieldy. As with any new trend humans will have to settle in, and settling in means acknowledging some of the structure of life. We may have a thousand television channels to choose from but the elders will have to rein in the youth to the more substantive endeavors.

The AI will follow trends in the many venues of communication. This will be smaller trends of the latest catch-phrase in conversation as well as larger trends in movie plots. It will integrate into society and learn of new things just like the rest of us. As with the changing times, and changing people, the AI will change as we march into the future.

What I, Wilson Holland, claim as my invention is a Universal Artificial Intelligence software program

1. The universal nature of the program is limited only by the scope and size of the recognizable, usable, awareness.
